(19) United States
(12) Patent Application Publication
(10) Pub. No.: US 2011/0196973 A1
(43) Pub. Date: Aug. 11, 2011

(54) METHOD AND APPARATUS FOR INTER-DEVICE SESSION CONTINUITY (IDSC) OF MULTI MEDIA STREAMS

(75) Inventors: Kamel M. Shaheen, King of Prussia, PA (US); Debashish Purkayastha, Collegeville, PA (US); Xavier DeFoy, Kirkland (CA); Michelle Perras, Montreal (CA)

(73) Assignee: INTERDIGITAL PATENT HOLDINGS, INC., Wilmington, DE (US)

(21) Appl. No.: 13/021,500

(22) Filed: Feb. 4, 2011

Related U.S. Application Data
(60) Provisional application No. 61/301,860, filed on Feb. 5, 2010.
(60) Provisional application No. 61/329,981, filed on Apr. 30, 2010.
(60) Provisional application No. 61/389,156, filed on Oct. 1, 2010.

(51) Int. Cl. G06F 15/16

(52) U.S. Cl. 709/228

(57) ABSTRACT

A method and apparatus for Inter-Device Session Continuity (IDSC). IDSC may include session transfer, session duplication, peer discovery, media transport control, session retrieval, and peer device detection of media streams between wireless transmit receive units (WTRUs) in real-time via Inter-User Equipment Transfer (IUT) across any internet protocol (IP) based network. This framework allows for both collaborative and non-collaborative media sessions, media session transport and shared media session control under the same subscription or multiple subscriptions.

### CROSS REFERENCE TO RELATED APPLICATIONS

This application claims the benefit of U.S. Provisional Application Ser. No. 61/301,860 filed on Feb. 5, 2010, U.S. Provisional Application Ser. No. 61/329,981 filed on Apr. 30, 2010 and U.S. Provisional Application Ser. No. 61/389,156 filed on Oct. 1, 2010, the contents of which are hereby incorporated by reference herein.

### BACKGROUND

The Internet Protocol (IP) Multimedia Subsystem (IMS) is an architectural framework for delivering IP-based multimedia services. A wireless transmit/receive unit (WTRU) may connect to an IMS through various access networks, including but not limited to networks based on technology such as Universal Mobile Telecommunication System (UMTS) Terrestrial Radio Access Network (UTRAN), Long Term Evolution (LTE), Worldwide Interoperability for Microwave Access (WiMax), or Wireless Local Area Network (WLAN) technology. Some procedures available through the use of IMS are the transfer, modification, replication and retrieval of media sessions between IMS-capable WTRUs in real-time. These procedures are known as Inter-User Equipment Transfer (IUT). However, IMS IUT is tightly bound to the IMS infrastructure and requires IMS-capable WTRUs. Accordingly, it would be advantageous for a media mobility framework that provides Inter-Device Session Continuity (IDSC) and allows media streams to be synchronized, transferred, modified, duplicated and retrieved between WTRUs that may not be IMS-capable in real-time across any internet protocol (IP) based network.

### SUMMARY

A method and apparatus for performing Inter-Device Session Continuity (IDSC). IDSC may include session transfer, session duplication, peer discovery, media transport control, session retrieval, and peer device detection of media streams between wireless transmit receive units (WTRUs) in real-time via Inter-User Equipment Transfer (IUT) across any internet protocol (IP) based network. This framework allows for both collaborative and non-collaborative media sessions, media session transport and shared media session control under the same subscription or multiple subscriptions.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 2 shows a high level diagram of IUT of media flows, wherein the media flows may be transferred, modified, duplicated or retrieved between IP media clients across any IP based network;

FIG. 3 shows a detailed diagram of an example of IUT of media flows between one or more WTRUs;

FIG. 4A shows a diagram of a media session transfer by WTRU-1, which is in direct communication with WTRU-2 and WTRU-3;

FIG. 4B shows a diagram of the establishment of a control session and a media session transfer by WTRU-1 using a session continuity relay function (SCRF) node to communicate with WTRU-2 and WTRU-3;

FIG. 4C shows a diagram of the establishment of a control session by WTRU-1 using the CN as a relay node to communicate with WTRU-2 and WTRU-3;

FIG. 5A is a flow diagram of a media session transfer by WTRU-1, which is in direct communication with WTRU-2 and/or WTRU-3;

FIG. 5B1 is a flow diagram of a media session transfer by WTRU-1 using a SCRF node to communicate with WTRU-2 and/or WTRU-3;

FIG. 5B2 is a continuation of FIG. 5B1;

FIG. 5C1 is a flow diagram of the establishment of a control session by WTRU-1 using the CN as a relay node to communicate with WTRU-2 and WTRU-3;

FIG. 5C2 is a continuation of FIG. 5C1;

FIG. 6A shows a diagram of a commit request and response process between one or more WTRUs and a CN;

FIG. 6B shows a diagram of a commit request and response process between one or more WTRUs and a CN using a central node;

FIG. 6C shows a diagram of a commit request and response process between one or more WTRUs and a CN wherein the CN is used as a central node;

FIG. 7A is a flow diagram of the IUT commit call flow between one or more WTRUs and a CN;

FIG. 7B is a flow diagram of the IUT commit call flow between one or more WTRUs and a CN via an SCRF/SCCF node;

FIG. 7C is a flow diagram of the IUT commit call flow between one or more WTRUs and a CN wherein the CN initiates the commit;

FIG. 8 shows a diagram of a media transfer using a CN and one or more WTRUs;

FIG. 9A is a flow diagram of an IUT message sequence within WTRU-1;

FIG. 9B is a flow diagram of an IUT message sequence within WTRU-2;

FIG. 9C is a flow diagram of an IUT message sequence within the CN;

FIG. 10A is a diagram of a centralized IDSC operation wherein an SCCF node centralizes IDSC control;

FIG. 10B is a diagram of a decentralized IDSC operation wherein a controller WTRU communicates directly with controlee WTRUs using an IDSC control framework;

FIG. 11 is a high level diagram of media session transfer between WTRUs using a streaming media server;

FIG. 12 is a flow diagram of an RTSP network protocol used to control a streaming media server;

FIG. 13A1 is a flow diagram of active device initiated transfer of media streams;

FIG. 13A2 is a continuation of FIG. 13A1;

FIG. 13B is a flow diagram of an alternative to the ANNOUNCE method;

FIG. 14A is a flow diagram of target device initiated transfer of media streams;

FIG. 14B is a flow diagram of target device initiated transfer of media streams in peer to peer communications;

FIG. 15A1 is a high level flow diagram of centralized IDSC using RTSP;

FIG. 15A2 is a continuation of FIG. 15A1;

FIG. 15B1 is a detailed flow diagram of centralized IDSC using RTSP and a SCCF node showing an initiation, start stream, IDSC initiation and IDSC preparation;

FIG. 15B2 is a continuation of FIG. 15B1;

FIG. 15B3 is a continuation of FIGS. 15B1 and 15B2;

FIG. 15B4 is a detailed flow diagram of centralized IDSC using RTSP and a SCCF node showing IDSC preparation, IDSC execution and completion;

FIG. 15B5 is a continuation of FIG. 15B4;

FIG. 15B6 is a continuation of FIGS. 15B4 and 15B5;

FIG. 16A1 is a is a high level flow diagram of P2P IDSC using RTSP;

FIG. 16A2 is a continuation of FIG. 16A1;

FIG. 16B1 is a detailed flow diagram of P2P IDSC using RTSP showing an initiation, start stream, IDSC initiation and IDSC preparation;

FIG. 16B2 is a continuation of FIG. 16B1;

FIG. 16B3 is a detailed flow diagram of P2P IDSC using RTSP showing IDSC preparation, IDSC execution and completion;

FIG. 16B4 is a continuation of FIG. 16B3;

FIG. 16B5 is a continuation of FIGS. 16B3 and 16B4;

FIG. 17A1 is another embodiment of a high level flow diagram of P2P IDSC using RTSP;

FIG. 17A2 is a continuation of FIG. 17A1;

FIG. 17B1 is a detailed flow diagram of P2P IDSC using RTSP, wherein all communications between WTRU-1 and the CN are through RTSP showing an initiation, start stream, IDSC initiation and IDSC preparation;

FIG. 17B2 is a continuation of FIG. 17B1;

FIG. 17B3 is a detailed flow diagram of P2P IDSC using RTSP, wherein all communications between WTRU-1 and the CN are through RTSP showing IDSC preparation, IDSC execution and completion;

FIG. 17B4 is a continuation of FIG. 17B3;

FIG. 17B5 is a continuation of FIGS. 17B4 and 17B5;

FIG. 18A1 is a is a high level flow diagram of P2P IDSC using RTSP, wherein all IDSC communications are between WTRU-1 and WTRU-2, and all communications with the CN are through RTSP;

FIG. 18A2 is a continuation of 18A1;

FIG. 18B1 is a detailed flow diagram of P2P IDSC using RTSP, wherein all IDSC communications are between WTRU-1 and WTRU-2, and all communications with the CN are through RTSP showing an initiation, start stream, IDSC initiation and IDSC preparation;

FIG. 18B2 is a continuation of FIG. 18B1;

FIG. 18B3 is a detailed flow diagram of P2P IDSC using RTSP, wherein all IDSC communications are between WTRU-1 and WTRU-2, and all communications with the CN are through RTSP showing IDSC preparation, IDSC execution and completion;

FIG. 18B4 is a continuation of FIG. 18B3;

FIG. 19 is a high level diagram of P2P IDSC using a universal plug and play (UPnP) audio/video (A/V) framework, wherein a controller WTRU communicates directly with controlee WTRUs;

FIG. 20A is a high level diagram of an example of an IDSC-UPnP transfer;

FIG. 20B1 shows a flow diagram of an example of an IDSC-UPnP transfer;

FIG. 20B2 is a continuation of FIG. 20B1; and

FIG. 20C is a diagram of an example of an IDSC-UPnP transfer without universal IDSC support.

### DETAILED DESCRIPTION

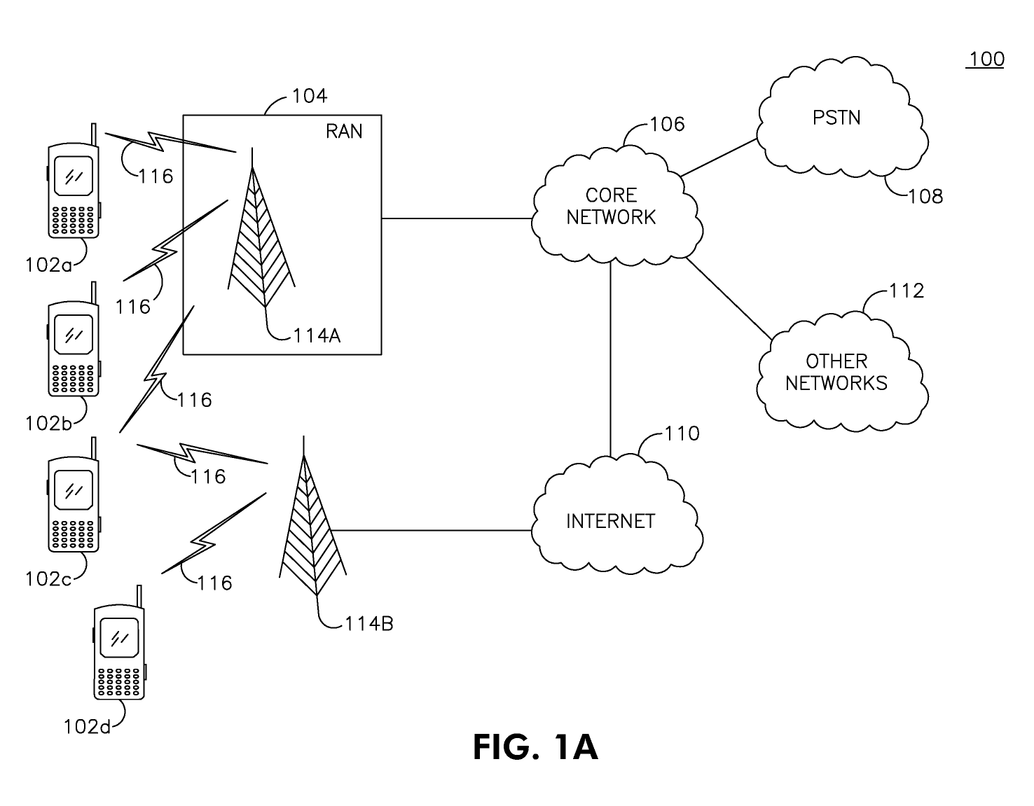

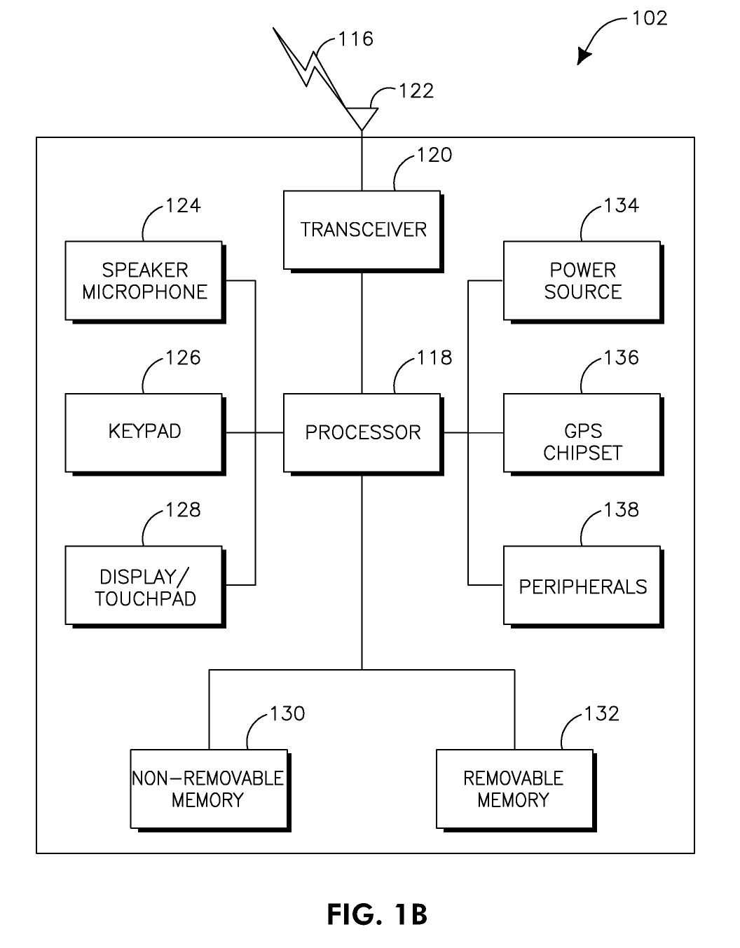

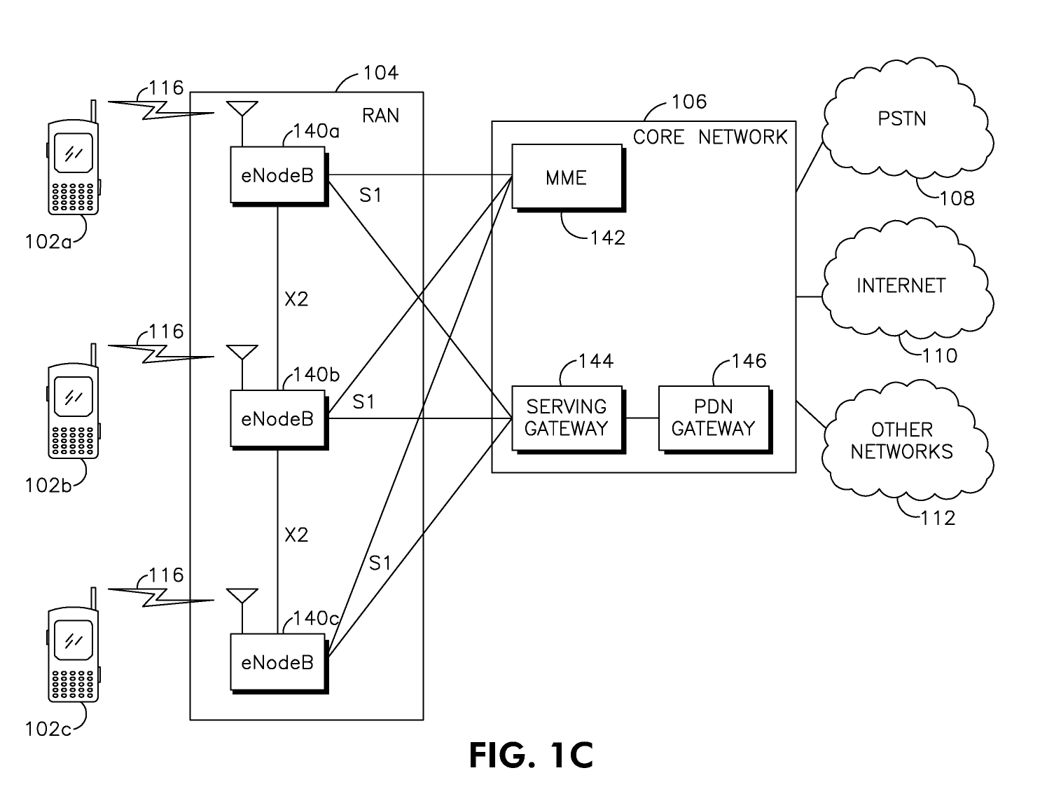

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 106, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 106 and/or the removable memory 132. The non-removable memory 106 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 142a, 142b, 142c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

A new message based session transfer protocol, which may be based on an existing protocol, may be used to enable IUT of media sessions without using an IMS framework. The new message based non-IMS session transfer protocol may include support for client and server applications. Both the client and the server applications may support a new application programming interface (API) that includes an IUT service function.

Inter-Device Session Continuity (IDSC) operations that function in a client server framework are described herein. While an IDSC protocol may be described in the embodiments, any control protocol may be used. An IDSC transfer may apply to application sessions delivered from multiple media sources that include a Real Time Streaming Protocol (RTSP), which may include bi-directional client server flows, real time transport protocol (RTP), which may include server to client flows, and real time control protocol (RTCP), which may include client to server flows. The result of the IDSC operation may be to transfer a media session from one device to another while enabling continuity of the media stream during the operation.

A wireless transmit/receive unit (WTRU) may establish a communication session including a plurality of media flows with a remote device or server. The communication session, or one or more of the media flows, may be transferred to, or duplicated on, one or more other WTRUs. IDSC may be performed using a protocol, such as a RTSP, an Extensible Messaging and Presence Protocol, or a Universal Plug and Play protocol (UPnP). The IDSC method may be controlled by a centralized server or may include using peer to peer control.

UPnP architecture allows networked devices such as personal computers, printers, Internet gateways, Wi-Fi access points and wireless devices to seamlessly discover each other's presence and establish functional network services for data sharing, communications, and entertainment. A UPnP compatible device may dynamically join a network, obtain an IP address, announce its name, convey its capabilities upon request, and learn about the presence and capabilities of other devices. The UPnP architecture may be used to provide IDSC service, such as replication and transfer of media streams from a media renderer (MR) to another MR. While a media server (MS) may be involved in IDSC, transfer/replication may be accomplished through the use of bookmarks. Bookmarks mark the point at which the media streams should start when the session is transferred. Bookmarking functionality may be implemented by a control point depending on seek modes supported by the device.

An action, such as GetPositionInfo( ), may be used to capture a position on the media, which may be revisited later through an action such as Seek( ). The control point may then obtain bookmarking information from a MR. The bookmarked information may then be used to point another MR to the bookmarked position on the media.

A general trend towards real-time social media, whereby end users are able to share and consume the same media content in real-time while interacting, drives a need for transmission of media streams across several devices. The herein framework allows for collaborative sessions where the media stream is transferred while remaining under the control of one device and for non-collaborative sessions where both the media stream and its control are transferred between devices. The herein framework also allows for standard media stream transport and may include but is not limited to Hyper Text Transport protocol (HTTP) or RTSP. In addition, the herein framework also allows for sessions to be controlled between devices under the same subscription (i.e., a single user) or different subscriptions (i.e., multiple users). These mechanisms may be embodied in any IP network and in particular over the Web as a way to address an increasing need for mobile and collaborative real-time media stream mass consumption.

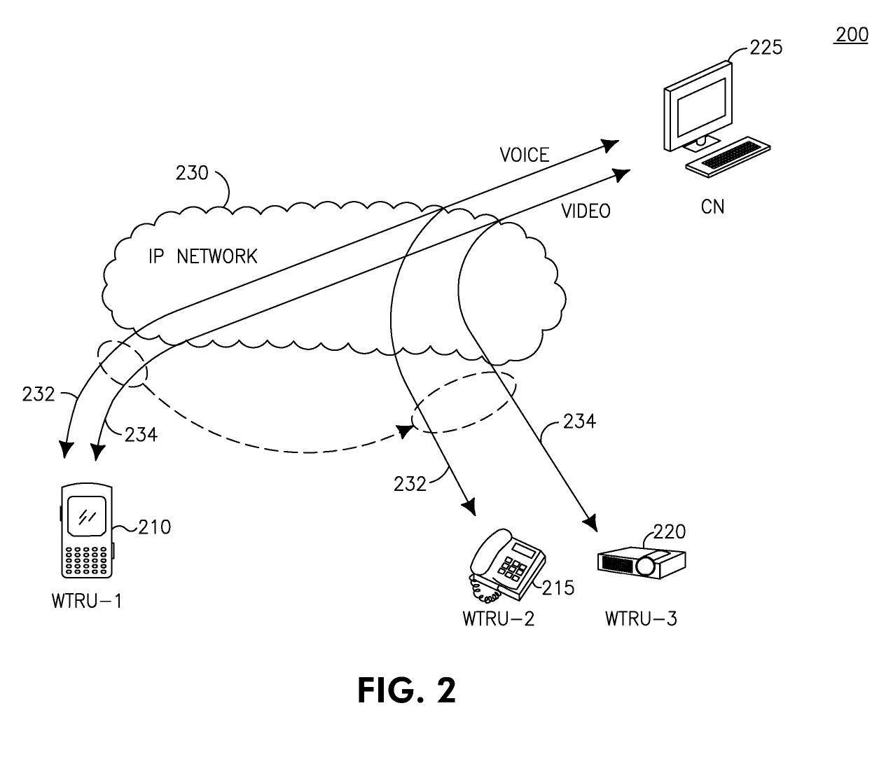

FIG. 2 shows a high level diagram 200 of IUT of media flows 232, 234 (i.e., voice and/or video sessions) wherein the media flows 232, 234 may be transferred, modified, duplicated or retrieved between IP media clients (e.g., WTRUs) across any IP based network 230. WTRU-1 210 establishes a voice and video session with the core network (CN) 225, which may be a media server, over an IP network 230. WTRU-1 210 may decide to initiate an IUT of session information, or to initiate a collaborative session with WTRU-2 215 and/or WTRU-3 220. WTRU-1 210 may establish a connection with WTRU-2 215 over an IP network 230 in order to transfer voice information. Similarly, WTRU-1 210 may establish a connection with WTRU-3 220 over an IP network 230 in order to transfer video information.

Any standard media protocol may be used with the media flows including but not limited to HTTP or RTSP. In addition, any IP network as well as the Web may be used with the media flows.

At any point in the method of FIG. 2, additional actions may be performed between the CN 225, WTRU-1 210, WTRU-2 215 and WTRU-3 220.

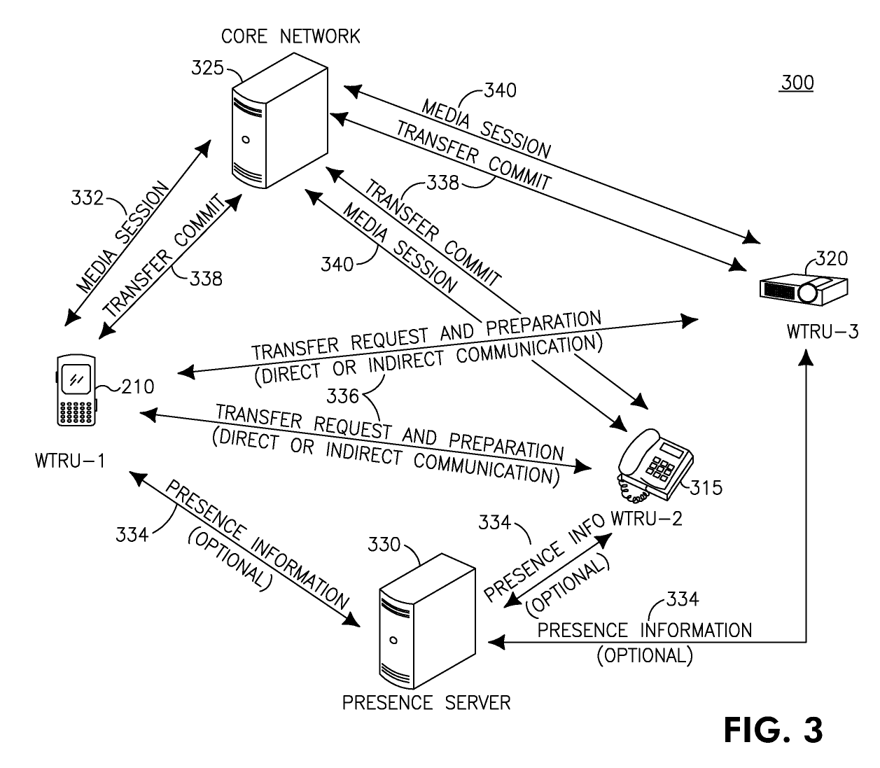

FIG. 3 shows a detailed diagram 300 of an example of IUT of media flows between one or more WTRUs. Any standard media protocol may be used with the media flows including but not limited to HTTP or RSTP. In addition, any IP network as well as the Web may be used with the media flows.

A media session 332 may be established between WTRU-1 310 and the CN 325. The CN 325 may also be used as an intermediate node during the IUT process. WTRU-1 310 may discover other WTRUs using a presence server 330 in order to obtain presence information 334 or WTRU-1 310 may know the identity of other WTRUs through their configuration.

WTRU-1 310 may decide to initiate an IUT of all or part of the media session with WTRU-2 315 and/or WTRU-3 320. WTRU-1 310 may send an IUT request 336 to WTRU-2 315 and/or WTRU-3 320 which may include IUT preparation, configuration, or parameter information. The preparation information may include an indication of the client application (e.g., media player) to use to receive the transferred media session. In addition, the originating WTRU ID, the target WTRU ID, attributes regarding the media to be transferred, bit rates, media type information, codec information and an IP address may be transferred. WTRU-1 310 may also provide a token or an IUT session ID to WTRU-2 315 and/or WTRU-3 320. This token may be provided to the CN 325 as poof of an agreement between WTRU-1 310 and WTRU-2 315 and/or WTRU-3 320 to perform IUT.

The IUT request 336 may be either a direct or an indirect communication. WTRU-2 315 and WTRU-3 320 may use the information received in the request to prepare for IUT. At this point, an intermediate node may or may not be used to enable communication or to apply a policy. Policies may be defined to: authorize or deny the transfer of media depending on a user profile, determine bandwidth allocated for the media, determine whether the media may be replicated, determine the entity responsible for billing and determine whether the target WTRU is allowed to perform additional transfers.

WTRU-1 310, WTRU-2 315 and/or WTRU-3 320 may initiate a communication with the CN 325 in order to communicate the agreement between the WTRUs to perform IUT via a commit request 338. The communication may also include IUT parameters including: the originating WTRU ID, the target WTRU ID, attributes of the media to be transferred, bit rates, identification of media flows, IP addresses, codec information and a token identifying the IUT session. The CN 325 may verify the agreement information and send a commit response 340 message to WTRU-2 315 and/or WTRU-3 320. Optionally, an intermediate node may be used communicate the commit request message. The CN 325 may be used as the intermediate node. If the CN 325 is used as the intermediate node, the commit request/response 338, 340 exchange may be simplified since the CN 325 is already aware of the agreement.

The transfer of the session information may be performed at the application level. The CN 325 may be used to transfer the all or part of the session to either WTRU-2 315 or WTRU-3 320.

At any point in the method of FIG. 3, additional actions may be performed between the CN 325, WTRU-1 310, WTRU-2 315, WTRU-3 320 and the presence server 330.

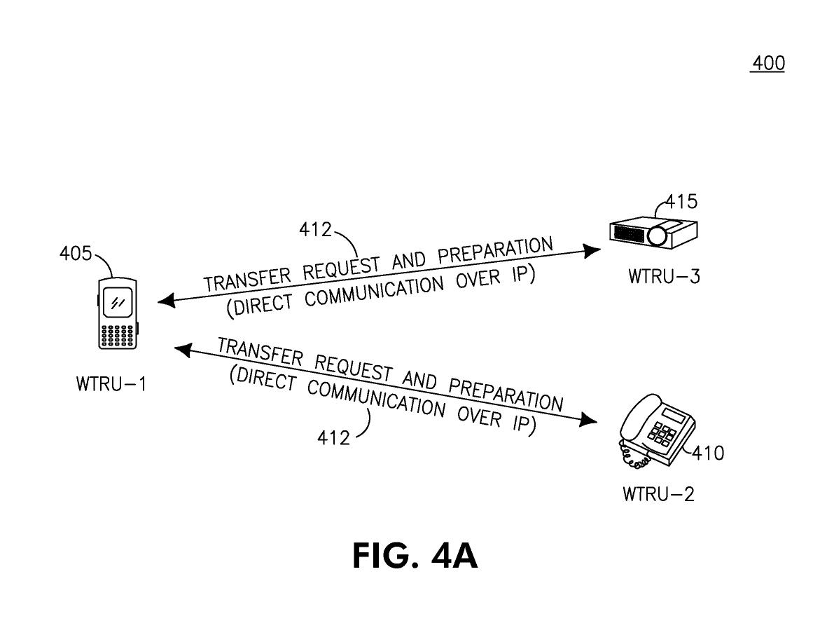

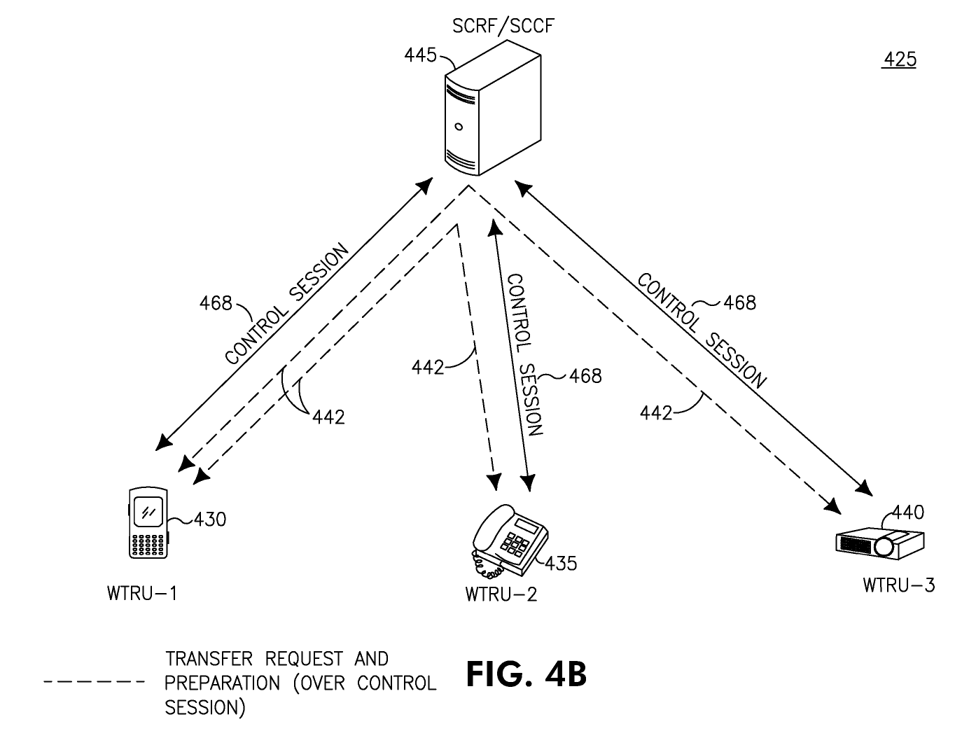

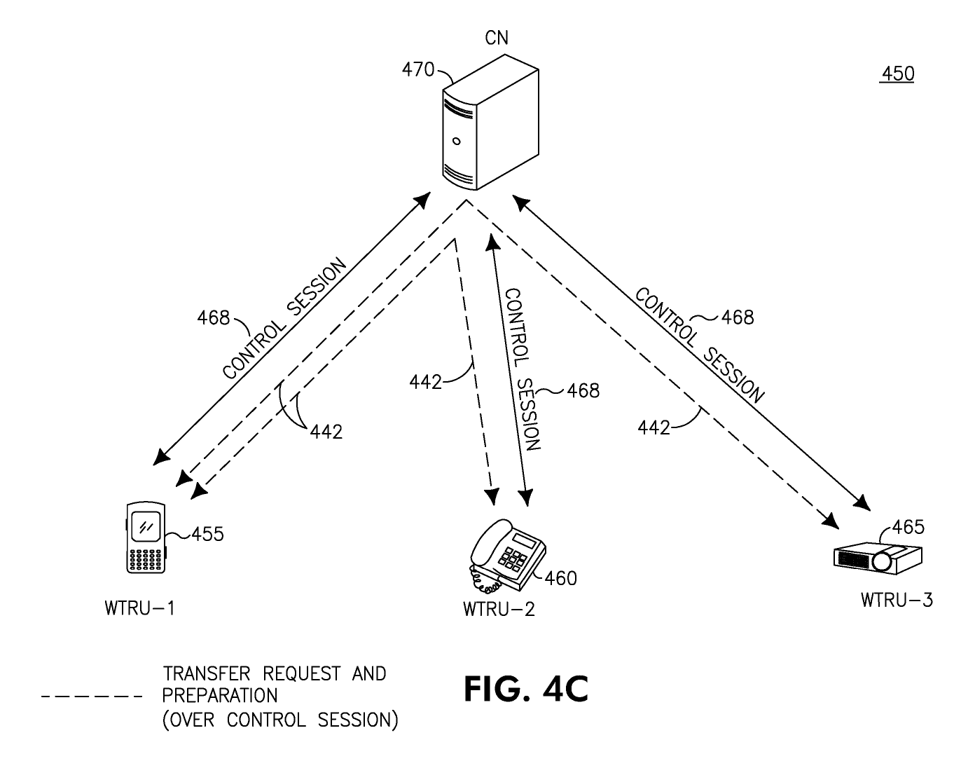

FIG. 4A shows a diagram 400 of a transmission of a media session transfer request and preparation information by WTRU-1 405, which is in direct communication with WTRU-2 410 and WTRU-3 415. WTRU-1 may detect the IP addresses of WTRU-2 410 and/or WTRU-3 415. WTRU-1 405 transmits a transfer request and preparation information 412 to WTRU-2 410 and/or WTRU-3 415 directly over IP in order to initiate IUT. WTRU-2 410 and/or WTRU-3 415 may send a transfer response 412 with additional information to WTRU-1 405.

At any point in the method of FIG. 4A, additional actions may be performed between WTRU-1 405, WTRU-2 410 and WTRU-3 415.

FIG. 4B shows a diagram 425 of the establishment of a control session and the transmission of a media session transfer request and preparation information 442 by WTRU-1 430 using rely node such as a session continuity relay function (SCRF) node 445 to communicate with WTRU-2 435 and WTRU-3 440. WTRU-1 430 transmits a transfer request and preparation information 442 to WTRU-2 435 and/or WTRU-3 440 via the SCRF node 445, and WTRU-1 430 may receive a response 442 including additional information from WTRU-2 435 and/or WTRU-3 440 via the SCRF node 445. The SCRF node 445 may be used to circumvent access issues (i.e., network address translation (NAT)) or perform additional functions, such as applying an access control, providing policy information or providing presence information. A control session 468 is established between WTRU-1 430 and the SCRF node 445. WTRU-2 435 and/or WTRU-3 440 may initiate a control session 468 with the SCRF node 445, or the SCRF node 445 may initiate a control session 468 with WTRU-2 435 and/or WTRU-3 440. In addition to or instead of using the SCRF node 445, the WTRU-1 430 may use a session continuity control function (SCCF) or a CN to communicate with WTRU-2 435 and/or WTRU-3 440.

At any point in the method of FIG. 4B, additional actions may be performed between WTRU-1 430, WTRU-2 435, WTRU-3 440, and the SCRF/SCCF 445.

FIG. 4C shows a diagram 450 of establishment of a control session by WTRU-1 455 using the CN 470 as a relay node to communicate with WTRU-2 460 and WTRU-3 465 and the transmission of a media session transfer request and preparation information 442 by WTRU-1 455 using the CN 470 to communicate with WTRU-2 460 and WTRU-3 465. A control session 468 is established between WTRU-1 455 and the CN 470. WTRU-2 460 and/or WTRU-3 465 may initiate a control session 468 with the CN 470, or the CN 470 may initiate a control session 468 with WTRU-2 460 and/or WTRU-3 465. WTRU-1 455 may use the CN 470 to communicate with WTRU-2 460 and/or WTRU-3 465 in order to transmit a media session transfer request and preparation information 442.

At any point in the method of FIG. 4C, additional actions may be performed between WTRU-1 455, WTRU-2 460, WTRU-3 465 and the CN 470.

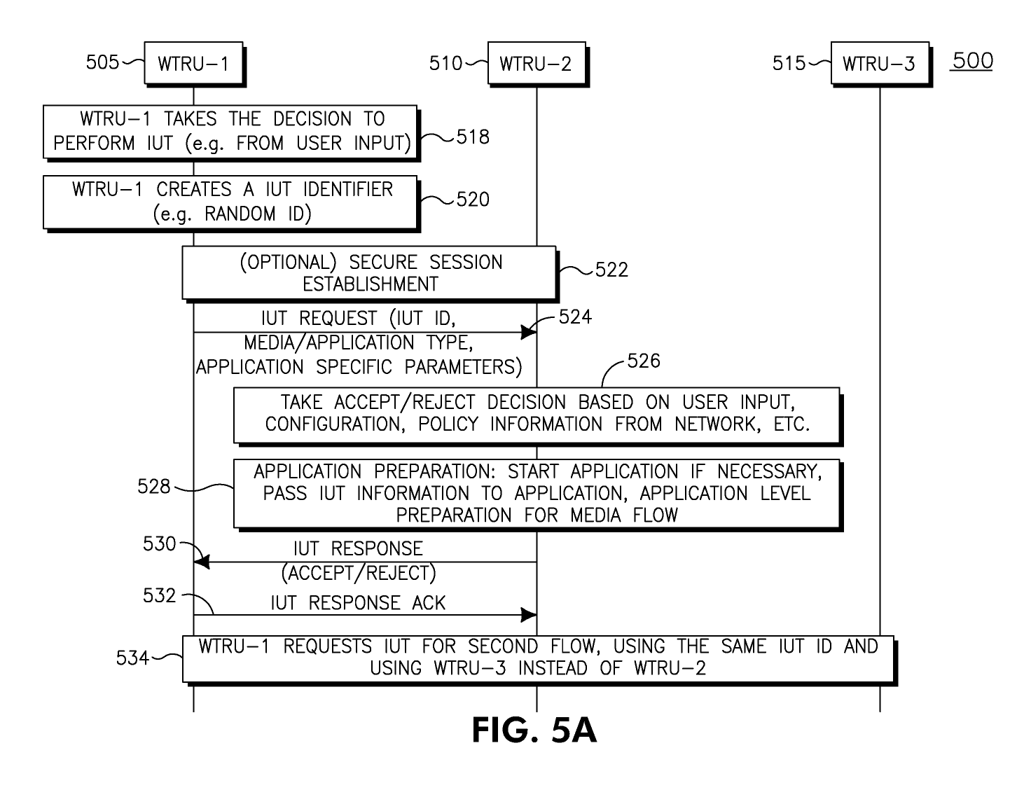

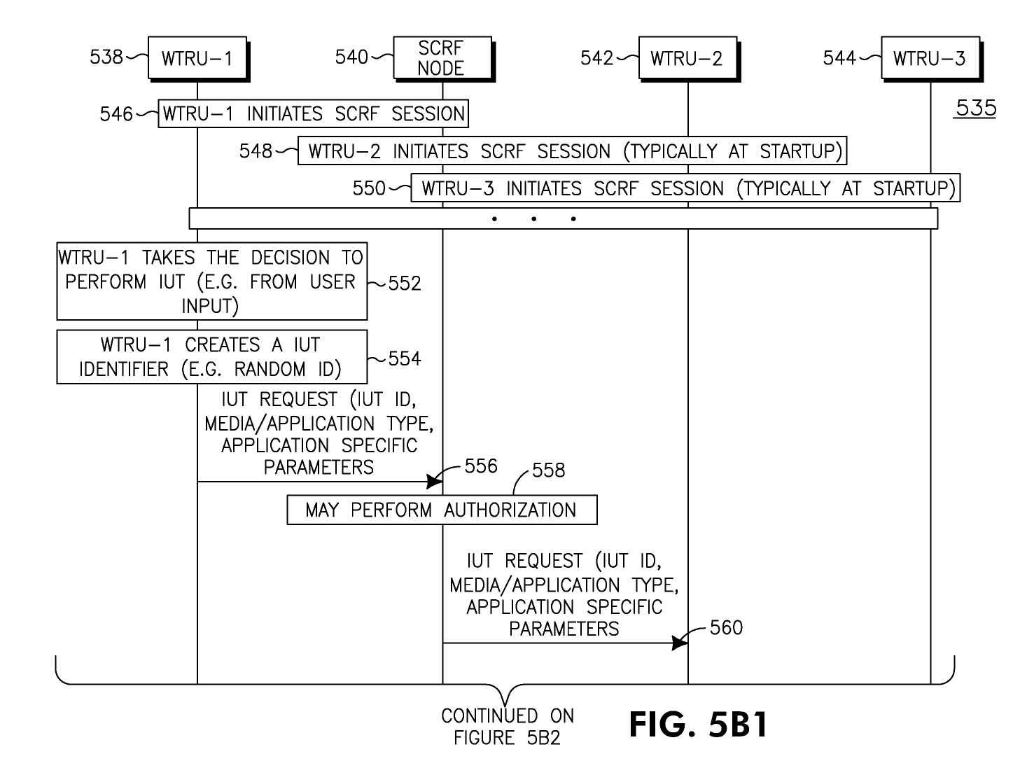

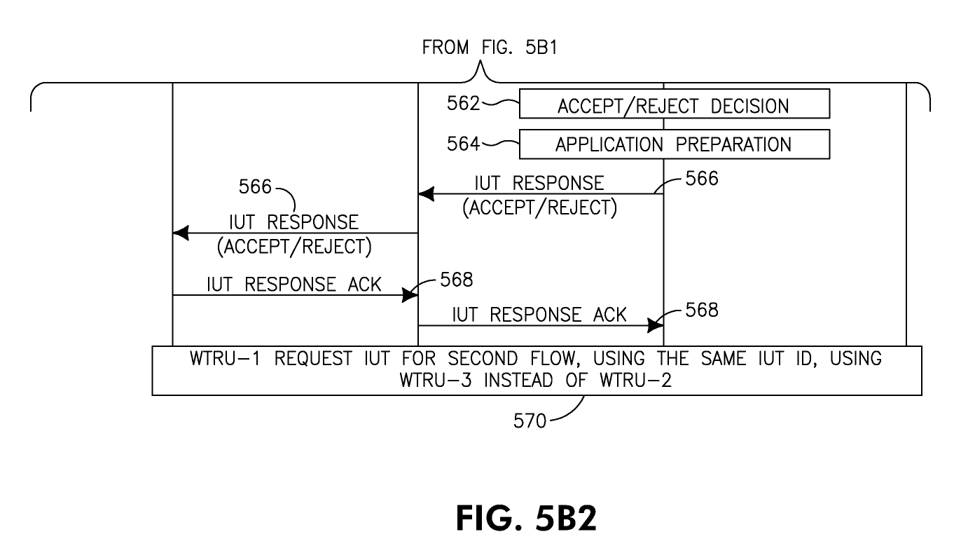

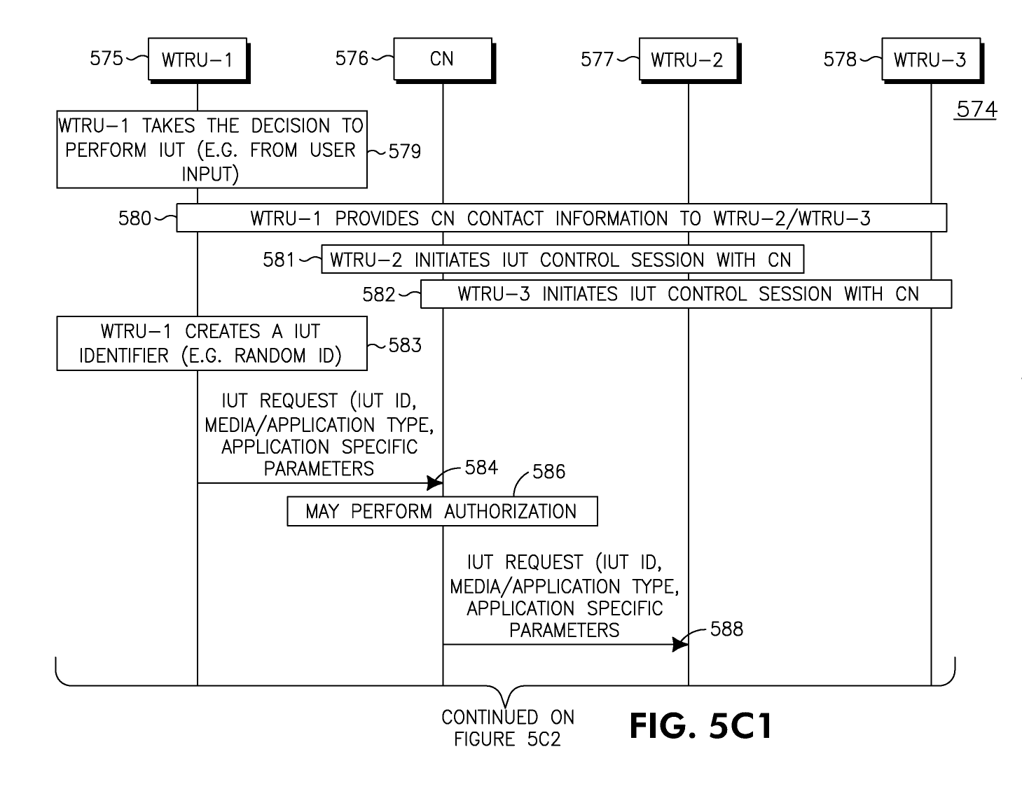

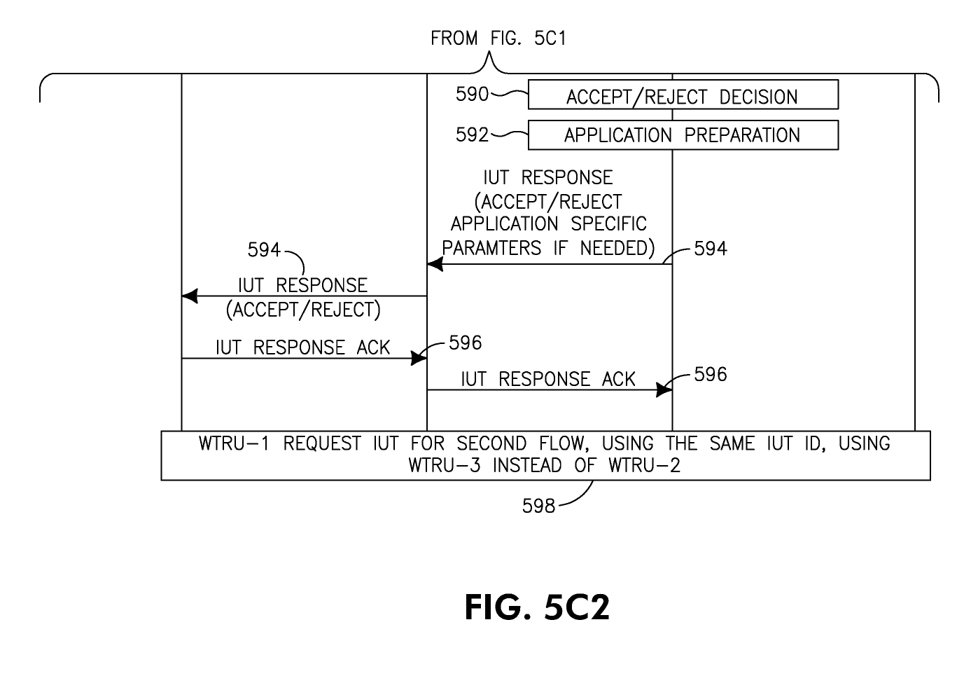

FIG. 5A is a flow diagram 500 of a transmission of a media session transfer request and preparation information by WTRU-1 505, which is in direct communication with WTRU-2 510 and/or WTRU-3 515. WTRU-1 505 may decide to initiate IUT 518 with either WTRU-2 510 or WTRU-3 515. WTRU-1 505 may create an IUT identifier (i.e., a random ID) 520 and may establish a secure session 522 with WTRU-2 510 and/or WTRU-3 515. WTRU-1 505 may transmit an IUT request 524, which may include but is not limited to an IUT ID, a media/application type or application specific parameters. WTRU-2 510 and/or WTRU-3 515 may receive the request and may accept or reject the request 526 based on criteria, including but not limited to: a user input, a pre-configuration, policy information or information from a network. WTRU-2 510 and/or WTRU-3 515 may begin application preparation 528 and may start an application, pass IUT information to the application or prepare the application for media flow. WTRU-2 510 and/or WTRU-3 515 may send an IUT response 530 either accepting or rejecting the IUT request to WTRU-1 505. WTRU-1 505 may transmit an IUT response acknowledgment (ACK) 532 to WTRU-2 510 and/or WTRU-3 515. WTRU-1 505 may request IUT for a second flow of information 534 by using the same IUT ID with either WTRU-2 510 or WTRU-3 515.

At any point in the method of FIG. 5A, additional actions may be performed between the WTRU-1 505, WTRU-2 510 and WTRU-3 515.

FIGS. 5B1 and 5B2 are a flow diagram 535 of a transmission of a media session transfer request and preparation information by WTRU-1 538 using a SCRF node 540 to communicate with WTRU-2 542 and/or WTRU-3 544. Optionally, a SCCF may be used in place of a SCRF node 540. WTRU-1 538, WTRU-2 542 and/or WTRU-3 544 may initiate a session 546, 548, 550 using the SCRF node 540. WTRU-1 538 may decide to initiate IUT 552. The decision may be based on user input, a pre-configuration, policy information or information from a network. WTRU-1 538 may create an IUT identifier 554 (i.e., a random ID) and may send an IUT request 556 to the SCRF node 540, which may include but is not limited to: an IUT ID, a media/application type or application specific parameters.

If the SCCF is used, the SCCF may perform actions including but not limited to authorization, IP translation and charging 558. However, if the SCRF node 540 is used, authorization or other actions may not be performed. The SCRF node 540 may send an IUT request 560, which may include but is not limited to: an IUT ID, a media/application type or application specific parameters to WTRU-2 542 and/or WTRU-3 544. WTRU-2 542 and/or WTRU-3 544 may accept or reject 562 the request, may begin application preparation 564, and may send a IUT response 566 to WTRU-1 538 via the SCRF node 540. The response 566 may include application specific information. WTRU-1 538 may send an IUT response ACK 568 to the SCRF node 540. The SCRF node 540 may send the IUT response ACK 568 to WTRU-2 542 and/or WTRU-3 544 unless the SCRF node 540 sent the IUT commit request, in which case no ACK is needed. WTRU-1 538 may request IUT for a second flow of information 570 by using the same IUT ID with either WTRU-2 542 or WTRU-3 544.

At any point in the method of FIGS. 5B1 and 5B2, additional actions may be performed between the SCRF node 540, WTRU-1 538, WTRU-2 542 and WTRU-3 544.

FIGS. 5C1 and 5C2 are a flow diagram 574 of the establishment of a control session by WTRU-1 575 using the CN 576 as a relay node to communicate with WTRU-2 577 and WTRU-3 578. WTRU-1 575 may decide to initiate IUT 579. The decision may be based on user input, a pre-configuration, policy information or information from a network. WTRU-1 575 may provide the CN 576 contact information 580 regarding WTRU-2 577 and/or WTRU-3 578. This information may be provided to the CN 576 via a variety of methods including but not limited to email or instant messaging. WTRU-2 577 and/or WTRU-3 578 may initiate an IUT control session 581, 582 with the CN 576. Optionally, the CN 576 may initiate a control session with WTRU-2 577 or WTRU-3 578 on an as needed basis.

WTRU-1 575 may create an IUT identifier 583 (i.e., a random ID) and may send an IUT request 584 to the CN 576, which may include but is not limited to: an IUT ID, a media/application type or application specific parameters. The CN 576 may perform actions 586 including but not limited to authorization, IP translation and charging. The CN 576 may send an IUT request 588, which may include but is not limited to an IUT ID, a media/application type or application specific parameters to WTRU-2 577 and/or WTRU-3 578. WTRU-2 577 and/or WTRU-3 578 may accept or reject the request 590 and may send a IUT response 594 to WTRU-1 575 via the CN 576. The response 594 may include application specific information. If WTRU-2 577 and/or WTRU-3 578 accept the request, it may begin application preparation 592 procedures. WTRU-1 575 may send an IUT response ACK 596 to the CN 576. The CN 576 may send the IUT response ACK 596 to WTRU-2 577 and/or WTRU-3 578, unless the CN 576 sent the IUT commit request in which case no ACK is needed. WTRU-1 575 may request IUT for a second flow of information 598 by using the same IUT ID with either WTRU-2 577 or WTRU-3 578.

At any point in the method of FIGS. 5C1 and 5C2, additional actions may be performed between the CN 576, WTRU-1 575, WTRU-2 577 and WTRU-3 578.

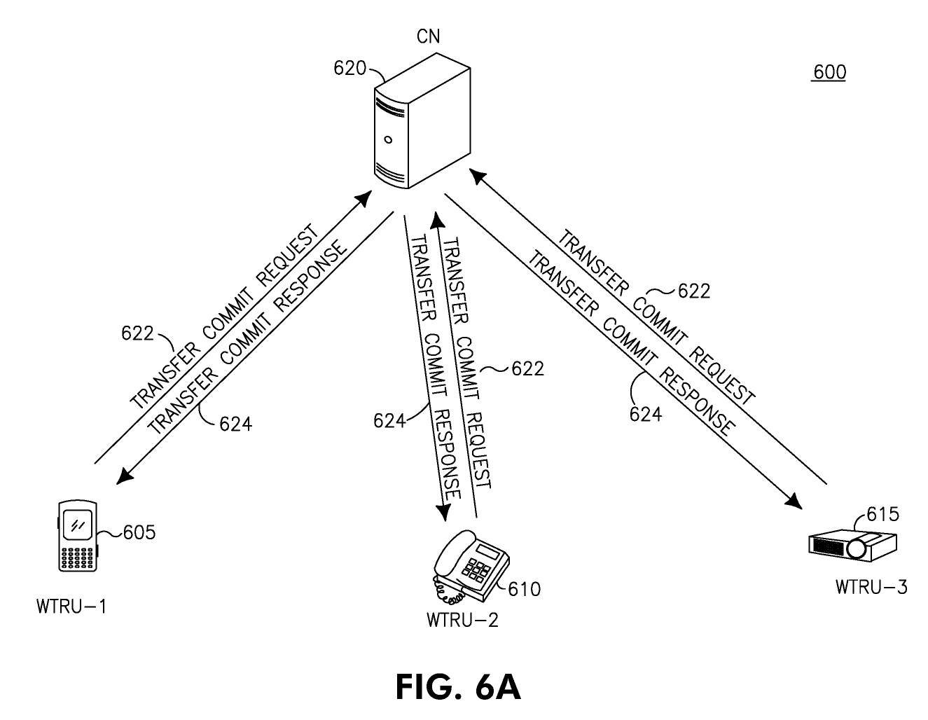

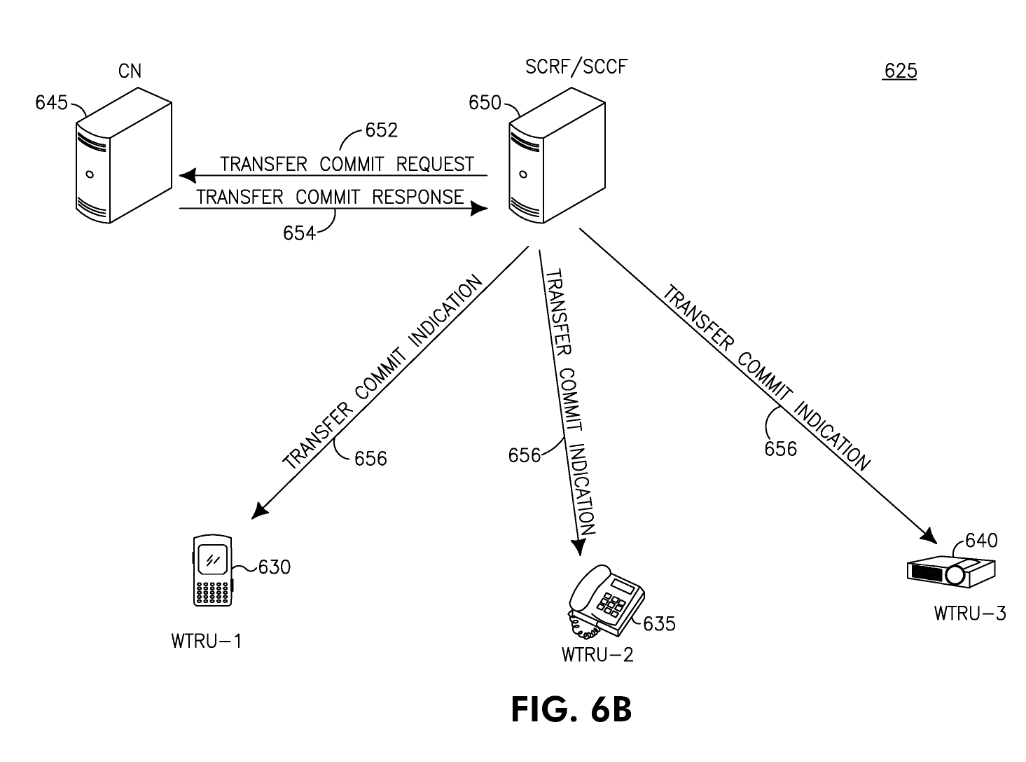

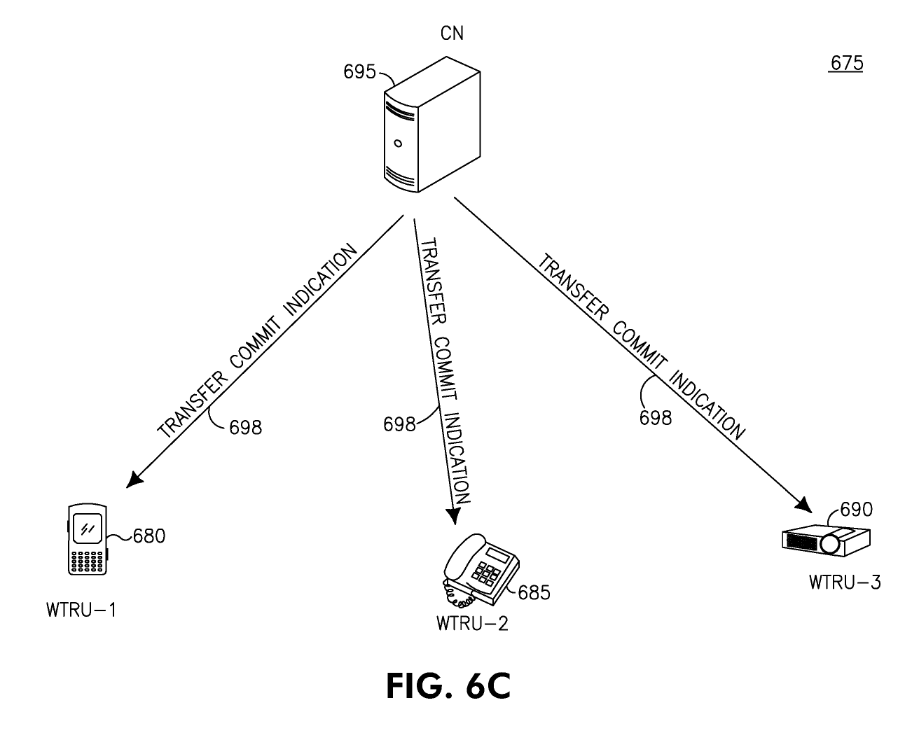

FIG. 6A shows a diagram 600 of a commit request and response process between one or more WTRUs and a CN 620. A control session is established between WTRU-1 605, WTRU-2 610 and/or WTRU-3 615. An IUT request may be negotiated between WTRU-1 605, WTRU-2 610 and/or WTRU-3 65 and the IUT information may be provided to the CN 620.

WTRU-1 605, WTRU-2 610 and/or WTRU-3 615 may send a commit request 622 to the CN 620. The CN 620 may compare the received commit requests 622 and may accept or reject the IUT request based on the commit requests 622. On a condition that the CN 620 accepts the IUT request, the CN 620 may prepare the application for IUT and may send a transfer commit response 624 to WTRU-1 605, WTRU-2 610 and/or WTRU-3 615.

At any point in the method of FIG. 6A, additional actions may be performed between the CN 620, WTRU-1 605, WTRU-2 610 and WTRU-3 615.

FIG. 6B shows a diagram 625 of a commit request and response process between one or more WTRUs and a CN 645 using a central node (i.e., a SCRF/SCCF) 650. WTRU-1 630, WTRU-2 635 and/or WTRU-3 640 may initiate a session using the SCRF/SCCF node 650. WTRU-1 630 may decide to initiate IUT. The decision may be based on user input, a pre-configuration, policy information or information from a network. WTRU-1 630 may create an IUT identifier (i.e., a random ID) and may send an IUT request to the SCRF/SCCF node 650, which may include but is not limited to an IUT ID, a media/application type or application specific parameters.

The SCRF/SCCF node 650 provides IUT information to the CN 645 and may send a transfer commit request 652 to the CN 645. The CN 645 may accept or reject the transfer commit request 652. On a condition that the CN 645 accepts the transfer commit request 652, the CN 645 may prepare the application for IUT and may send a transfer commit response 654 to the SCRF/SCCF node 650. The SCRF/SCCF node 650 may send a transfer commit indication 656 to WTRU-1 630, WTRU-2 635 and/or WTRU-3 640.

At any point in the method of FIG. 6B, additional actions may be performed between WTRU-1 630, WTRU-2 635, WTRU-3 640, the SCRF/SCCF node 650 and the CN 645.

FIG. 6C shows a diagram 675 of a commit request and response process between one or more WTRUs and a CN 695 wherein the CN 695 is used as a central node. WTRU-1 680 may decide to initiate IUT. The decision may be based on user input, a pre-configuration, policy information or information from a network. WTRU-1 680 may provide the CN 695 contact information regarding WTRU-2 685 and/or WTRU-3 690. This information may be provided to the CN 695 via a variety of methods including but not limited to email or instant messaging. WTRU-1 680, WTRU-2 685 and/or WTRU-3 690 may initiate an IUT control session with the CN 695. Optionally, the CN 695 may initiate a control session with WTRU-1 680, WTRU-2 685 or WTRU-3 690 on an as needed basis. In addition, WTRU-1 680 may create an IUT identifier (i.e., a random ID).

A control session may be established between WTRU-1 680, WTRU-2 685 and/or WTRU-3 690 and an IUT request may be negotiated between WTRU-1 680, WTRU-2 685 and/or WTRU-3 690 wherein the IUT information may be provided to the CN 695. A commit request may not need to be sent to the CN 695 since the CN 695 may be involved in the establishment of the control session. The CN 695 may send a commit indication 698 to WTRU-1 680, WTRU-2 685 and/or WTRU-3 690 in order to trigger IUT.

At any point in the method of FIG. 6C, additional actions may be performed between WTRU-1 680, WTRU-2 685, WTRU-3 690 and the CN 695.

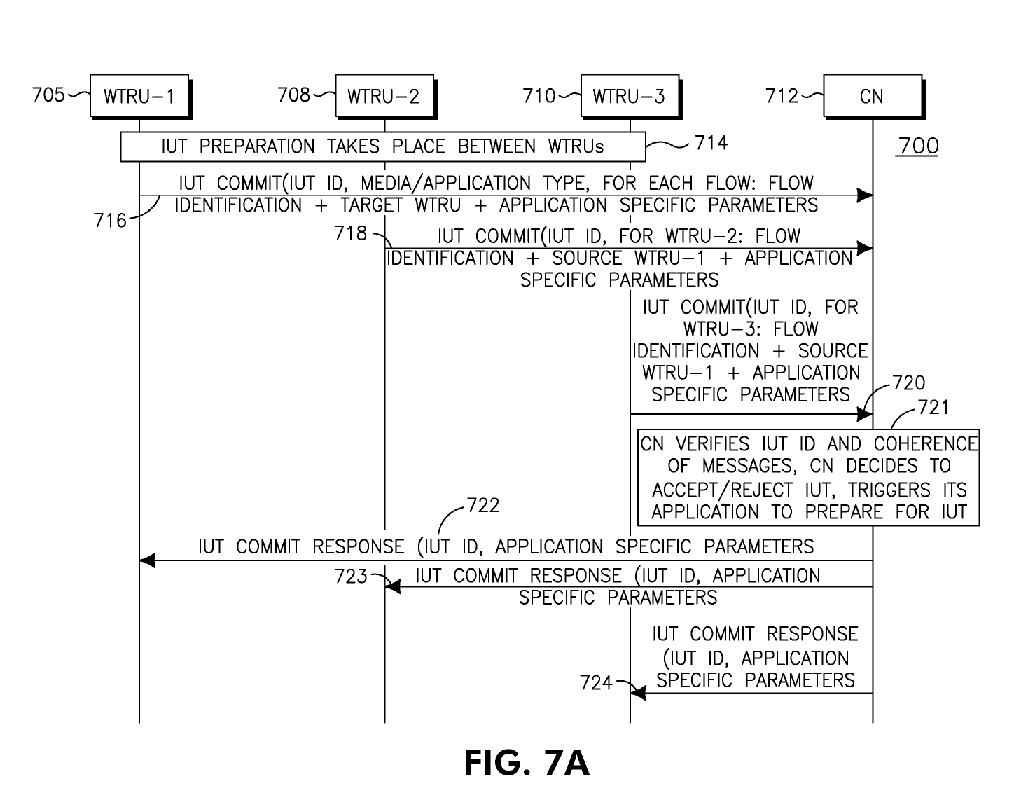

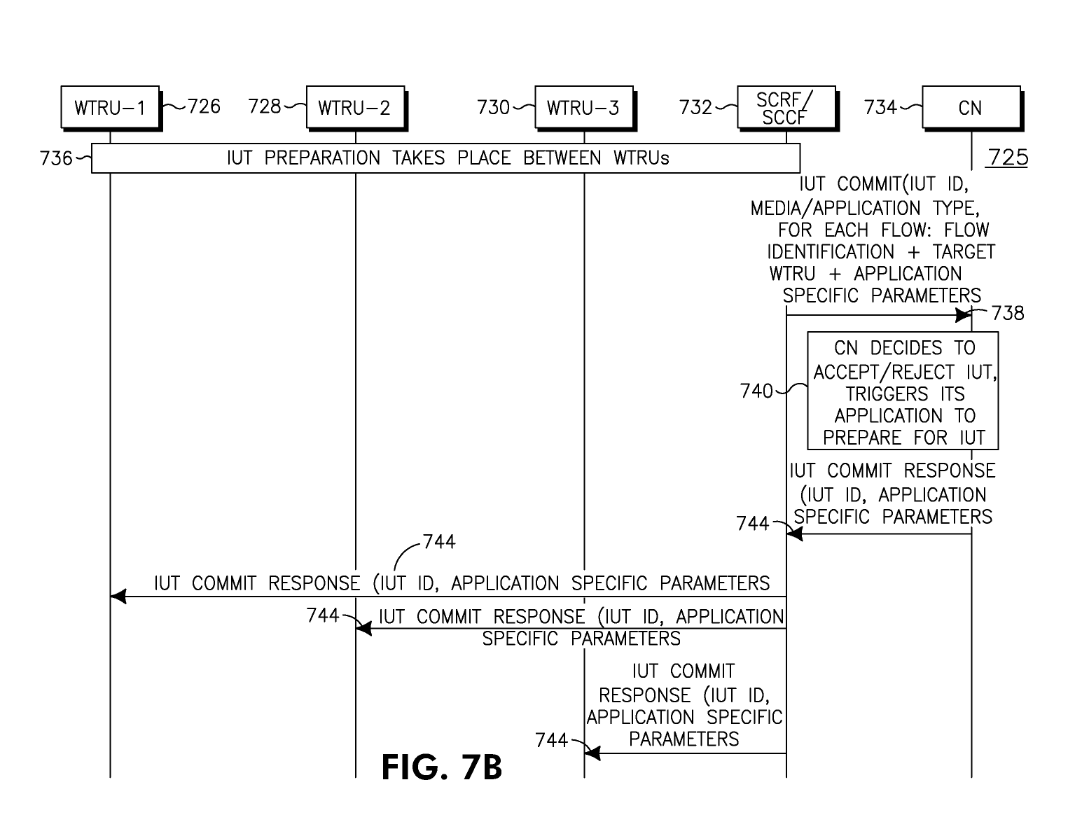

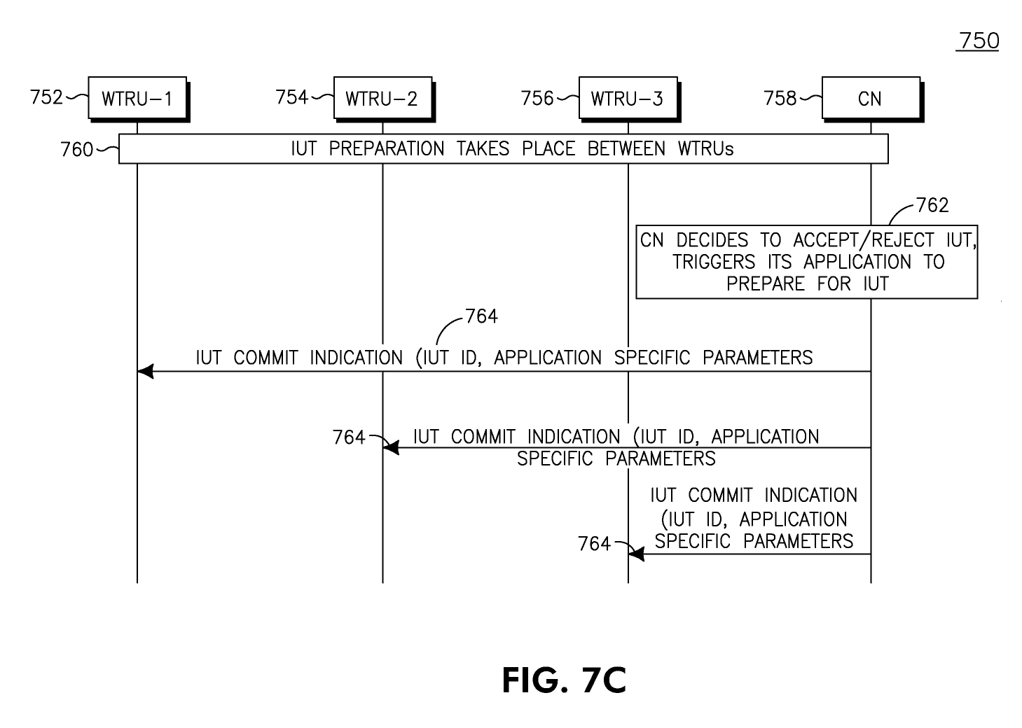

FIG. 7A is a flow diagram 700 of the IUT commit call flow between one or more WTRUs and a CN 712. WTRU-1 705 may decide to initiate IUT. The decision may be based on user input, a pre-configuration, policy information or information from a network. IUT preparation may take place 714 where WTRU-1 705 may create an IUT identifier (i.e., a random ID) and may establish a secure session with WTRU-2 708 and/or WTRU-3 710.

WTRU-1 705 may transmit an IUT commit request 716 to the CN 712, wherein the request 716 may include but is not limited to: an IUT ID, a media/application type, a flow identification, a target WTRU and application specific parameters. WTRU-2 708 may transmit an IUT commit request 718 to the CN 712, wherein the request 718 may include but is not limited to: an IUT ID, a flow identification, a source WTRU and application specific parameters. WTRU-3 710 may transmit an IUT commit request 720 to the CN 712, wherein the request 720 may include but is not limited to: an IUT ID, a flow identification, a source WTRU and application specific parameters.

The CN 712 may verify the IUT IDs and the coherence of the messages 721. The CN 712 determines to accept or reject the IUT request 721. On a condition that the CN 712 determines to accept the IUT request, it triggers its application to prepare for IUT 721. The CN 712 may transmit an IUT commit response 722, 723, 724 to each of WTRU-1 705, WTRU-2 708 and/or WTRU-3 710, which may include but is not limited to an IUT ID and application specific parameters.

At any point in the method of FIG. 7A, additional actions may be performed between WTRU-1 705, WTRU-2 708, WTRU-3 710 and the CN 712.

FIG. 7B is a flow diagram 725 of the IUT commit call flow between one or more WTRUs and a CN 734 via an SCRF/SCCF node 732. WTRU-1 726, WTRU-2 728 and/or WTRU-3 730 may initiate a session using the SCRF/SCCF node 732. WTRU-1 726 may decide to initiate IUT. The decision may be based on user input, a pre-configuration, policy information or information from a network. IUT preparation may begin 736 and WTRU-1 726 may create an IUT identifier (i.e., a random ID) and may send an IUT request to the SCRF/SCCF node 732, which may include but is not limited to: an IUT ID, a media/application type or application specific parameters.

The SCRF/SCCF node 732 provides IUT information to the CN 734 and may send a IUT commit request 738 to the CN 734, wherein the request 738 may include but is not limited to an IUT ID, a media/application type, a flow identification, a target WTRU and application specific parameters. The CN 734 determines to accept or reject the IUT request 740. On a condition that the CN determines to accept the IUT request, it triggers its application to prepare for IUT 740. The CN 734 may transmit an IUT commit response 744 to each of WTRU-1 726, WTRU-2 728 and/or WTRU-3 730, via the SCRF/SCCF node 732, which may include but is not limited to an IUT ID and application specific parameters.

At any point in the method of FIG. 7B, additional actions may be performed between the SCRF/SCCF node 732, WTRU-1 726, WTRU-2 728, WTRU-3 730 and the CN 734.

FIG. 7C is a flow diagram 750 of the IUT commit call flow between one or more WTRUs and a CN 758 wherein the CN 758 initiates the commit. WTRU-1 752 may decide to initiate IUT. The decision may be based on user input, a pre-configuration, policy information or information from a network. IUT preparation may take place 760 between WTRU-1 752, WTRU-2 754 and WTRU-3 756. WTRU-1 752 may provide the CN 758 contact information regarding WTRU-2 754 and/or WTRU-3 756. This information may be provided to the CN 758 via a variety of methods including but not limited to: email or instant messaging. WTRU-1 752, WTRU-2 754 and/or WTRU-3 756 may initiate an IUT control session with the CN 758. Optionally, the CN 758 may initiate a control session with WTRU-1 752, WTRU-2 754 or WTRU-3 756 on an as needed basis.

WTRU-1 752 may create an IUT identifier (i.e., a random ID) and may send an IUT request to the CN 758, which may include but is not limited to: an IUT ID, a media/application type or application specific parameters.

The CN 758 may verify the IUT IDs and the coherence of the messages. The CN 758 determines to accept or reject the IUT request 762. On a condition that the CN 758 determines to accept the IUT request, it triggers its application to prepare for IUT 762. The CN 758 may transmit an IUT commit indication 764 to each of WTRU-1 752, WTRU-2 754 and/or WTRU-3 756, which may include but is not limited to: an IUT ID and application specific parameters.

At any point in the method of FIG. 7C, additional actions may be performed between WTRU-1 752, WTRU-2 754, WTRU-3 756 and the CN 758.

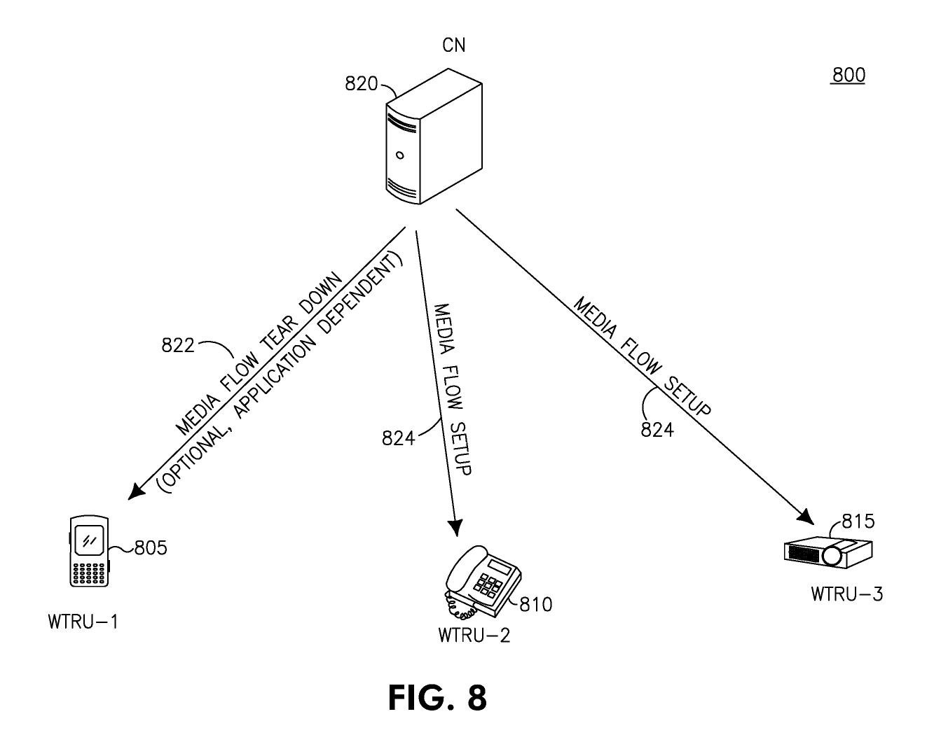

FIG. 8 shows a diagram 800 of a media transfer using a CN 820 and one or more WTRUs. The CN 820 may include a media server application while the WTRUs may include a media client application. Once the CN 820 has accepted the IUT request from WTRU-1 805 media flow setup and media flow transfer to WTRU-2 810 and/or WTRU-3 815 may be performed 824. Media flow transfer may be facilitated by an IUT function, which may be located in either the CN 820 or in any of the WTRUs and may be media application dependent.

The CN 820 or any of the WTRUs may initiate a new media session using media application functions. The CN 820 may inform the media server application to use IP addresses as targets for the transferred flow. Optionally, media flow duplication may be performed instead of or in addition to media transfer, and WTRU-1 805 may choose to tear down (i.e., terminate) 822 its media flow with the CN 820.

At any point in the method of FIG. 8, additional actions may be performed between WTRU-1 805, WTRU-2 810, WTRU-3 815 and the CN 820.

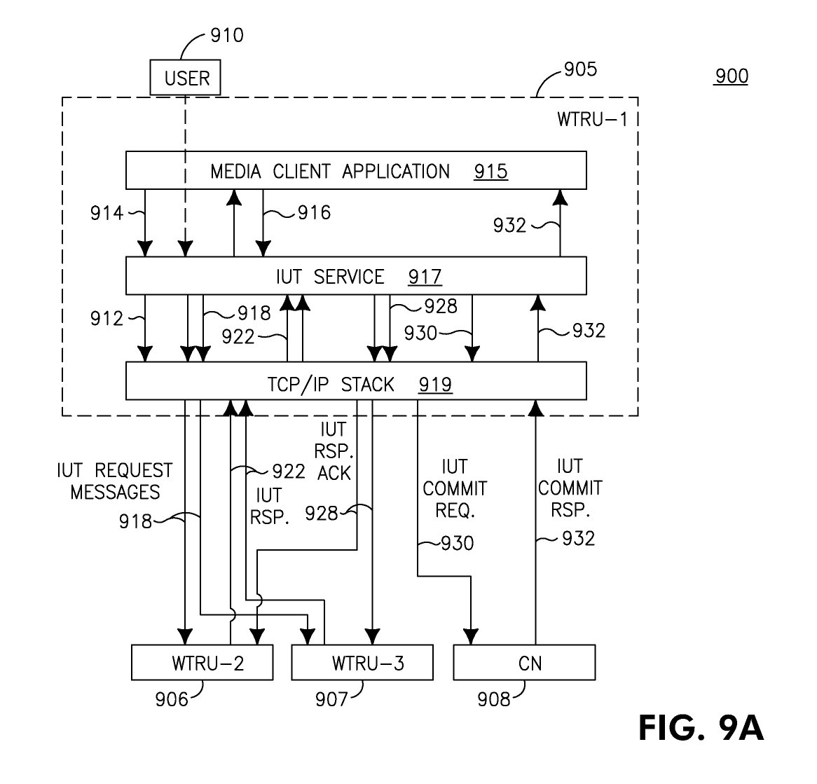

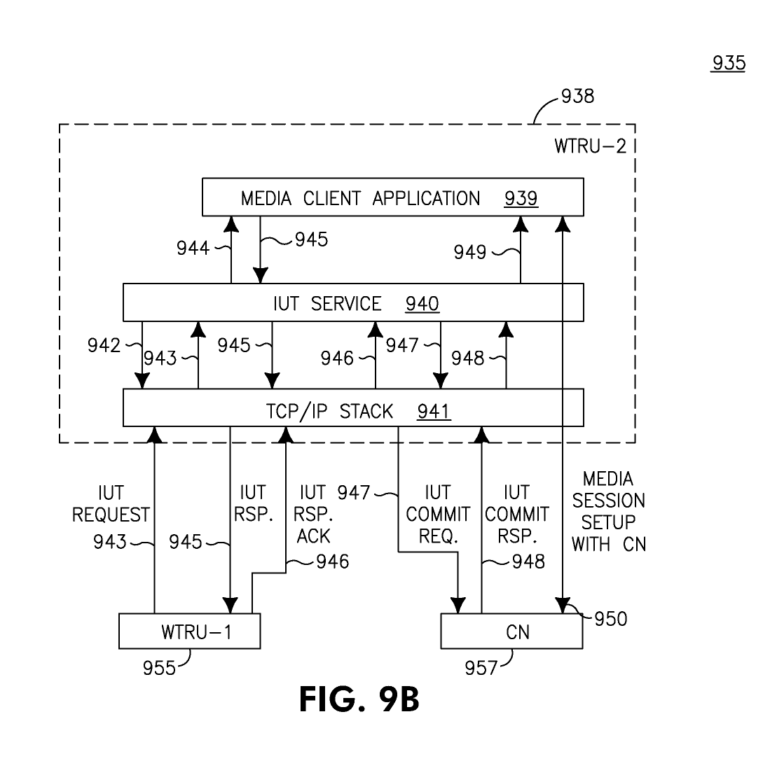

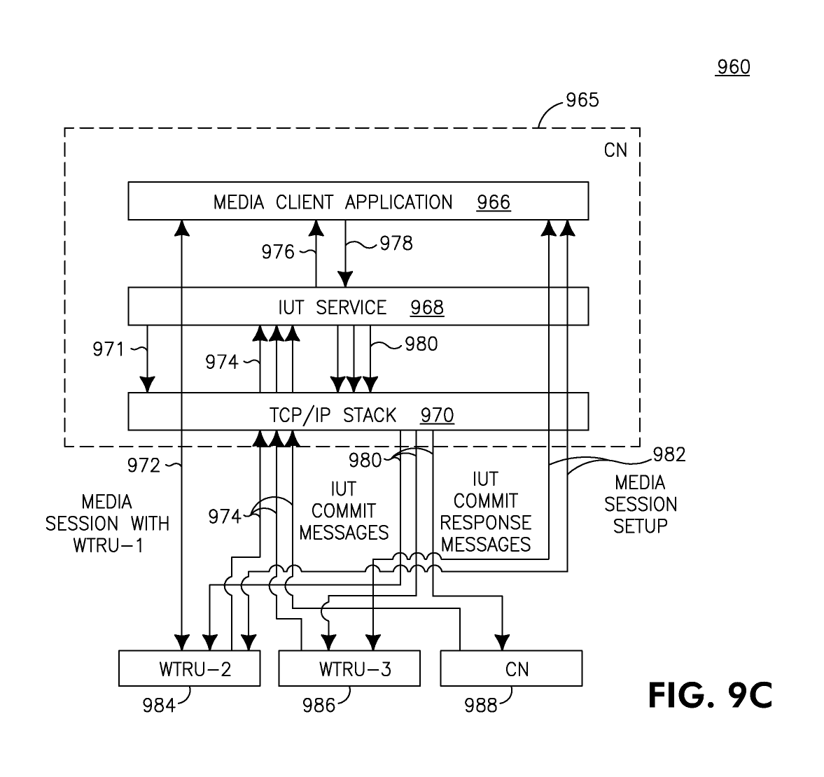

FIG. 9A is a flow diagram of an IUT message sequence within WTRU-1 905, the source WTRU. Upon completion or in conjunction with the procedures in 5A, 6A and 7A, an IUT service 917 may register 912 with a TCP/IP stack 919. Upon initiation of the media client application 915, the media client application 915 registers 914 with an IUT service 917. A user 910 may trigger IUT (i.e., via a graphical user interface (GUI) 916. The IUT service 917 may pass an IUT request 916 to the media client application 915, which may fill the IUT request with application specific parameters and may trigger a request 918 to the IUT service 917. Requests 918 may be sent by the IUT service 917 through a TCP/IP stack 919 and on to WTRU-2 906 and/or WTRU-3 907 using IUT request messages 918. IUT response messages 922 are received by the TCP/IP stack 919 from WTRU-2 and/or WTRU-3 and sent to the IUT service 917. The IUT service 917 may acknowledge 928 the IUT responses. IUT response acknowledgments 928 may be sent to WTRU-2 906 and/or WTRU-3 907.

The IUT service 917 may send a commit message 930 through the TCP/IP stack 919 to the CN 908. The CN 908 may send a commit response 932 to the IUT service 917 via the TCP/IP stack 919. The IUT service 917 may indicate to the media client application 915 that the IUT transfer is accepted by the CN 908. The media client application 915 may tear down the transferred media flows.

At any point in the method of FIG. 9A, additional actions may be performed between WTRU-1 905, WTRU-2 906, WTRU-3 907, the CN 908, the media client application 915, the IUT service 917 and the TCP/IP stack 919.

FIG. 9B is a flow diagram 935 of an IUT message sequence within WTRU-2 938, the target WTRU. Upon completion or in conjunction with the procedures in 5A, 6A and 7A, an IUT service 940 may register 942 with a TCP/IP stack 941. WTRU-2 938 may receive an IUT request 943 from WTRU-1 955. The IUT request 943 is received by the IUT service 940 via the TCP/IP stack 941. The IUT service 940 initiates the media client application 944 and passes the application specific parameters to the media client application 939. The media client application 939 prepares for IUT transfer and sends an IUT response 945 to WTRU-1 955 via the IUT service 940 and the TCP/IP stack 941. The TCP/IP stack 941 receives an IUT response acknowledgment 946 from WTRU-1 955 and transfers the IUT response 946 to the IUT service 940.

The IUT service 940 may send a commit message 947 through the TCP/IP stack 941 to the CN 957. The CN 957 may send a commit response 948 to the IUT service 940 via the TCP/IP stack 941. The IUT service 940 may trigger the media transfer 949 in WTRU-2 938 via the media client application 939. The media client application 939 may connect 950 to the CN 957 and perform application level operation to resume media flow at a given position.

At any point in the method of FIG. 9B, additional actions may be performed between WTRU-1 955, WTRU-2 938, the CN 957, the media client application 939, the IUT service 940 and the TCP/IP stack 941.

FIG. 9C is a flow diagram 960 of an IUT message sequence within the CN 965. Upon completion or in conjunction with the procedures in 5A, 6A and 7A, an IUT service 968 may register 971 with a TCP/IP stack 970. A media session 972 is established with WTRU-1 984 via the media server application 966. IUT commit messages 974 are received by the TCP/IP stack 970 indicating that WTRU-1 984, WTRU-2 986 and/or WTRU-3 988 agree to perform an IUT. The commit messages 974 are transmitted to the IUT service 968.

The IUT service 968 determines that the IUT commit messages are coherent 976 and may send an IUT request 976 to the media server application 966. The media server application 966 may perform any necessary preparation and may accept IUT by sending an indication 978 to the IUT service 968. The IUT service 968 sends commit response 980 messages to WTRU-1 984, WTRU-2 986 and/or WTRU-3 988 via the TCP/IP stack 970. WTRU-2 986 and/or WTRU-3 988 may initiate a media flow setup 982 at the application level.

At any point in the method of FIG. 9C, additional actions may be performed between WTRU-1 984, WTRU-2 986, WTRU-3 988, the CN 965, the media client application 966, the IUT service 968 and the TCP/IP stack 970.

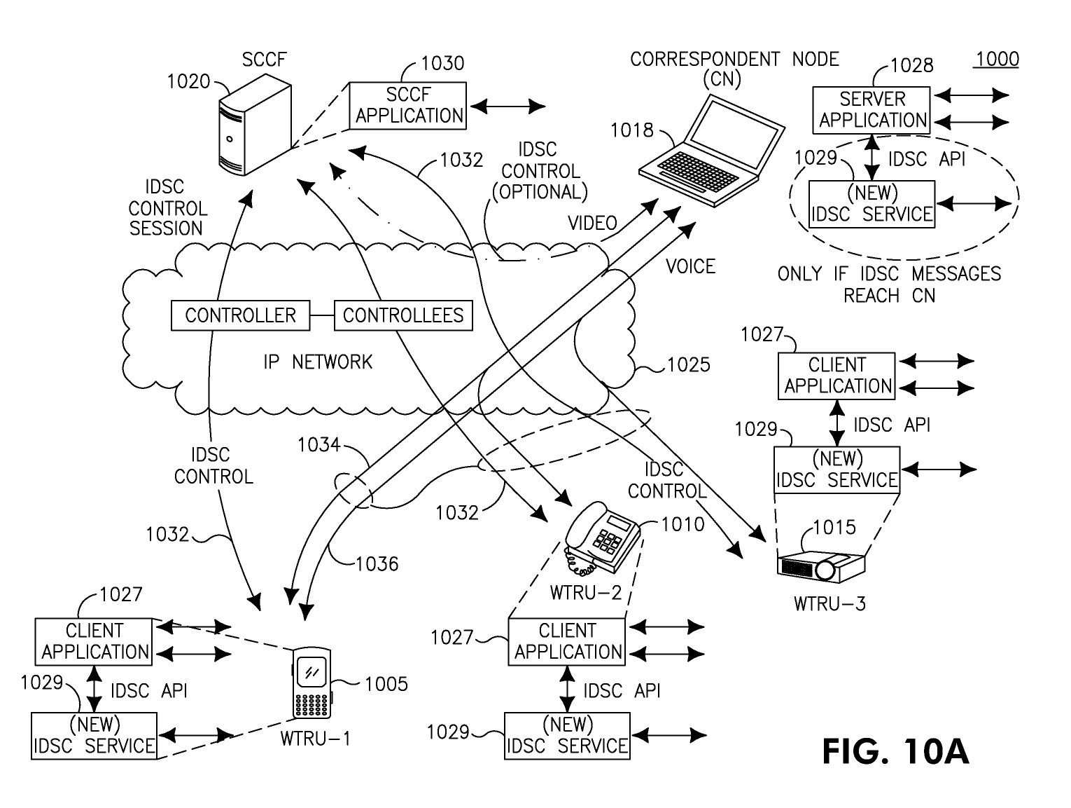

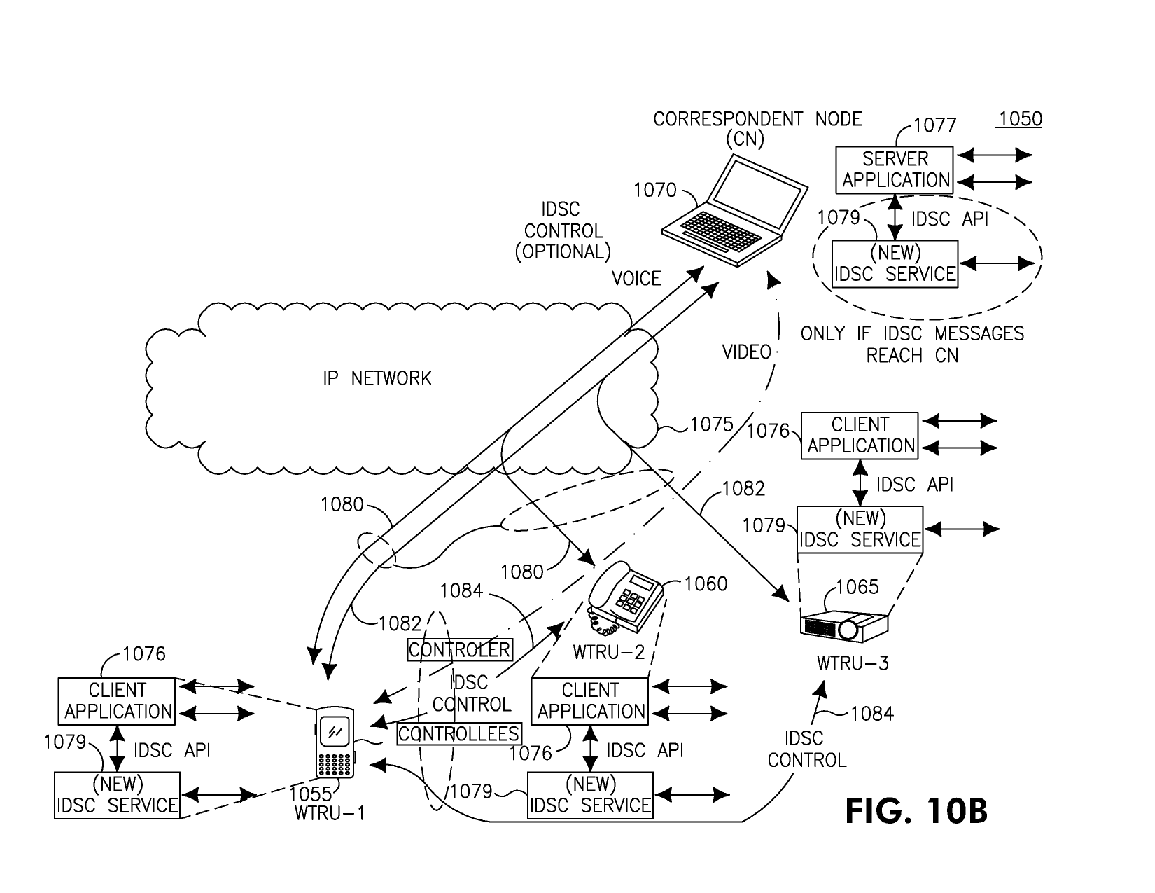

FIG. 10A is a diagram 1000 of a centralized IDSC operation wherein an SCCF node 1020 centralizes IDSC control. The use of a SCCF node 1020 allows for NAT traversal for clients while allowing for implementation of policy settings and protection against denial of service (DoS) attacks.

IDSC transfer may include peer discovery and IDSC Transport Channel Setup. Transport channels may be established on demand, or an existing channel, such as a Presence or a UPnP channel, may be used. An IDSC decision, which may be represented as an input to the IDSC service, may be initiated by a user, for example, via a user interface, or by a device, for example, based on a policy. Although FIGS. 10A-18B2 show IDSC using RTSP, IDSC may be similarly used with any other protocol. IDSC transfer may be performed with IDSC server support (full IDSC), or without (limited IDSC). An IDSC transfer may be centrally, or peer to peer (P2P) controlled. A WTRU may be able to perform a full, or limited, IDSC operation using a centrally controlled, or a P2P controlled, IDSC.

IDSC control may be established using a IDSC protocol or an extension of an existing protocol such as UPnP. Voice and video data may be transferred from WTRU-1 1005 to WTRU-2 1010 and/or WTRU-3 1015 via an IDSC framework using the SCCF node 1020 to centralize IDSC control. The voice and video data may be transported using any application protocol including but not limited to RSP/RTP or HTTP.

WTRU-1 1005, WTRU-2 1010 and WTRU-3 1015 may include a client application 1027 that uses an IDSC API to communicate with an IDSC service 1029. The IDSC service 1029 is a software component for handling IDSC messages. The SCCF node 1020 includes an SCCF application 1030 which may allow for IDSC control to be established between the SCCF node 1020 and the CN 1018. The CN 1018 includes a server application 1028 that uses an IDSC API to communicate with the IDSC service 1029.

When the CN 1018 is involved in the IDSC procedure, aggregated media flows may stay aggregated when they are moved or duplicated on different devices. Aggregated media flows may also stay synchronized after the movement or duplication on another device which may allow for more flexible policy enforcement.

WTRU-1 1005 may establish an IDSC control session 1032 with the SCCF node 1020 via an IP network 1025, wherein WTRU-1 1005 is the controller for the media sessions. WTRU-2 1010 and WTRU-3 1015 may establish an IDSC control session 1032 with the SCCF node 1020 via the IP network 1025. WTRU-2 1010 and WTRU-3 1015 are controlees for the media sessions.

The WTRU-1 1005 establishes a voice and video session 1034,1036 with the CN 1018 over an IP network 1025. WTRU-1 1005 may decide to initiate an IUT of session information, or to initiate a collaborative session with WTRU-2 1010 and/or WTRU-3 1015. WTRU-1 1005 may establish a connection with WTRU-2 1010 over an IP network 1025 using the CN 1018 in order to transfer voice information 1034. Similarly, WTRU-1 1005 may establish a connection with WTRU-3 1015 over an IP network 1025 using the CN 1018 in order to transfer video information 1036.

At any point in the method of FIG. 10A, additional actions may be performed between WTRU-1 1005, WTRU-2 1010, WTRU-3 1015, the CN 1018 and the SCCF node 1020.

FIG. 10B is a diagram 1050 of a decentralized IDSC operation wherein a controller WTRU, WTRU-1 1055, communicates directly with controlee WTRUs, WTRU-2 1060 and WTRU-3 1065, using an IDSC control framework. IDSC may include centralized or decentralized (P2P) IDSC control. Centralized IDSC, may include the use of a SCCF, NAT traversal for access devices, policy centralization, and may protect against DoS attacks. A centralized IDSC transfer may include some IDSC operations without the use of a specialized server application.

Decentralized IDSC, such as P2P IDSC, may include control by a Remote Device and may be infrastructure independent. Aggregated media flows, such as video and audio media flows, may remain aggregated when transferred or duplicated on different devices. An aggregate media flow, including the audio on a first access device, the video on a second access device, and a duplicated video flow a third access device, may be paused. An aggregated flow may remain synchronized after a media flow in the aggregated flow is transferred or duplicated. P2P IDSC may include flexible policy enforcement.

Application level IDSC, such as IDSC for RTSP/RTP client-server applications may include the use of application specific identifiers. RTSP may include a network protocol used to control a streaming media server. Access devices, such as a WTRU, may control streaming using media control methods, such as play or pause.

WTRU-1 1055, WTRU-2 1060 and WTRU-3 1065 may include a client application 1076 that uses an IDSC API to communicate with an IDSC service 1079. The IDSC service 1079 is a software component for handling IDSC messages. The CN 1070 includes a server application 1077 that uses an IDSC API to communicate with the IDSC service 1079. However, the CN 1070 may not be involved in the IDSC procedure. When the CN 1070 is not involved in the IDSC procedure, IDSC operations may be performed without the need to modify the server application or the client-server protocol. In addition, client application changes are less complex since the client-server protocol need not change.

WTRU-1 1055 may establish an IDSC control session 1084 with WTRU-2 1060, WTRU-3 1065 and optionally the CN 1070, wherein WTRU-1 1055 is the controller for the media sessions. WTRU-2 1060 and WTRU-3 1065 are controlees for the media sessions.

The WTRU-1 1055 may establish a voice 1080 and video session 1082 with the CN 1070 over an IP network 1075. WTRU-1 1055 may decide to initiate an IUT of session information, or to initiate a collaborative session with WTRU-2 1060 and/or WTRU-3 1065. WTRU-1 1055 may establish a connection with WTRU-2 1060 over an IP network 1075 using the CN 1070 in order to transfer voice information 1080. Similarly, WTRU-1 1055 may establish a connection with WTRU-3 1065 over an IP network 1075 using the CN 1070 in order to transfer video information 1082.

At any point in the method of FIG. 10B, additional actions may be performed between WTRU-1 1055, WTRU-2 1060, WTRU-3 1065 and the CN 1070.

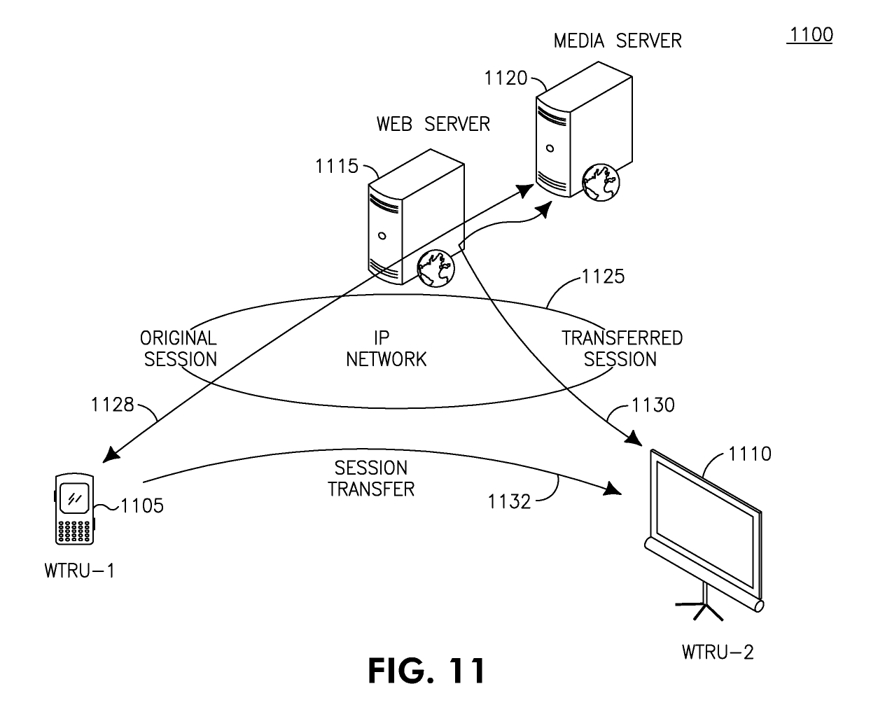

FIG. 11 is a high level diagram 1100 of media session transfer between WTRUs using a streaming media server. WTRU-1 1105, which may include a first IP client, may establish a streaming media session (Original Session) 1128 with a remote device, such as a media server 1120. The streaming media session may me performed via a discovery server, such as a web server 1115. The web server 1115 and the media server 1120 may be logical units and, optionally, may be a single physical unit. WTRU-1 1105 may transfer the session 1132 to WTRU-2 1110, which may include a second IP client. WTRU-1 1105 and WTRU-2 1110 may be capable of streaming media over the Internet. WTRU-1 1105, WTRU-2 1110, or both, may be associated with a subscription. WTRU-2 1110 may perform the transferred streaming media session (transferred session) 1130.

For example, WTRU-1 1105 may be performing a session 1128 including a streamed video via an air interface, such as a 3GPP air interface. WTRU-1 1105 may transfer the session 1132 to WTRU-2 1110, such as a large screen display, connected to a wired interface, such as a local area network (LAN). The session transfer 1132 may include a pause of the streaming video. The session may be continued 1130, for example, from the position where the video was paused on WTRU-2 1110. A session transfer may be initiated, for example, based on user input on WTRU-1 1105 or on WTRU-2 1110.

A stream may include a single media instance stream, such as an audio media instance or a video media instance. A stream may also include a whiteboard or shared application group. A stream, such as a stream using real-time transport protocol (RTP), may include RTP packets, Real Time Control Protocol (RTCP) packets, or both. The packets may be created by a source within an RTP session.

A presentation may include a set of one or more streams presented to a client as a media feed, and may include using a presentation description. For example, a presentation using RTSP may include performing aggregate control of one or more streams.

At any point in the method of FIG. 11, additional actions may be performed between WTRU-1 1105, WTRU-2 1110, the web server 1115 and the media server 1120.

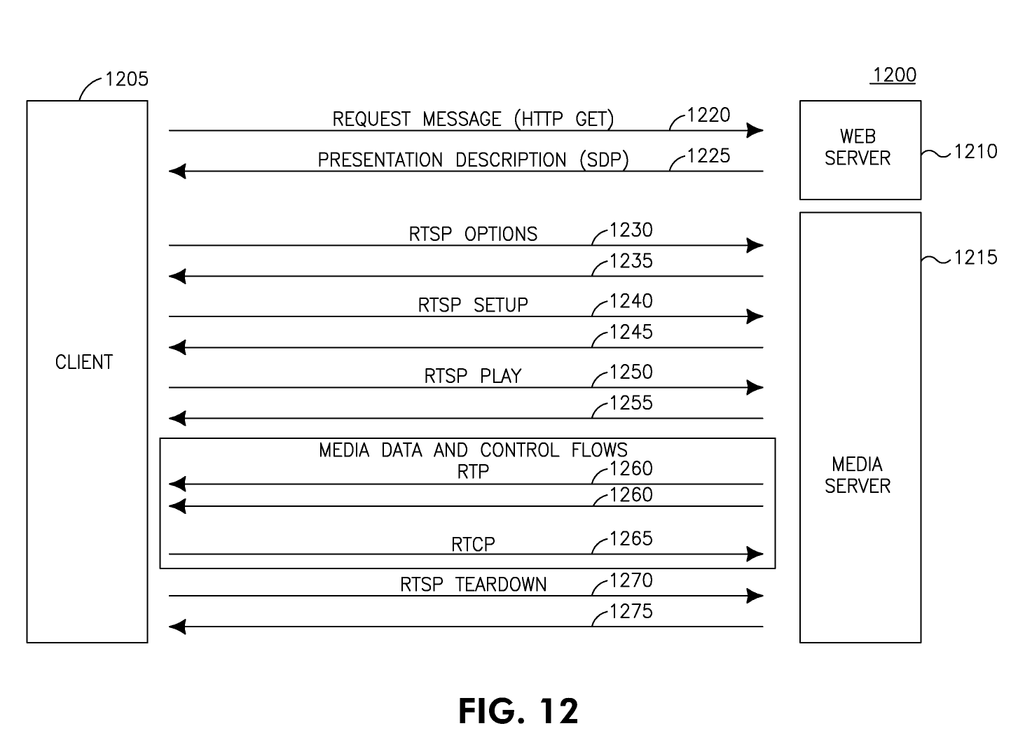

FIG. 12 is a flow diagram 1200 of an RTSP network protocol used to control a streaming media server 1215. Although FIG. 12 shows one example of an RTSP protocol stack, other configurations may be used. Communication protocols, such as RTSP may be used to provide streaming services, such as multimedia services. RTSP is a network control protocol for use in entertainment and communications systems to control streaming media servers.

As shown in FIG. 12, the WTRU may receive a presentation description from a media server using a message, such as RTSP DESCRIBE, and may use messages, such as RTSP SETUP, to handle media components.

A session description may include information regarding the media components and related encoding options. For example, a message, such as RTSP OPTIONS, may indicate Media Server capabilities; a message, such as RTSP SETUP, may indicate media stream transportation information, such as protocol or port; a message, such as RTSP PLAY, may initiate streaming, and a message, such as RTSP TEARDOWN, may stop streaming.

An IDSC capable device may identify another IDSC capable device using an identifier, such as an Application Name, which may include a unique string. For example, the unique string may include a mime type, such as, using application/x-rtsp, or a simple string, such as, using RTSP. The identifier may include additional support information that may indicate a best peer for a transfer/duplication. For example, an identifier, such as rtsp+idsc.basic, may indicate that the device supports an IDSC function, such as idsc.basic. A RTSP capable device, a IDSC capable device, or both, may be available for transfer, and the transfer method may depend on the target device.

An IDSC capable device may identify an application session using an identifier, such as an Application Session ID, for example a Session ID. The Application Session ID may be a number, such as in RTSP. The Application Session ID may uniquely identify an application session. The Application Session ID may be unique within the scope of a server application instance, such as the server application that created the Application Session ID. The scope may not contextual, and the application session ID may be associated with the server application instance, using, for example, an identification, such as a URL of the RTSP server.

An IDSC capable device may identify an IDSC Request using an identifier, such as, an IDSC Request ID. AN IDSC Request ID may be generated by an application server. An originating application access device may generate the IDSC Request ID where, for example, centralized IDSC is used. The scope may not be contextual, and the IDSC session ID may be associated with its creator, using, for example, an identification, such as a URL of the RTSP server.

RSTP controls the delivery of real-time data, such as audio data or video data, carried over multiple sessions, for example, using user datagram protocol (UDP), multicast UDP and transmission control protocol (TCP). The data delivery mechanisms used by RTSP are based on real-time transport protocol (RTP). Clients of media servers issue VCR-like commands, such as play and pause, to facilitate real-time control of playback of media files from the server. RTSP may be used along with RTP/RTCP to implement media streaming.

RTSP may be used as a network remote control for a multimedia server. The streams controlled may be defined by a presentation description, such as Session Description Protocol (SDP). RTSP may be connection-less and a server may maintain a session using an identifier, such as a session label. An RTSP session may not be tied to a transport-level connection, such as a TCP connection. During an RTSP session, an RTSP client may open and close many reliable transport connections to a server, for example, to issue RTSP requests. The streams controlled by RTSP may use RTP, but may not depend on the transport mechanism.

RTSP may be similar in syntax and operation to other protocols, such as Hypertext Transfer Protocol (HTTP/1.1). RSTP may include an RSTP specific protocol identifier. RSTP may be stateful. Both the RSTP server and client may issue a request. Data controlled by an RSTP based session may be carried out-of-band by a different protocol. RTSP may use ISO 10646 (UTF-8). A RSTP Request-Universal Resource Indicator (URI) may contain an absolute URI.

RSTP may be used for retrieval of media from a media server 1215. For example, a client 1205 may request a presentation description via a protocol, such as HTTP 1220, 1225. RSTP may also be used for invitation of a media server 1215 to a conference. For example, a media server 1215 may be invited to join an existing conference, either to playback media into the presentation or to record all or a subset of the media in a presentation. In addition, RSTP may be used for addition of media to an existing presentation. For example, in a presentation, such as a live presentation, the server may indicate to the client that additional media may be available.

A request message 1220, such as an RSTP request message, may be sent from a client 1205 to a server 1210 or from a server 1210 to a client 1205. A request message 1220 may include, for example within the first line of that message, a method to be applied to a resource, an identifier of the resource, and a protocol version.

For example, a request message may be expressed as:

| | | |
|---|---|---|
| Request = | Request-Line | ; |
| *( | general-header | ; |
| \| | request-header | ; |
| \| | entity-header ) | ; |
| | CRLF | |
| | [ message-body ] | ; |

A Request-Line may be expressed as:

Request-Line = Method SP Request-URI SP RTSP-Version CRLF

| | |
|---|---|
| Method = “DESCRIBE” | ; |

| | | |
|---|---|---|
| \| | “ANNOUNCE” | ; |
| \| | “GET_PARAMETER” | ; |
| \| | “OPTIONS” | ; |
| \| | “PAUSE” | ; |
| \| | “PLAY” | ; |
| \| | “RECORD” | ; |
| \| | “REDIRECT” | ; |
| \| | “SETUP” | ; |
| \| | “SET_PARAMETER” | ; |
| \| | “TEARDOWN” | ; |
| \| | extension-method | |

A request-header may be expressed as:

| | |
|---|---|
| request-header = Accept | ; |

| | | |
|---|---|---|
| \| | Accept-Encoding | ; |
| \| | Accept-Language | ; |
| \| | Authorization | ; |
| \| | From | ; |
| \| | If-Modified-Since | ; |
| \| | Range | ; |
| \| | Referer | ; |
| \| | User-Agent | ; |

Table 1 shows an example of RTSP methods. A direction of a method may be indicated as client-to-server (C->S) or server-to-client (S->C). A RTSP method may be associated with an object, such as a presentation (P) or a stream (S).

TABLE 1

| method | direction | object | note |
|---|---|---|---|
| DESCRIBE | C->S | P, S | recommended |
| ANNOUNCE | C->S, S->C | P, S | Optional |
| GET_PARAMETER | C->S, S->C | P, S | Optional |
| OPTIONS | C->S | P, S | Required |
| | S->C | P, S | Optional |
| PAUSE | C->S | P, S | recommended |
| PLAY | C->S | P, S | Required |
| RECORD | C->S | P, S | Optional |
| REDIRECT | S->C | P, S | Optional |
| SETUP | C->S | S | Required |
| SET_PARAMETER | C->S, S->C | P, S | Optional |
| TEARDOWN | C->S | P, S | Required |

A client 1205 may transmit a request message 1220, such as an RTSP or an HTTP request, to the web server 1210 to get presentation information. A presentation description 1225 including a session description protocol (SDP) may be transmitted from the web server 1210 to the client 1205. The client 1205 may send a request message, such as an RTSP request, to the media server 1215 to receive RTSP options 1230, RTSP setup information 1240 and RTSP play information 1250. The RTSP options request 1230 is a request for media server capabilities. The RTSP setup request 1240 is used to specify the transport method for a media stream. The RTSP play request 1250 triggers streaming.

The client 1205 may receive a response to each request 1235, 1245, 1250, from the media server 1215. The media server 1215 may also send media data and control flow RTP 1260 and the client 1205 may send in response a RTCP 1265. The client 1205 may also sent a RTSP teardown request 1270 to the media server 1215 and may receive a response 1275 to the teardown request. The teardown request is a request to stop streaming.

At any point in the method of FIG. 12, additional actions may be performed between the client 1205, the web server 1210 and the media server 1215.

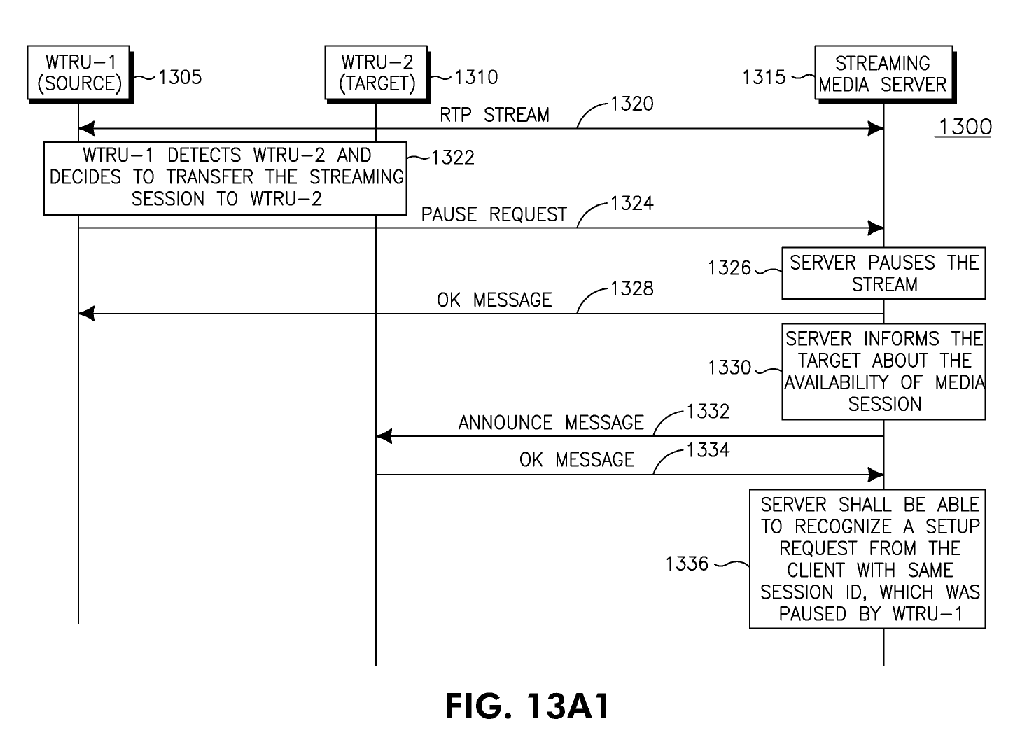

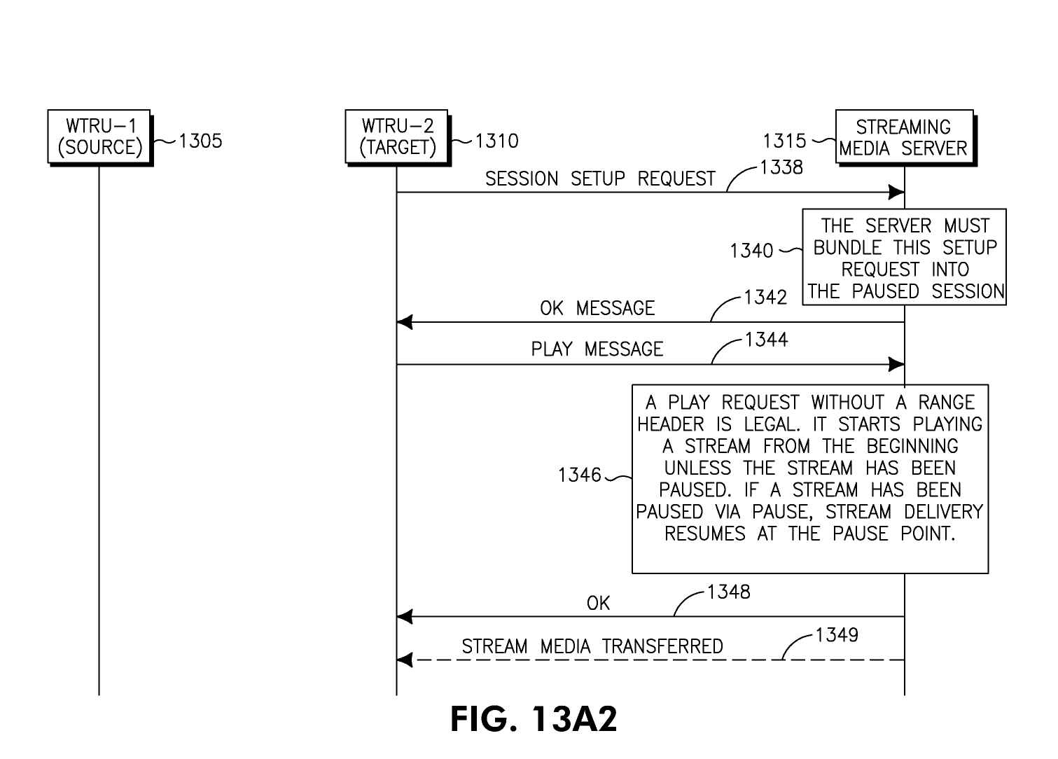

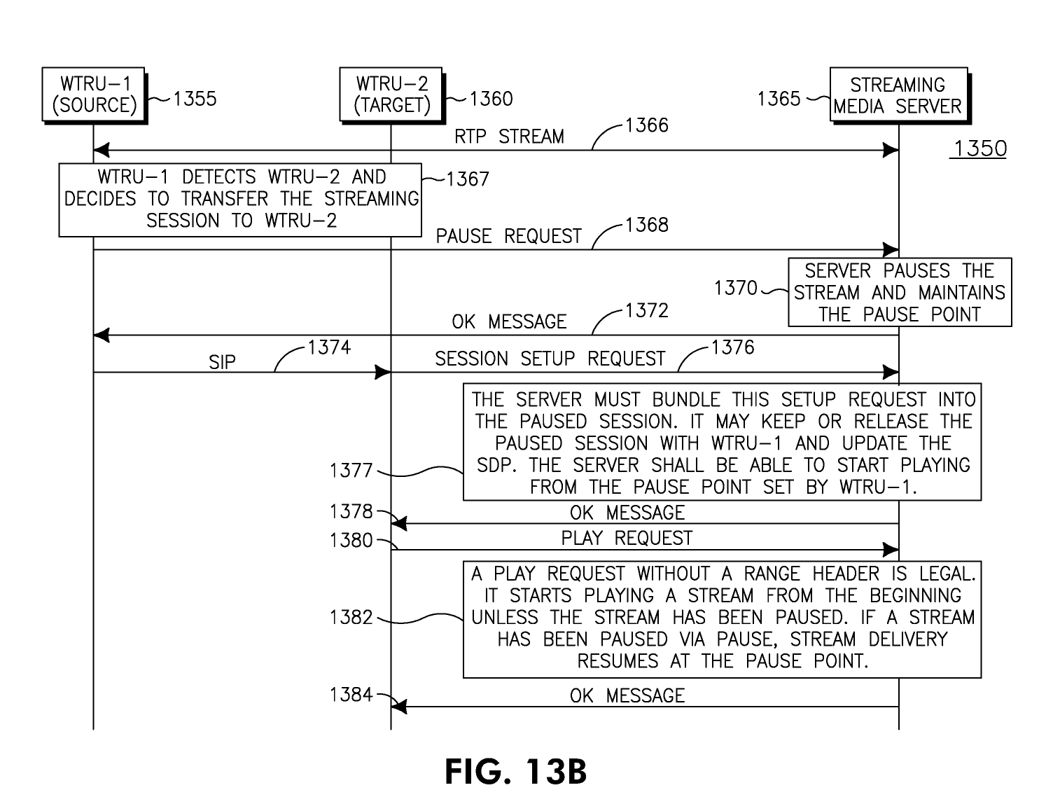

FIGS. 13A1 and 13A2 are flow diagrams 1300 of active device initiated transfer of media streams. An active device is a source WTRU that is playing streamed media. WTRU-1 1305 is the active device. WTRU-2 1310 is a target device. Both WTRU-1 1305 and WTRU-2 1310 have registered with the RTSP server and have exchanged capability information with the RTSP server. Included in the capability exchange is information regarding whether WTRU-1 1305 or WTRU-2 1310 support an ANNOUNCE method. An ANNOUNCE method is a method used to notify a WTRU about a media stream transfer.

WTRU-1 1305 establishes an RTP stream 1320 with the streaming media server 1315. WTRU-1 1305 may detect the availability 1322 of WTRU-2 1310 and may decide to transfer the streaming media session 1322 to WTRU-2 1310. WTRU-1 1305 may initiate a pause of the streaming media 1324. For example, WTRU-1 1305 may send a pause request 1324, such as a PAUSE message or a TRANSFER message, to the server 1315. The pause request 1324 may include an identity of WTRU-2 1310, the target WTRU, and an Information Element (IE), such as a TransferTo IE, which may indicate a targetURI. The pause request 1324 may also include additional information including but not limited to a range header to indicate a pause point for the streaming media, a session ID and a CSeq field. The CSeq field specifies the sequence number for an RTSP request/response message pair.

The server 1315 may pause the streaming media 1326. For example, if the pause request 1324 includes a range header, the server 1315 may pause the streaming media at the pause point indicated by the range header. If the pause request 1324 does not include a range header, stream delivery may be interrupted immediately on receipt of the message and the pause point may be set to the current normal play time. In response to a PAUSE request, the server may discard queued PLAY requests. However, the pause point in the media stream may be maintained. A subsequent PLAY request without a range header may resume the media stream from the pause point. The server 1315 may send an OK message 1328 to WTRU-1 1305. The OK message 1328 may include a CSeq and a timestamp.

The server 1315 may send a message 1332, such as an ANNOUNCE message to WTRU-2 1310, indicating the session transfer. The message may include a session ID, an indication that the message is a Transfer Request or, alternatively, the message may include a session description of the paused session. In addition, the message 1332 may include a CSeq, additional RTP information and a content type. WTRU-2 1310 may use information in the message to perform the session.

The ANNOUNCE message may be part of the RTSP protocol. The ANNOUNCE method may be used by the server 1315 to asynchronously publish session descriptions or other event information. For example, the server 1315, or the client, may publish a session description pertinent to a RTSP session URL. For example, a multi-unicast live video server utilizing RTSP may publish an updated SDP to indicate a new media track added to the RTSP session. A client may receive the ANNOUNCE request, which may include with an SDP entity body, and the client may, optionally, perform SETUP on the newly available media track.

WTRU-2 1310 may send an OK message 1334 to the server and may initiate a setup of the session 1336 and play of the streaming media. The OK message 1334 may include CSeq and a session ID.

As shown in FIG. 13A2, WTRU-2 1310 may send a setup request 1338 to the server 1315 to initiate the streaming media. The setup request 1338 may include a session ID associated with the session, a CSeq and a transport field. Based on the session ID, the server may recognize the session as the session paused by WTRU-1 1305.

The server 1315 may bundle the setup request into the paused session 1340. Optionally, the server 1315 may release the paused session 1340 with WTRU-1 1305 and update the SDP. The server may send a message, such as an OK message 1342, to WTRU-2 1310. The OK message 1342 may include a CSeq, timestamp, session ID and transport.

The WTRU-2 1310 may initiate play of the streaming media and may send a message, such as a PLAY request 1344, to the server 1315 to initiate playback. The PLAY request 1344 may include a CSeq and a session ID. Optionally, the message may include a range header. The server 1315 may resume playback 1346 from the beginning, from a point indicated in a range header, or from a pause point, if the stream was paused. The server 1315 may send an OK message 1348 to the WTRU-2 1310 and may transfer the session 1349 to WTRU-2 1310. The OK message 1348 may include a CSeq and timestamp.

At any point in the method of FIGS. 13A1 and 13A2, additional actions may be performed between WTRU-1 1305, WTRU-2 1310 and the media server 1315.

FIG. 13B is a flow diagram 1350 of an alternative to the ANNOUNCE method, wherein WTRU-1 1355 may target WTRU-2 1360 directly by using a SIP refer request to indicate to WTRU-2 1360 the transferred media.

Both WTRU-1 1355 and WTRU-2 1360 have registered with the RTSP server and have exchanged capability information with the RTSP server. WTRU-1 1355 establishes an RTP stream 1366 with the streaming media server. WTRU-1 1355 may detect the availability of WTRU-2 1360 and may decide to transfer the streaming media session 1367 to WTRU-2 1360. WTRU-1 1355 may initiate a pause 1368 of the streaming media. For example, WTRU-1 1355 may send a pause request 1368, such as a PAUSE message to the server 1365. The pause request 1368 may include a range header to indicate a pause point for the streaming media, a session ID and a CSeq.

The server 1365 may pause the streaming media 1370 and may maintain the pause point. For example, if the pause request 1368 includes a range header the server 1365 may pause the streaming media at the pause point indicated by the range header. If the pause request 1368 does not include a range header, stream delivery may be interrupted immediately on receipt of the message and the pause point may be set to the current normal play time. In response to a PAUSE request, the server 1365 may discard queued PLAY requests. However, the pause point in the media stream may be maintained. A subsequent PLAY request without a range header may resume the media stream from the pause point. The server 1365 may send an OK message 1372 to WTRU-1 1355. The OK message 1372 may include a CSeq and a timestamp.

WTRU-1 1355 may send a SIP refer message 1374 to WTRU-2 1360 with a SDP of the paused session. The SIP refer message 1374 may be sent directly via P2P, or indirectly through another node routing SIP messages.

WTRU-2 1360 may send a setup request 1376 to the server 1365 to initiate the streaming media. The setup request 1376 may include a session ID associated with the session, a CSeq and a transport field. Based on the session ID, the server 1365 may recognize the session as the session paused by WTRU-1 1355.

The server 1365 may bundle the setup request 1377 into the paused session. Optionally, the server 1365 may release the paused session with WTRU-1 1355 and update the SDP. The server 1365 may send a message, such as an OK message 1378, to WTRU-2 1360. The OK message 1378 may include a CSeq, timestamp, session ID and transport.

The WTRU-2 1360 may initiate play of the streaming media by sending a message 1380, such as a PLAY request, to the server 1365 to initiate playback. The PLAY request 1380 may include a CSeq and a session ID. Optionally, the message 1380 may include a range header. The server 1365 may resume playback from the beginning, from a point indicated in a range header, or from a pause point, 1382 if the stream was paused. The server 1365 may send an OK message 1384 to the WTRU-2 1360 and may transfer the session to WTRU-2 1360. The OK message 1384 may include a CSeq and timestamp.

At any point in the method of FIG. 13B, additional actions may be performed between WTRU-1 1355, WTRU-2 1360 and the media server 1365.

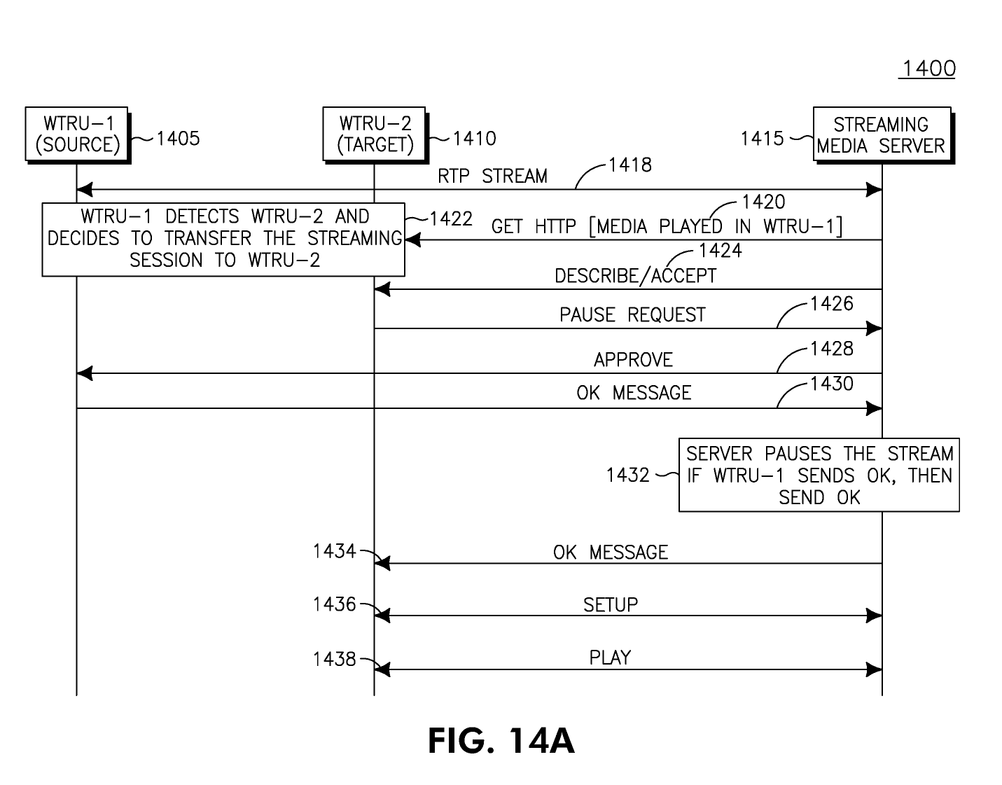

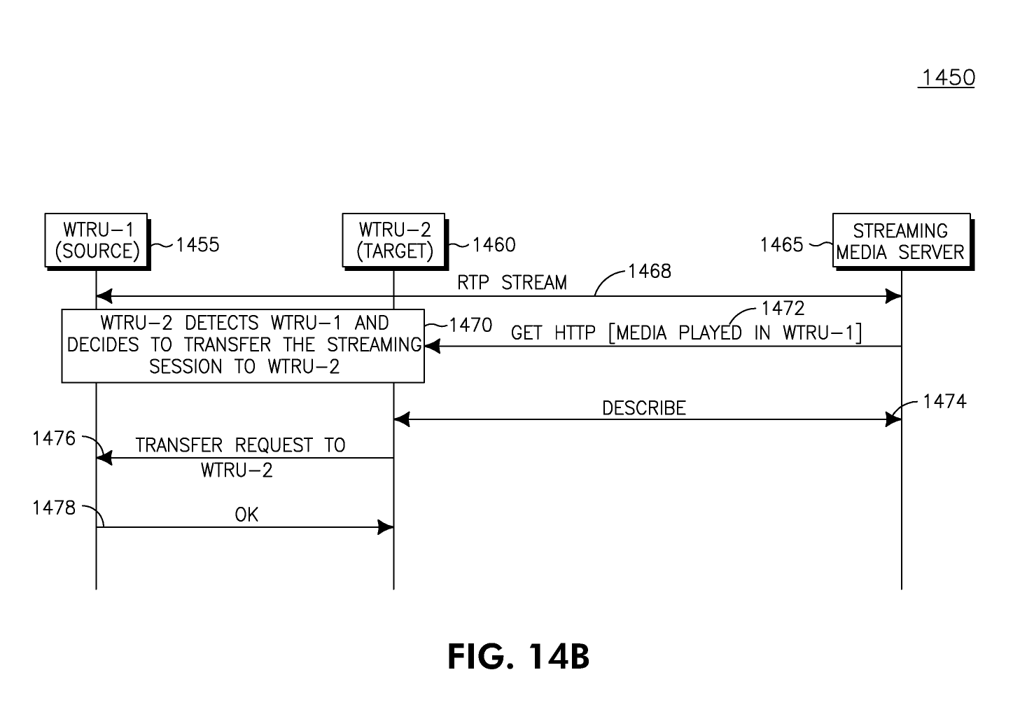

FIG. 14A is a flow diagram 1400 of target device initiated transfer of media streams. An active device may be a source WTRU that is playing streamed media. WTRU-1 1405 may be the source device while WTRU-2 1410 may be the target device. Both WTRU-1 1405 and WTRU-2 1410 have registered with the RTSP server and have exchanged capability information with the RTSP server. Included in the capability exchange is information regarding whether WTRU-1 1405 or WTRU-2 1410 support an ANNOUNCE method.

WTRU-1 1405 establishes an RTP stream 1418 with the streaming media server 1415. WTRU-2 1410 may detect the availability 1422 of WTRU-1 1405 and may decide to transfer the streaming media session to itself. An HTTP get request and response 1420 is transmitted between WTRU-2 1410 and the media server 1415. In addition, a describe and accept message 1424 may be exchanged between WTRU-2 1410 and the media server 1415. WTRU-2 1410 may initiate a pause of the streaming media by sending a pause request 1426, such as a PAUSE message or a TRANSFER message, to the server 1415. The pause request 1426 may include an identity of WTRU-1 1405, the source WTRU, and an Information Element (IE), such as a TransferTo IE, which may indicate a targetURI. The pause request 1426 may also include a range header to indicate a pause point for the streaming media, a session ID and a CSeq.

The server 1415 may send a message 1428, such as an ANNOUNCE message to WTRU-1 1405, indicating the session transfer. The message 1428 may include a session ID, an indication that the message is a target initiated transfer request or, alternatively, the message 1428 may include a session description of the paused session. In addition, the message may include a CSeq.

WTRU-1 1405 may send an OK message 1430 to the server 1415. The OK message 1434 may include CSeq and a session ID. The server 1415 may pause the streaming media 1432.

The server 1415 may send an OK message 1434 to WTRU-1 1405. The OK message 1434 may include a CSeq and a timestamp. The media server 1415 and WTRU-2 1410 may exchange setup information 1436 including a session ID, CSeq and transport information.

The WTRU-2 1410 may initiate play of the streaming media by sending a message 1438, such as a PLAY request, to the server 1415 to initiate playback. The PLAY request 1438 may include a CSeq and a session ID. Optionally, the message 1438 may include a range header. The server 1415 may resume playback from the beginning, from a point indicated in a range header, or from a pause point, if the stream was paused.

At any point in the method of FIG. 14A, additional actions may be performed between WTRU-1 1405, WTRU-2 1410 and the media server 1415.

FIG. 14B is a flow diagram 1450 of target device initiated transfer of media streams in peer to peer communications. Both WTRU-1 1455 and WTRU-2 1460 have registered with the RTSP server and have exchanged capability information with the RTSP server. Included in the capability exchange is information regarding whether WTRU-1 1455 or WTRU-2 1460 support an ANNOUNCE method.

WTRU-1 1455 establishes an RTP stream 1468 with the streaming media server 1465. WTRU-2 1460 may detect the availability 1470 of WTRU-1 1455 and may decide to transfer the streaming media session to itself 1470. An HTTP get request and response 1472 is transmitted between WTRU-2 1460 and the media server 1465. In addition, a describe and accept message 1474 may be exchanged between WTRU-2 1460 and the media server 1465. WTRU-2 1460 may send a transfer request 1476 to WTRU-1 1455. WTRU-1 1455 may send an OK message 1478 to WTRU-2 1460.

In an alternate embodiment to FIG. 14B, WTRU-2 1460 may send a pause request, such as a PAUSE message or a TRANSFER message, to the server 1465. The pause request may include an identity of WTRU-1 1455, the source WTRU, and an Information Element (IE), such as a TransferTo IE, which may indicate a targetURI. The pause request may also include a range header to indicate a pause point for the streaming media, a session ID and a CSeq.

The server 1465 may send a message, such as an ANNOUNCE message to WTRU-1 1455, indicating the session transfer. The message may include a session ID, an indication that the message is a Target Initiated Transfer Request or, alternatively, the message may include a session description of the paused session. In addition, the message may include a CSeq.

WTRU-1 1455 may send an OK message to the server 1465. The OK message may include CSeq and a session ID. The server 1465 may pause the streaming media.

The server 1465 may send an OK message to WTRU-1 1455. The OK message may include a CSeq and a timestamp. The media server 1465 and WTRU-2 1460 may exchange setup information including a session ID, CSeq and transport information.

The WTRU-2 1460 may initiate play of the streaming media. For example, WTRU-2 1460 my send a message, such as a PLAY request, to the server 1465 to initiate playback. The PLAY request may include a CSeq and a session ID. Optionally, the message may include a range header. The server 1465 may resume playback from the beginning, from a point indicated in a range header, or from a pause point, if the stream was paused.

The server 1465 may send a message, such as an ANNOUNCE message to WTRU-1 1455, indicating the session transfer. The message may include a session ID, an indication that the message is a Target Initiated Transfer Request or, alternatively, the message may include a session description of the paused session. In addition, the message may include a CSeq.

WTRU-1 1455 may send an OK message to the server 1465. The OK message may include CSeq and a session ID. The server 1465 may pause the streaming media.

The server 1465 may send an OK message to WTRU-1 1455. The OK message may include a CSeq and a timestamp. The media server 1465 and WTRU-2 1460 may exchange setup information including a session ID, CSeq and transport information.

The WTRU-2 1460 may initiate play of the streaming media. For example, WTRU-2 1460 my send a message, such as a PLAY request, to the server 1465 to initiate playback. The PLAY request may include a CSeq and a session ID. Optionally, the message may include a range header. The server may resume playback from the beginning, from a point indicated in a range header, or from a pause point, if the stream was paused.

In an alternate embodiment to FIG. 14B, WTRU-1 1455 may initiate a pause of the streaming media. For example, WTRU-1 1455 may send a pause request, such as a PAUSE message or a TRANSFER message, to the server 1465. The pause request may include an identity of WTRU-2 1460, the target WTRU, and an Information Element (IE), such as a TransferTo IE, which may indicate a targetURI. The pause request may also include a range header to indicate a pause point for the streaming media, a session ID and a CSeq.

The server 1465 may pause the streaming media. In response to a PAUSE request, the server may discard queued PLAY requests. However, the pause point in the media stream may be maintained. A subsequent PLAY request without a range header may resume the media stream from the pause point. The server 1465 may send an OK message to WTRU-1 1455. The OK message may include a CSeq and a timestamp.

The server 1465 may send a message, such as an ANNOUNCE message to WTRU-2 1460, indicating the session transfer. The message may include a session ID, an indication that the message is a Transfer Request or, alternatively, the message may include a session description of the paused session. In addition, the message may include a CSeq, additional RTP information and a content type. WTRU-2 1460 may use information in the message to perform the session.

WTRU-2 1460 may send an OK message to the server 1465 and may initiate a setup of the session and play of the streaming media. The OK message may include CSeq and a session ID. For example, WTRU-2 1460 may send a setup request to the server 1465 to initiate the streaming media. The setup request may include a session ID associated with the session, a CSeq and a transport field. Based on the session ID, the server may recognize the session as the session paused by WTRU-1 1455.

The server 1465 may bundle the setup request into the paused session. Optionally, the server 1465 may release the paused session with WTRU-1 1455 and update the SDP. The server 1465 may send a message, such as an OK message, to WTRU-2 1460. The OK message may include a CSeq, timestamp, session ID and transport.

The WTRU-2 1460 may initiate play of the streaming media. For example, WTRU-2 1460 may send a message, such as a PLAY request, to the server 1465 to initiate playback. The PLAY request may include a CSeq and a session ID. Optionally, the message may include a range header. The server 1465 may resume playback from the beginning, from a point indicated in a range header, or from a pause point, if the stream was paused. The server 1465 may send an OK message to the WTRU-2 1460 and may transfer the session to WTRU-2 1460. The OK message may include a CSeq and timestamp.

At any point in the method of FIG. 14B, additional actions may be performed between WTRU-1 1455, WTRU-2 1460 and the media server 1465.

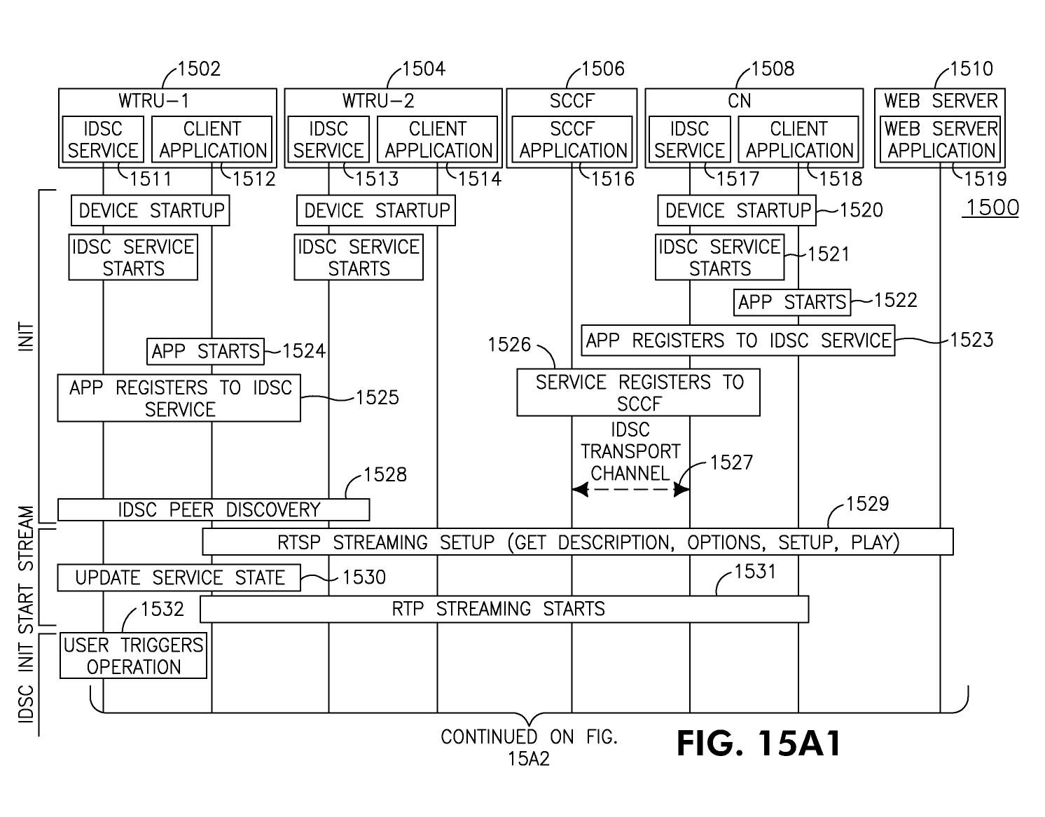

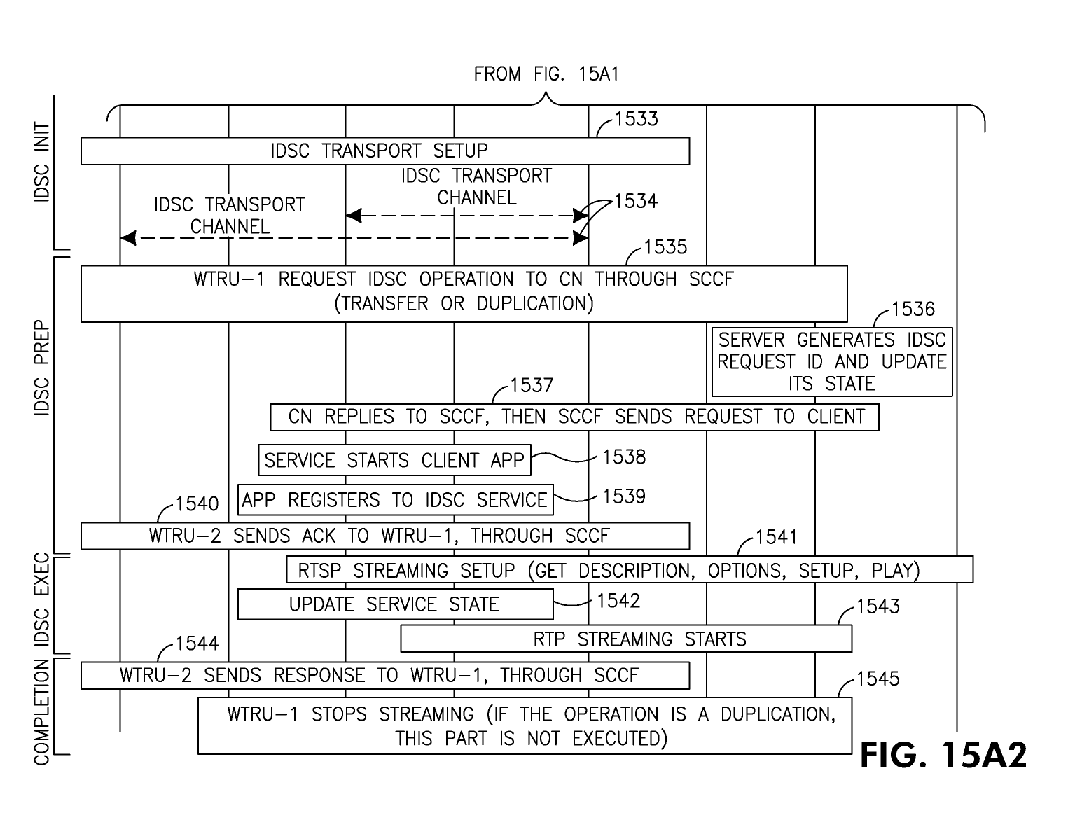

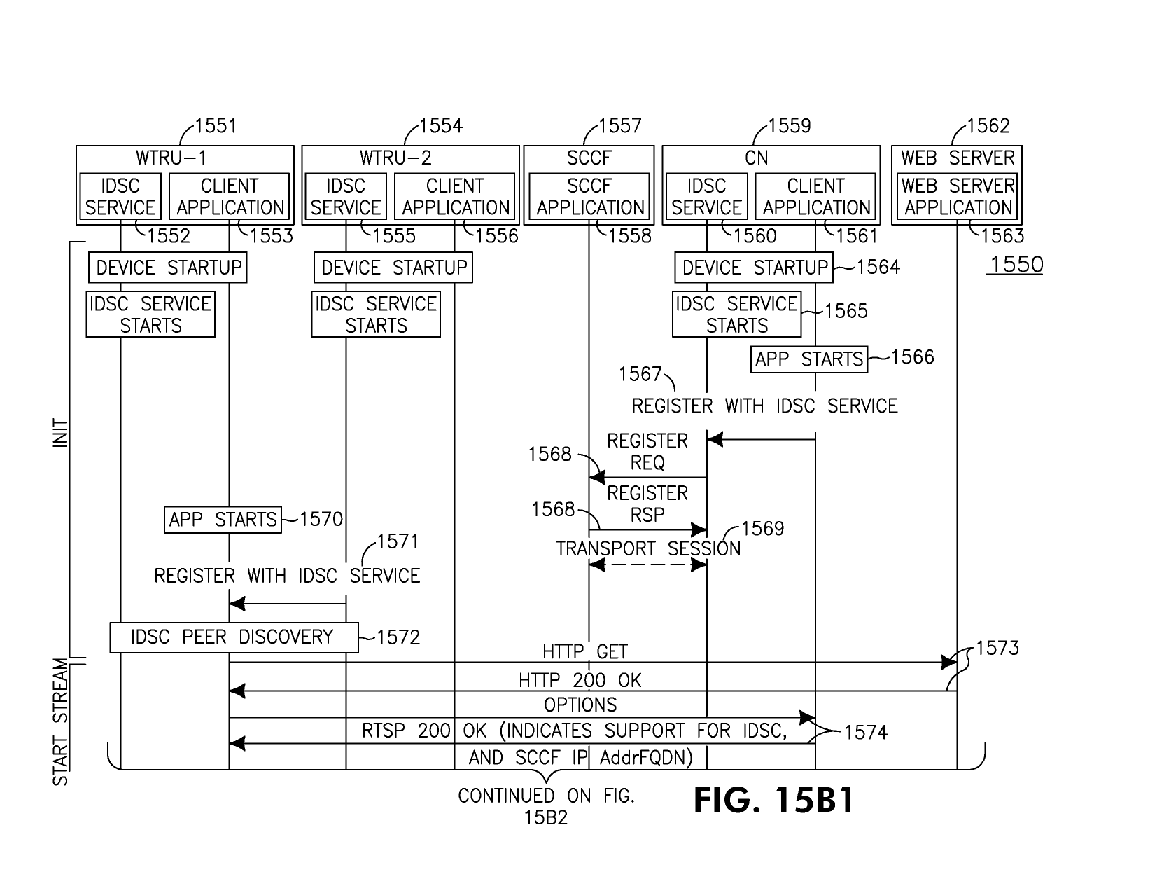

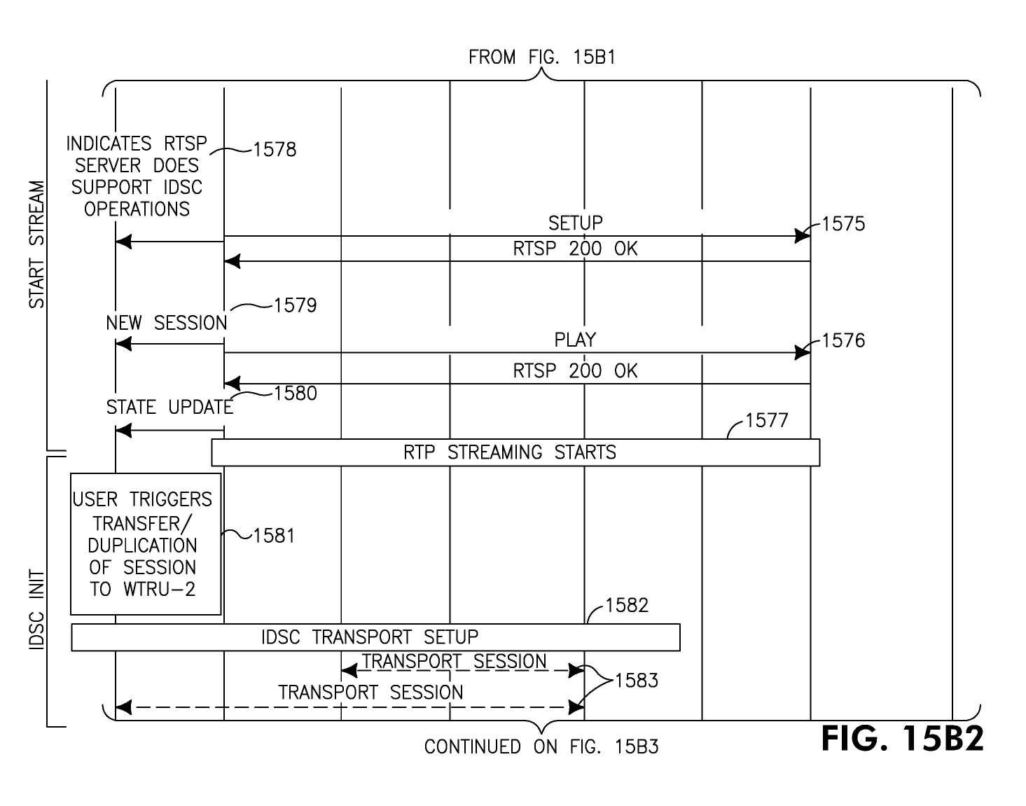

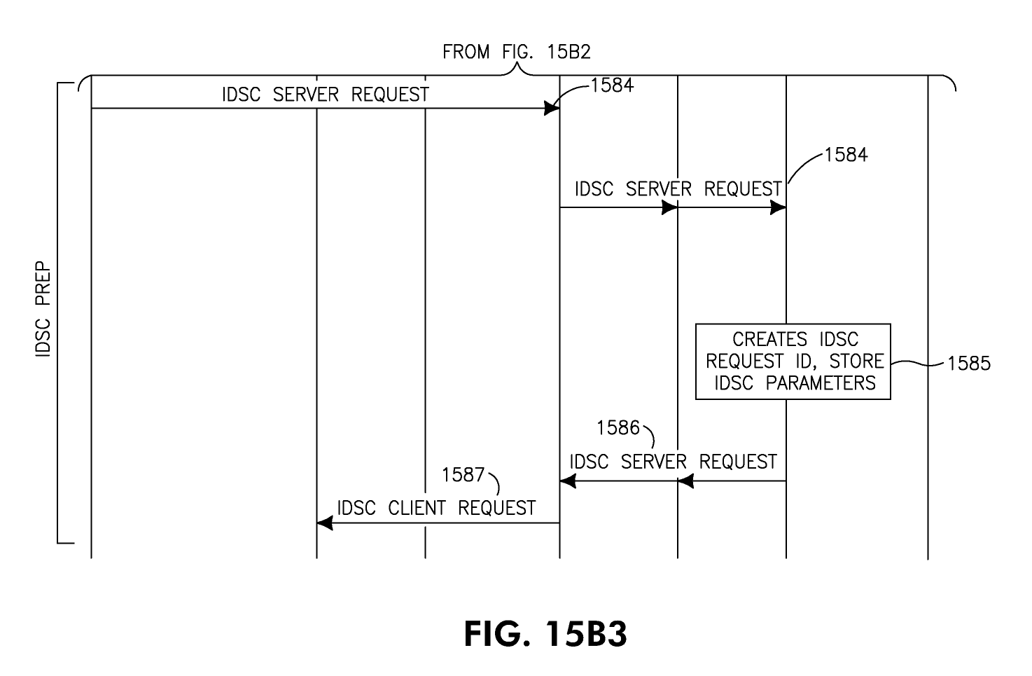

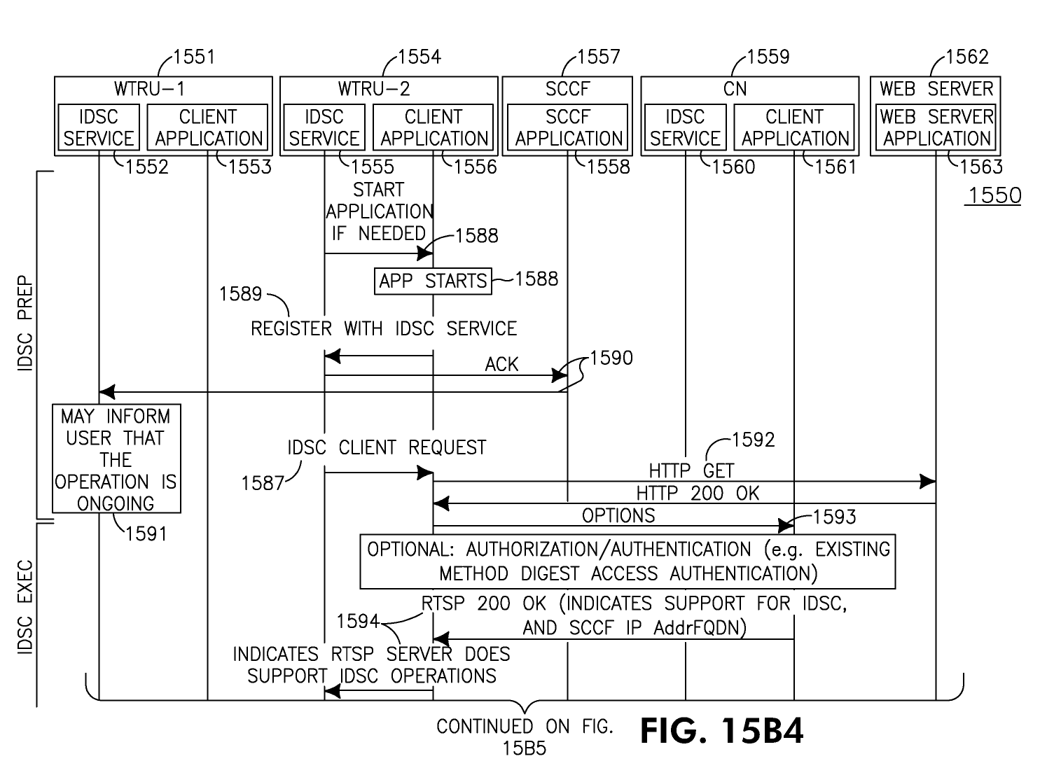

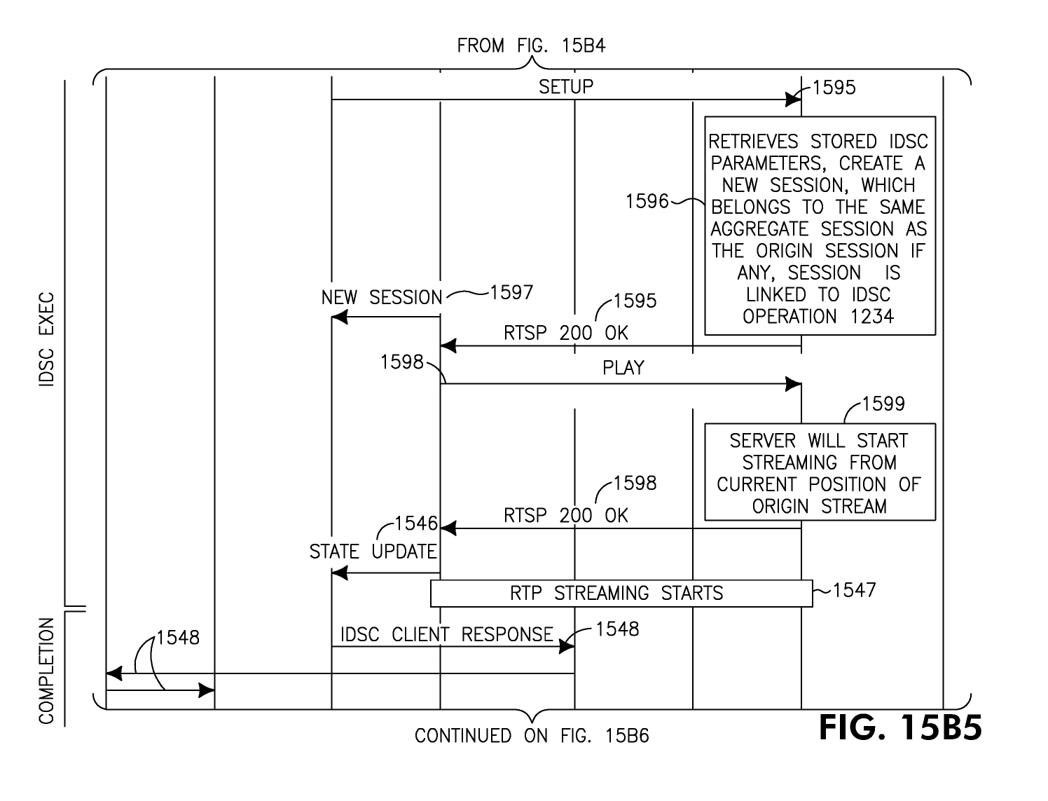

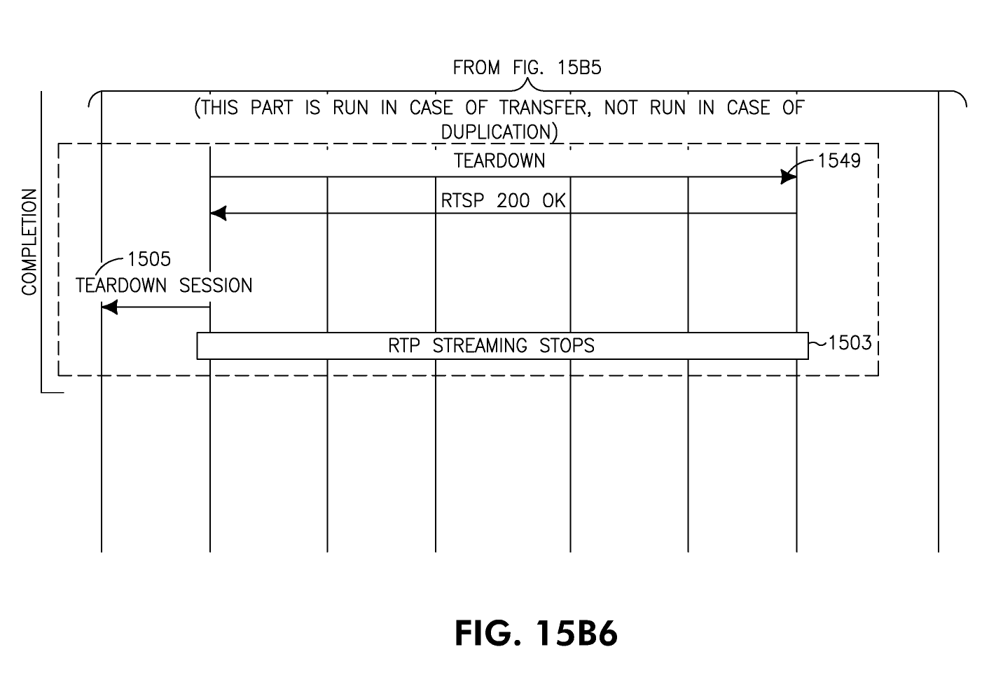

FIGS. 15A1 and 15A2 are a high level flow diagram 1500 of centralized IDSC using RTSP. An IDSC protocol may be used to prepare a transfer or duplication of an operation and may use an RTSP application protocol to perform the operation. IDSC messages may pass through the SCCF node 1506. The SCCF node 1506 may used for NAT traversal, policy enforcement or charging.

In the initialization stage of IDSC WTRU-1 1502, WTRU-2 1504 and the CN 1508 initiate device start-up 1520 and their IDSC services start 1521. In the CN 1508 the server application 1518 starts 1522 and registers 1523 to the IDSC service 1517, and in WTRU-1 the client application 1512 starts 1524 and registers 1525 to the IDSC service 1511. The IDSC service 1517 in the CN 1508 registers 1526 with the SCCF 1516 and establishes an IDSC transport channel 1527. The IDSC service 1511 in the WTRU-1 1502 initiates peer discovery 1528 with the IDSC service 1513 of WTRU-2 1504.

In the start stream stage of IDSC, WTRU-1 1502 initiates RTSP streaming setup 1529 using its client application 1512 with the server application 1518 of the CN 1508 and the web server 1510 via the web server application 1519 by sending requests. The requests 1529 includes a GET request, an OPTION request, a SETUP request and a PLAY request. WTRU-1 1502 may update its service state 1530 and may begin RTP streaming 1531 with the CN 1508 via their respective client 1512 and server applications 1518.

In the IDSC initiation stage a user may trigger 1532 an operation and WTRU-1 1502 may establish an IDSC transport setup 1533 with WTRU-2 1504 via its IDSC service 1513 and the SCCF node 1506 via its SCCF application 1516. WTRU-1 1502 and WTRU-2 1504 may exchange IDSC transport channel information 1534 with the SCCF 1506.

In the IDSC preparation stage WTRU-1 1502 may send a request 1535 for an IDSC operation with the CN 1508 via the SCCF 1506. This may be a request for a transfer or a duplication of a media session. The CN server application 1518 may generate an IDSC request ID and may update its state 1536. The CN 1508 may send a response 1537 to WTRU-2 1504 via the SCCF node 1506. WTRU-2 1504 may initiate 1538 its client application 1514 and register 1539 with the IDSC service 1513. WTRU-2 1504 may send an ACK 1540 to WTRU-1 1502 via the SCCF node 1506.

In the IDSC execution stage WTRU-2 1504 may send RTSP streaming requests 1451 including a GET request, an OPTION request, a SETUP request and a PLAY request to the CN 1508 and the web server 1510. WTRU-2 1504 may update its service state 1542 and may begin RTP streaming 1543 with the CN 1508.

In the IDSC completion stage, WTRU-2 1504 may send a response 1544 to WTRU-1 1502 via the SCCF node 1506. WTRU-1 1502 may cease streaming 1545.

At any point in the method of FIGS. 15A1 and 15A2, additional actions may be performed between WTRU-1 1502, WTRU-2 1504, the SCCF node 1506, the CN 1508 and the web server 1510.

FIGS. 15B1, 15B2, 15B3, 15B4, 15B5 and 15B6 are detailed flow diagrams 1550 of centralized IDSC using RTSP.

In FIG. 15B1 the initialization stage and start stream of IDSC is shown. WTRU-1 1551, WTRU-2 1554 and the CN 1559 initiate device start-up1564 and the IDSC services start 1565. In the CN 1559 the server application 1561 starts 1566 and registers 1567 to the IDSC service 1560 by sending a register request 1567 to the SCCF node 1557 via the SCCF application 1558. The SCCF 1557 sends a register response 1568 and an IDSC transport session 1569 is established. In WTRU-1 1551 the client application 1553 starts 1570 and registers 1571 to the IDSC service 1553. The IDSC service 1553 in the WTRU-1 1551 initiates peer discovery 1572 with the IDSC service 1555 of WTRU-2 1554.

FIGS. 15B1 and 15B2 show the start stream stage of IDSC. WTRU-1 1551 initiates RTSP streaming setup via its client application 1553 by sending a HTTP GET request 1573 to the web server 1562 via the web server application 1563 and receiving an OK ACK 1573 from the web server 1562. WTRU-1 1551 may send requests to the server application including an option request 1574, a setup request 1575 and a play request 1576 and receiving an OK ACK 1574, 1575, 1576 from the CN server application 1561 in response to each request. WTRU-1 1551 may update its IDSC service state 1580 with information regarding whether the RTSP server supports IDSC operations 1578 and new session information 1579 including a session ID. WTRU-1 1551 may begin RTP streaming 1577 with the CN 1559 via their respective client 1553 and server applications 1561.

FIGS. 15B2 and 15B3 show in the IDSC initiation stage a user may trigger 1581 an operation such as a transfer or duplication of session and WTRU-1 1551 may establish an IDSC transport setup 1582 with WTRU-2 1554 and the SCCF node 1559. WTRU-1 1551 and WTRU-2 1554 may exchange IDSC transport channel information 1583 with the SCCF node 1559.

FIGS. 15B3 and 15B4 show in the IDSC preparation stage WTRU-1 1551 may send an IDSC server request message 1584 to the CN 1559 via the SCCF node 1557. The request message 1584 may include an indication of the type (i.e., transfer or duplicate), session ID, target information, description, media and authentication or authorization information. The CN server application 1561 may generate an IDSC request ID 1585, may update its state and may store IDSC parameters. The CN 1559 may send a response to the SCCF node 1557. The response 1586 may include an IDSC request ID, description and media URL information. The SCCF node 1557 may send the request 1587 WTRU-2 1554.

WTRU-2 1554 may initiate 1588 its client application 1556 and register 1589 with the IDSC service. WTRU-2 1554 may send an ACK to 1590 WTRU-1 1551 via the SCCF node 1557. The SCCF node 1557 may send the ACK 1590 to WTRU-1 1551. WTRU-1 1551 may inform 1591 the user that the operation is ongoing.

FIGS. 15B4 and 15B5 show in the IDSC execution stage IDSC service 1555 of WTRU-2 1554 may send a IDSC client request 1587 to client application 1556 of WTRU-2 1554 including but not limited to an IDSC request ID, description and media URLs. The client application 1556 of WTRU-2 1554 may send to the web server 1562 an HTTP GET request 1592 and may receive a OK ACK 1592. WTRU-2 1554 may send an OPTIONS request 1593 to the CN server application, which may include an RTSP URL and authorization or authentication information. WTRU-2 client application 1556 may receive an RTSP OK ACK 1594 which may indicate support for IDSC and an SCCF IP address. The client application 1556 may transmit this information to the IDSC service 1555. WTRU-2 1554 may send a SETUP request 1595 to the CN server application 1561, which may include an RTSP URL and IDSC request ID. The server application 1561 may retrieve stored IDSC parameters 1596 and may create a new session which may belong to the same aggregate session as the original session. The server application 1561 may send an RTSP OK ACK 1597 to the client application 1556 which may transmit the information to the IDSC service 1555 of WTRU-2 1554. The information may include a new session ID and an IDSC request ID.

WTRU-2 client application 1556 may send a PLAY request 1598 to the server application of the CN 1561. The request 1598 may include an RTSP URL and a session ID. The server application 1598 may start streaming 1547 from its current position and may send an RTSP OK ACK 1546 to the client application of WTRU-2 1556. The client application of WTRU-2 1556 may send a state update indication 1546 to the IDSC service 1555 including a session ID. WTRU-2 1554 may update its service state and may begin RTP streaming 1547 with the CN 1559.

FIGS. 15B5 and 15B6 show in the IDSC completion stage, WTRU-2 1554 may send an IDSC client response 1548 to the IDSC service of WTRU-1 1552 via the SCCF node 1558 that includes an IDSC request ID. The IDSC service of WTRU-1 1552 may send an indication 1548 of the IDSC client response to the client application of WTRU-1 1553 and WTRU-1 1551 may cease streaming. WTRU-1 1551 may send a teardown request 1549 including RTSP URL the server application 1561. The server application 1561 may send an ACK to the client application of WTRU-1 1553. The client application of WTRU-1 1553 may send a teardown session indication 1505 to the IDSC service of WTRU-1 1552. RTP streaming between the client application of WTRU-1 1553 and the server application 1561 may cease 1503.

At any point in the method of FIGS. 15B1, 15B2, 15B3, 15B4, 15B5 and 15B6, additional actions may be performed between WTRU-1 1551, WTRU-2 1554, the SCCF node 1558, the CN 1559 and the web server 1562.

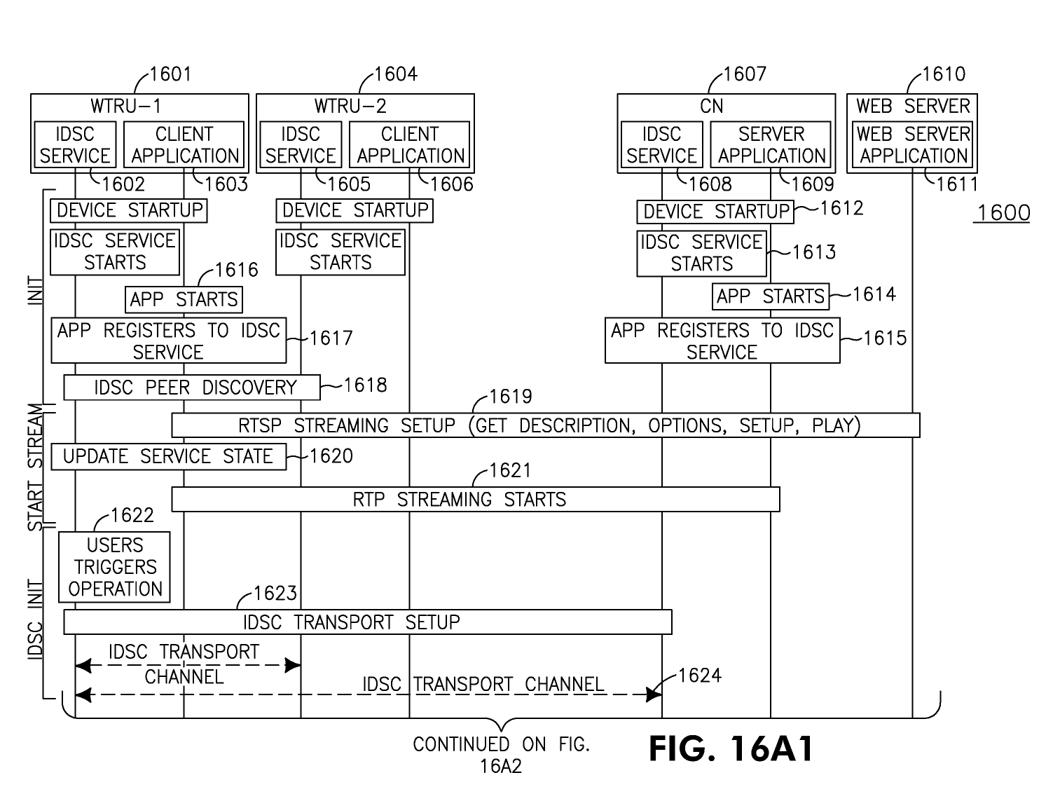

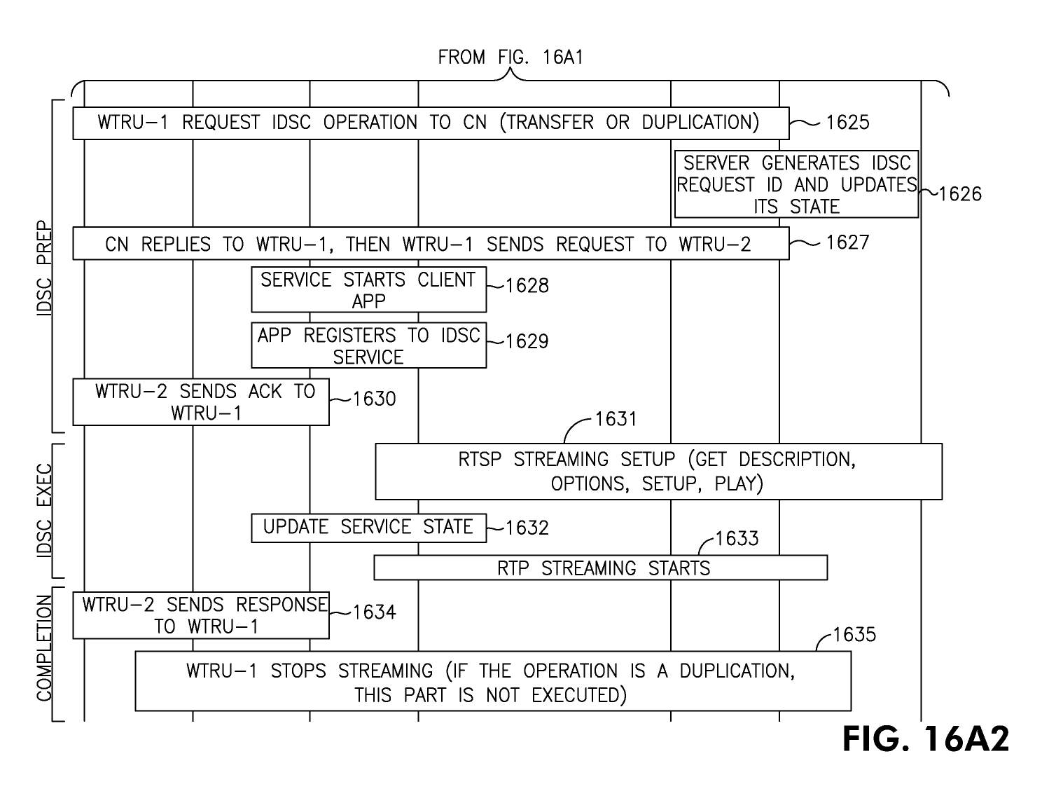

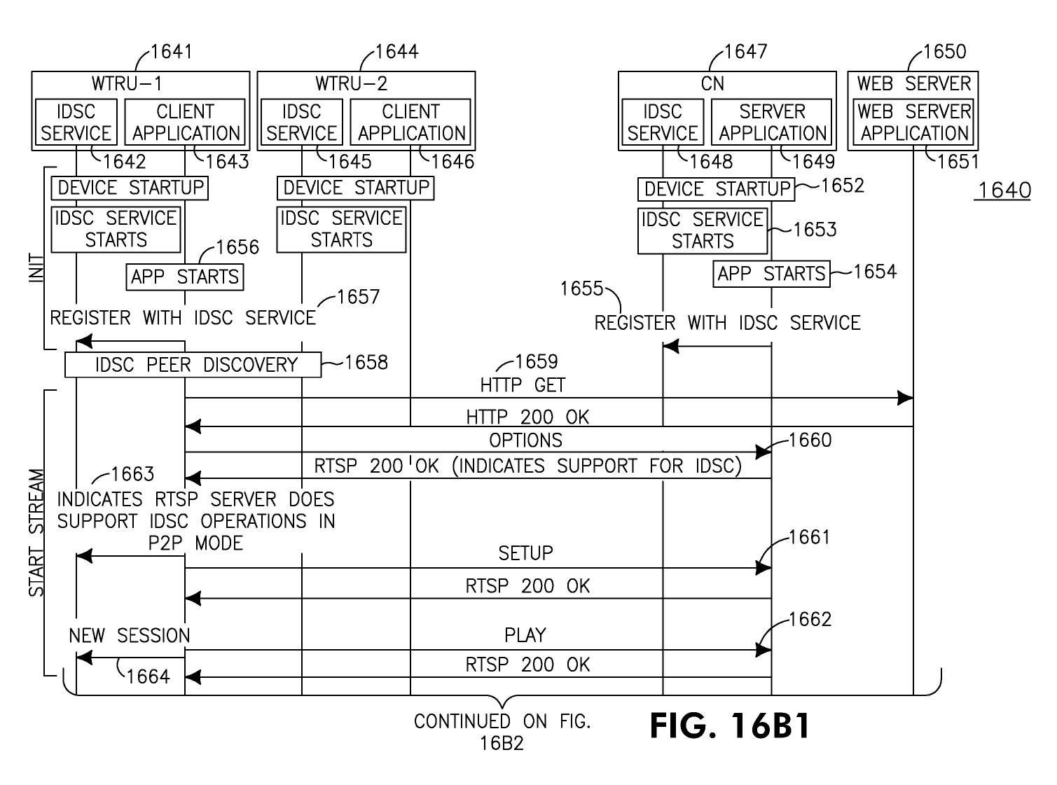

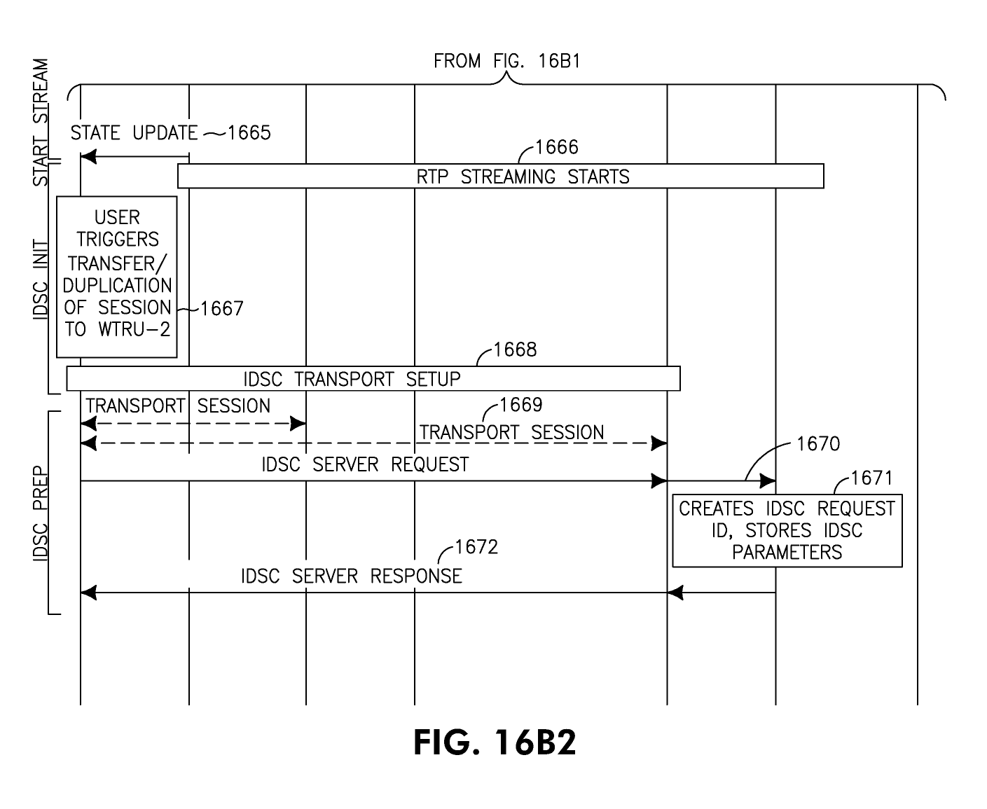

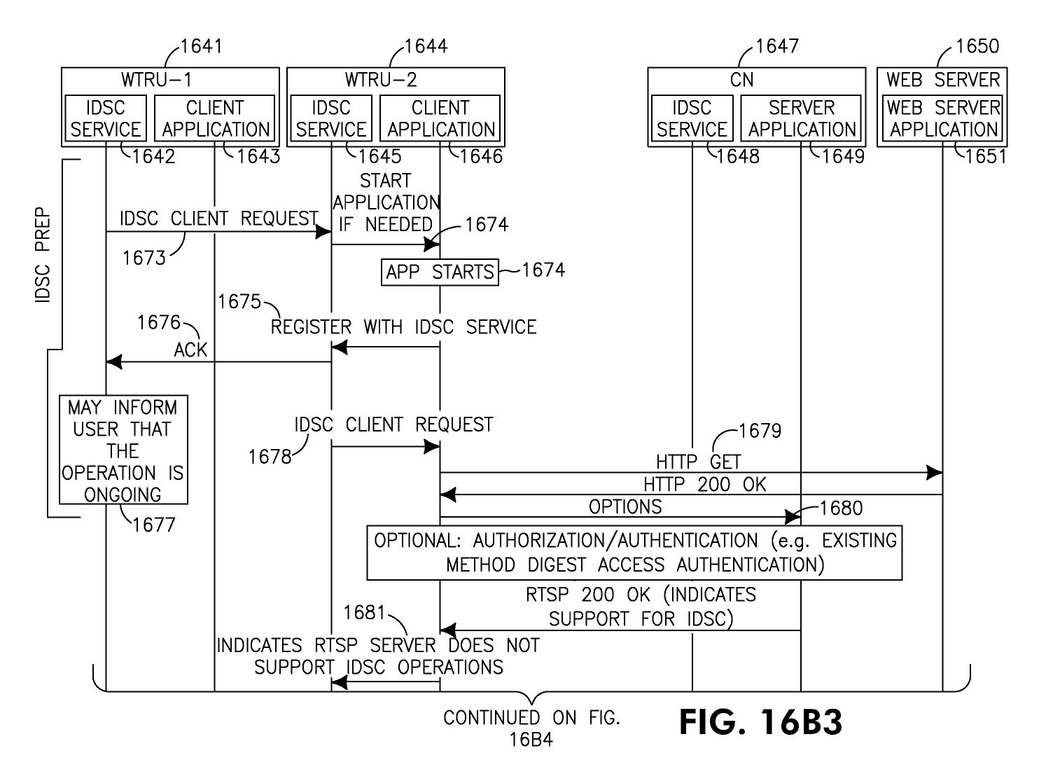

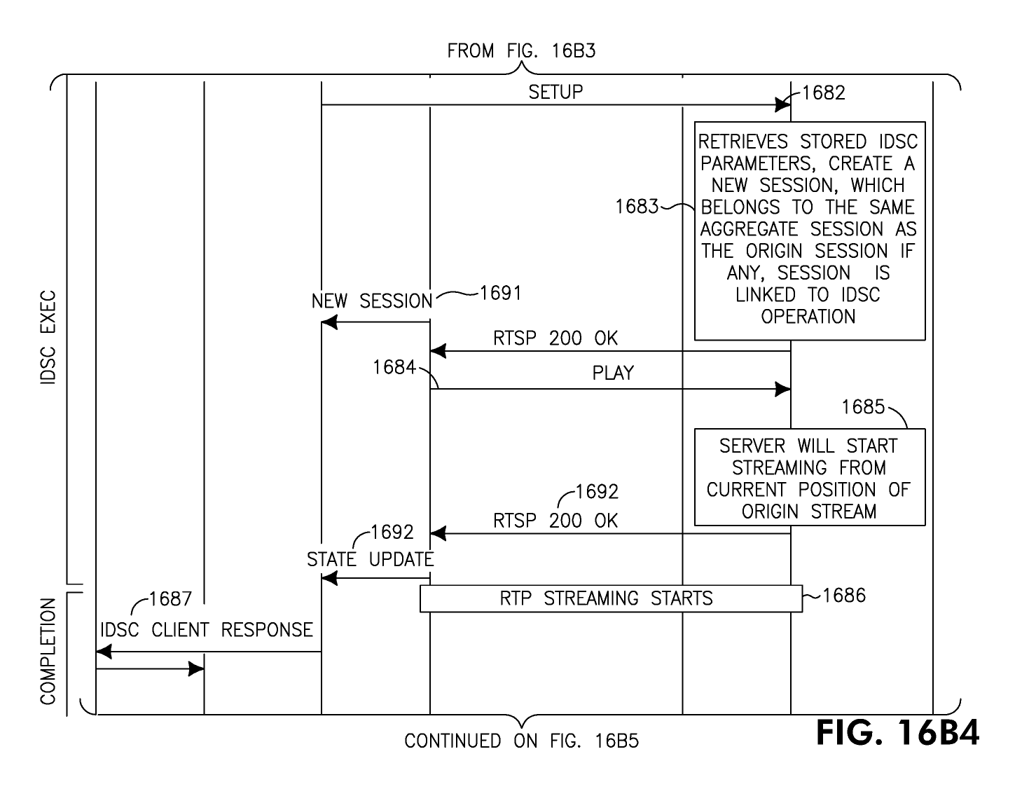

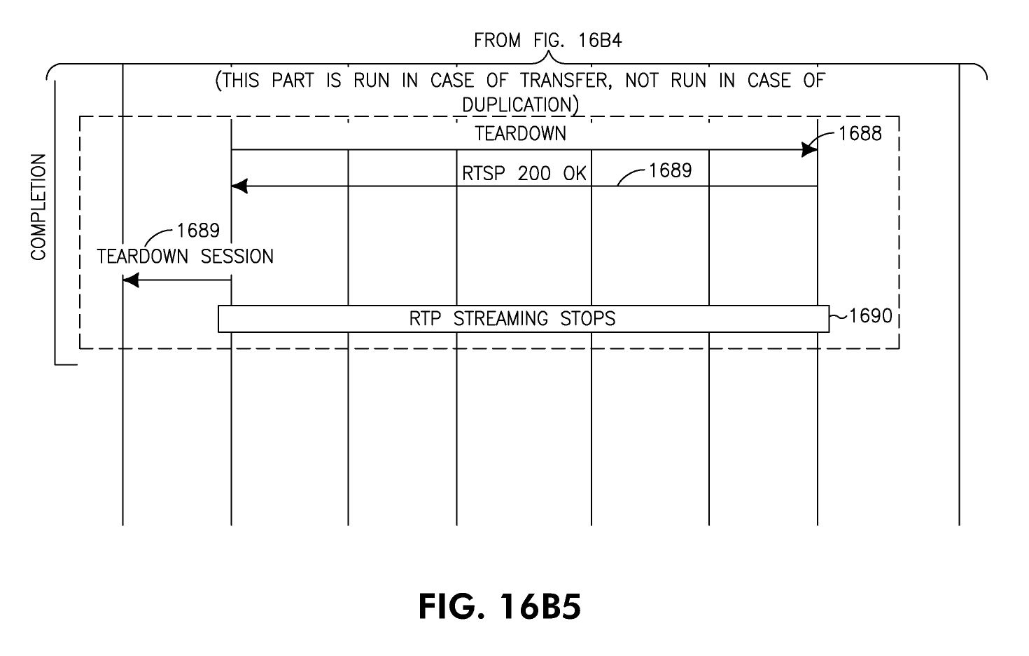

FIGS. 16A1 and 16A2 are a is a high level flow diagram 1600 of P2P IDSC using RTSP.

In the initialization stage of IDSC, WTRU-1 1601, WTRU-2 1604 and the CN 1607 initiate device start-up 1612 and the IDSC services start 1613. In the CN 1607 the server application 1609 starts 1614 and registers 1615 to the IDSC service 1608. In WTRU-1 1601 the client application 1603 starts 1616 and registers 1617 to the IDSC service 1602. The IDSC service in the WTRU-1 1602 initiates peer discovery 1618 with the IDSC service of WTRU-2 1605.

In the start stream stage of IDSC, WTRU-1 1601 initiates RTSP streaming setup 1619 using its client application 1603 with the server application 1609 in the CN 1607 and the web server application 1611 in the web server 1610 by sending requests 1619. The requests includes a GET request, an OPTION request, a SETUP request and a PLAY request. WTRU-1 1601 may update its service state 1620 and may begin RTP streaming 1621 with the CN 1607 via their respective client 1603 and server applications 1609.

In the IDSC initiation stage a user may trigger an operation 1622 and WTRU-1 1601 may establish an IDSC transport setup 1623 with WTRU-2 1604 and the CN 1607. WTRU-1 1601 and WTRU-2 1604 may exchange IDSC transport channel information 1624 with the CN 1607.

In the IDSC preparation stage WTRU-1 1601 may send a request 1625 for an IDSC operation with the CN 1607. This may be a request for a transfer or a duplication of a media session. The CN server application 1609 may generate an IDSC request ID 1626 and may update its state. The CN 1607 may send a response 1627 to WTRU-1 1601, which may then send the response 1630 to WTRU-2 1604. WTRU-2 1604 may initiate 1628 its client application 1606 and register 1629 with the IDSC service 1605. WTRU-2 may send an ACK 1630 to WTRU-1 1601.

In the IDSC execution stage WTRU-2 1604 may send RTSP streaming requests 1631 including a GET request, an OPTION request, a SETUP request and a PLAY request to the CN 1610 and the web server 1611. WTRU-2 1604 may update its service state 1632 and may begin RTP streaming 1633 with the CN 1607.

In the IDSC completion stage, WTRU-2 1604 may send a response 1634 to WTRU-1 1601. WTRU-1 1601 may cease streaming 1635.

At any point in the method of FIGS. 16A1 and 16A2, additional actions may be performed between WTRU-1 1601, WTRU-2 1604, the CN 1607 and the web server 1610.

FIGS. 16B1, 16B2, 16B3, 16B4 and 16B5 are detailed flow diagrams 1640 of P2P IDSC using RTSP.

In FIG. 16B1 the initialization stage of IDSC is shown. WTRU-1 1641, WTRU-2 1644 and the CN 1642 initiate device start-up 1652 and the IDSC services start 1653. In the CN 1647 the server application 1649 starts 1654 and registers 1655 to the IDSC service 1648 by sending a register request 1655. In WTRU-1 1641 the client application 1643 starts 1656 and registers 1657 to the IDSC service 1642.

In the start stream stage of IDSC, the IDSC service in the WTRU-1 1642 initiates peer discovery 1658 with the IDSC service of WTRU-2 1645. The client application of WTRU-1 1643 initiates RTSP streaming by sending a HTTP GET request 1659 to the web server application 1651 and receiving an OK ACK from the web server 1650.

WTRU-1 1641 may send additional requests to the CN server application 1649 including an OPTION request 1660, a SETUP request 1661 and a PLAY request 1662 and receiving an OK ACK from the CN server application 1649 in response to each request. In FIG. 16B2, WTRU-1 1642 may update its IDSC service state 1665 with information regarding whether the RTSP server supports IDSC operations 1663 and new session information 1664 including a session ID. WTRU-1 1641 may begin RTP streaming 1666 with the CN 1647 via their respective client 1643 and server 1649 applications.

In the IDSC initiation stage a user may trigger an operation 1667 such as a transfer or duplication of session and WTRU-1 1641 may establish an IDSC transport setup 1668 with WTRU-2 1644 and the CN 1647. WTRU-1 1641 and WTRU-2 1644 may exchange IDSC transport channel information 1669 with the CN 1647.

In the IDSC preparation stage WTRU-1 1641 may send an IDSC server request message 1670 to the CN 1647. The request message 1670 may include an indication of the type (i.e., transfer or duplicate), session ID, target information, description, media and authentication or authorization information. The CN server application 1649 may generate an IDSC request ID 1671 and may update its state. The CN may store IDSC parameters 1671. The CN 1647 may send a response 1672 to WTRU-1 1641. The response may include an IDSC request ID, description and media URL information.

In FIG. 16B3, the IDSC preparation stage is continued and the IDSC service of WTRU-1 1642 may send a client request 1673 to the IDSC service of WTRU-2 1645 that includes a request ID, description and media URLs. WTRU-2 1644 may initiate its client application1674 and register 1675 with the IDSC service 1645. WTRU-2 1644 may send an ACK 1676 to WTRU-1 1641. WTRU-1 1641 may inform the user that the operation is ongoing 1677.

In the IDSC execution stage the IDSC service of WTRU-2 1642 may send a IDSC client request 1678 to the client application of WTRU-2 1646 including but not limited to an IDSC request ID, description and media URLs. The client application of WTRU-2 1646 may send to the web server an HTTP GET request 1679 and may receive a OK ACK. WTRU-2 1644 may send an OPTIONS request 1680 to the CN server application 1649, which may include an RTSP URL and authorization or authentication information. WTRU-2 client application 1646 may receive an RTSP OK ACK 1681, which may indicate the RTSP server does not support IDSC operations. The client application 1646 may transmit this information to the IDSC service of WTRU-2 1645.

In FIG. 16B4, WTRU-2 1644 may send a SETUP request 1682 to the CN server application 1649, which may include an RTSP URL and IDSC request ID. The server application 1649 may retrieve stored IDSC parameters 1683 and may create a new session which may belong to the same aggregate session as the original session. The server application 1649 may send an RTSP OK ACK 1691 to the client application of WTRU-2 1646, which may transmit the information to the IDSC service of WTRU-2 1645. The information may include a new session ID and an IDSC request ID.

WTRU-2 client application 1646 may send a PLAY request 1684 to the server application of the CN 1649. The request 1684 may include an RTSP URL and a session ID. The server application 1649 may start streaming from its current position and may send an RTSP OK ACK 1692 to the client application of WTRU-2 1646. The client application of WTRU-2 1646 may send a state update indication 1692 to the IDSC service 1645 including a session ID. The IDSC service 1645 may send a client response 1687 to the client application 1643 of WTRU-1 via the IDSC service 1642 of WTRU-1. WTRU-2 1644 may update its service state 1692 and may begin RTP streaming 1686 with the CN 1647.

In FIG. 16B5 during the IDSC completion stage, the client application of WTRU-1 1643 may send a teardown request 1688 including RTSP URL the server application 1649. The server application 1649 may send an ACK 1689 to the client application of WTRU-1 1643. The client application of WTRU-1 1643 may send a teardown session indication 1689 to the IDSC service of WTRU-1 1642. RTP streaming 1690 between the client application of WTRU-1 1643 and the server application 1649 may cease.

At any point in the method of FIGS. 16B1, 16B2, 16B3, 16B4 and 16B5, additional actions may be performed between WTRU-1 1641, WTRU-2 1644, the CN 1647 and the web server 1650.

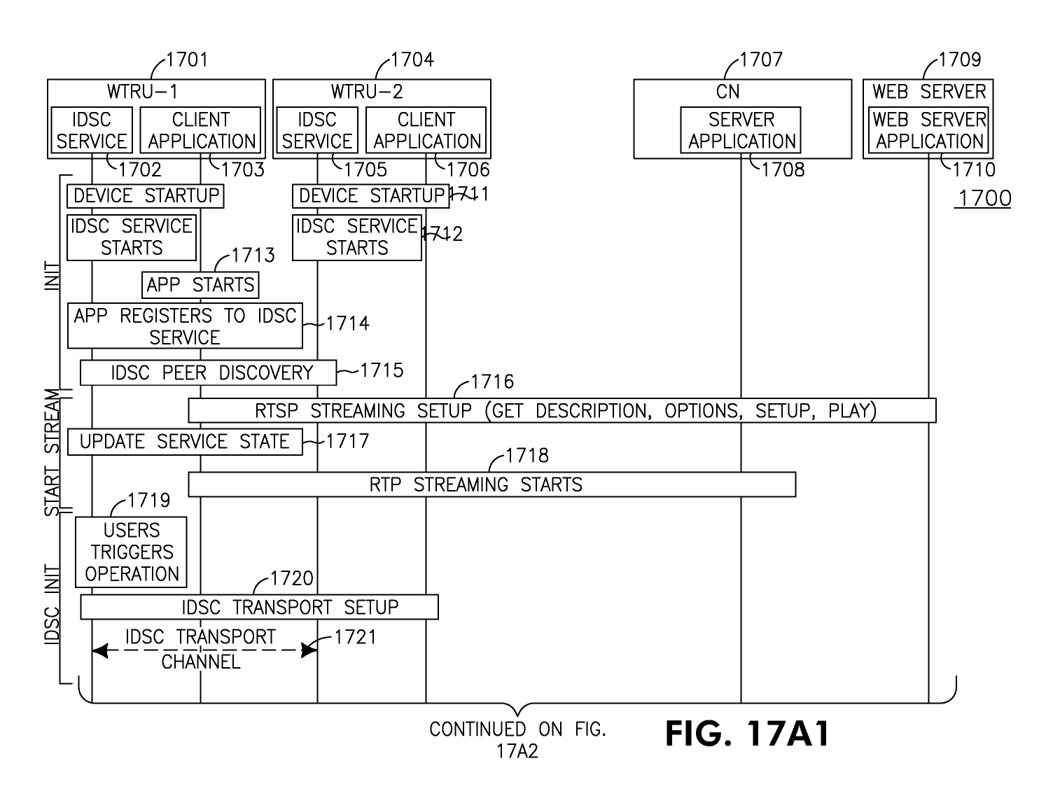

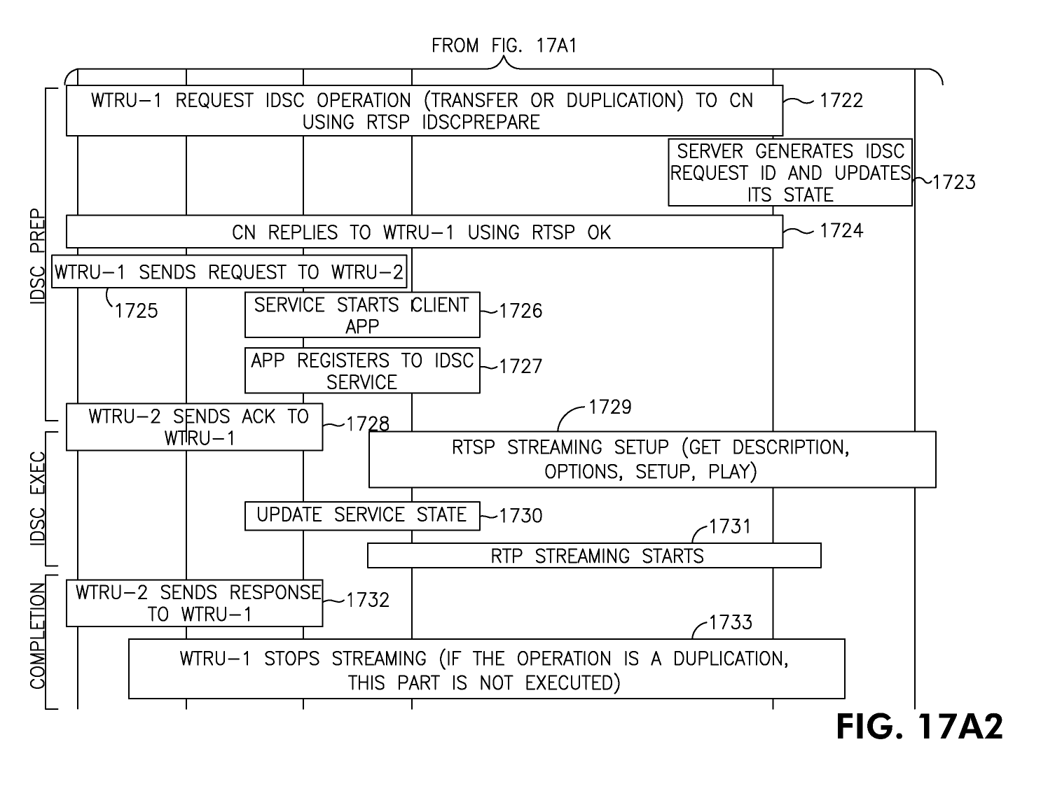

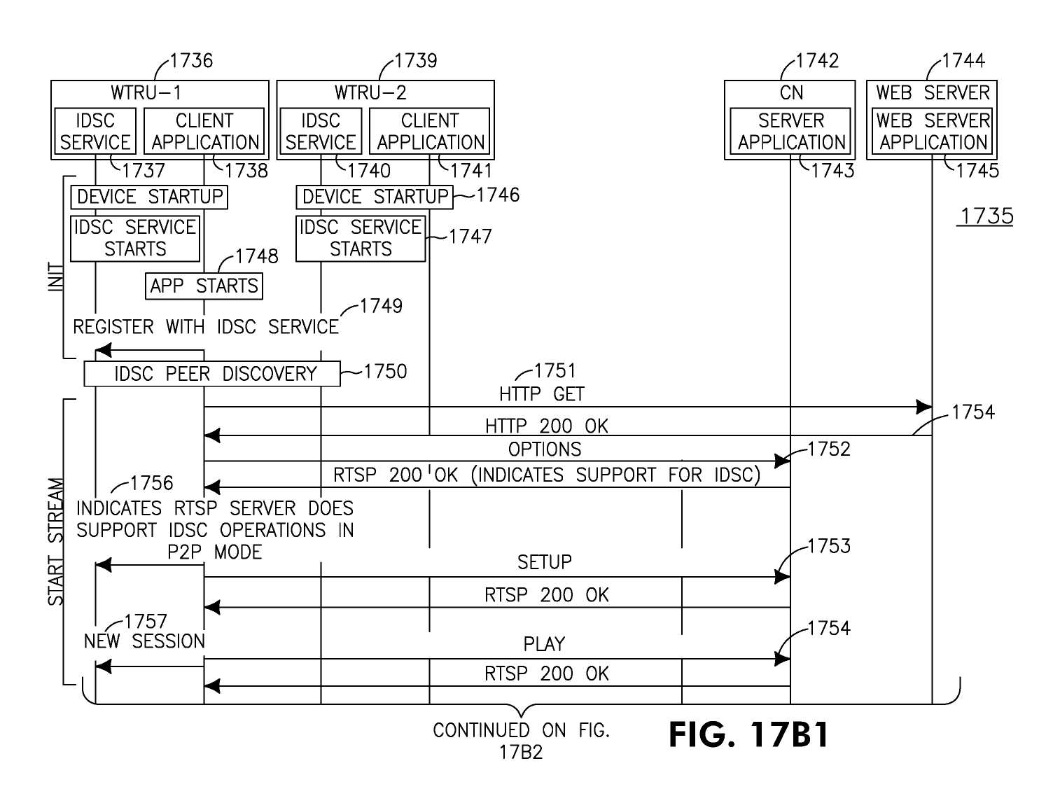

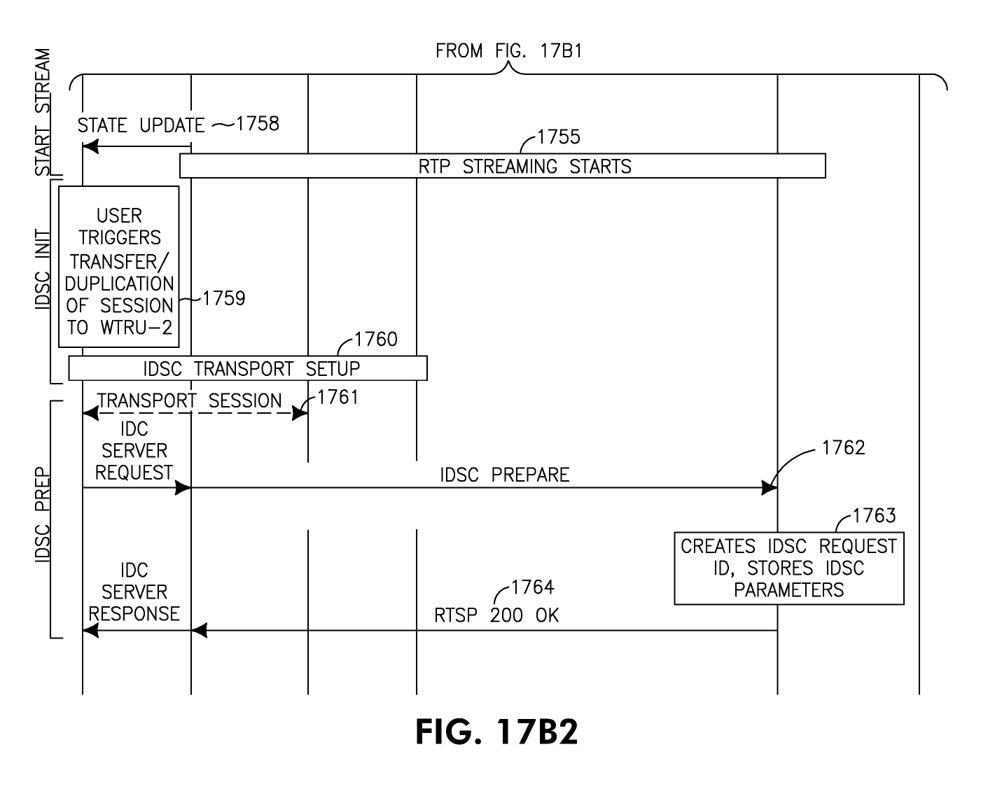

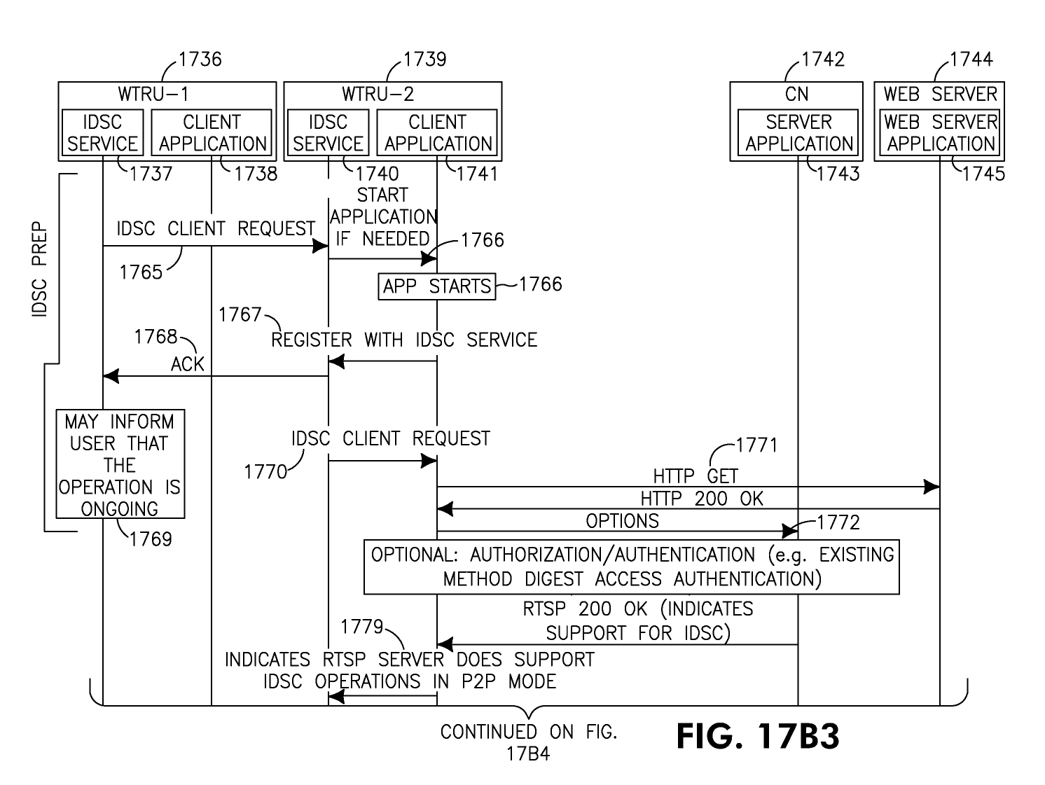

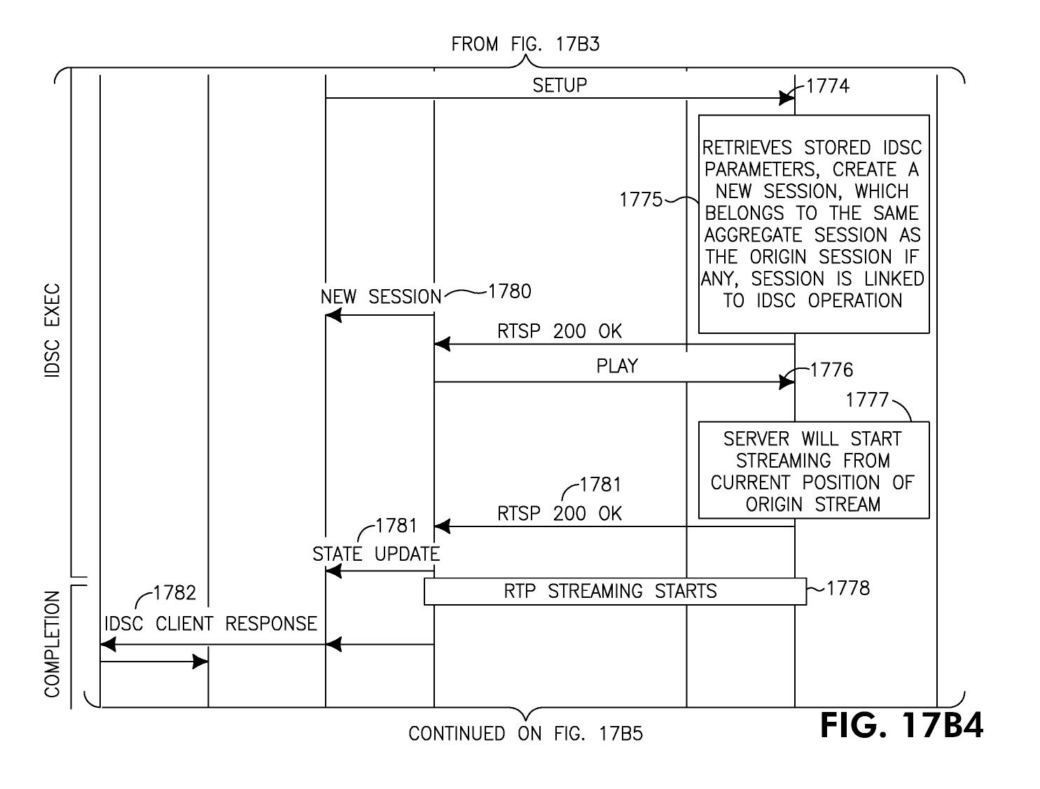

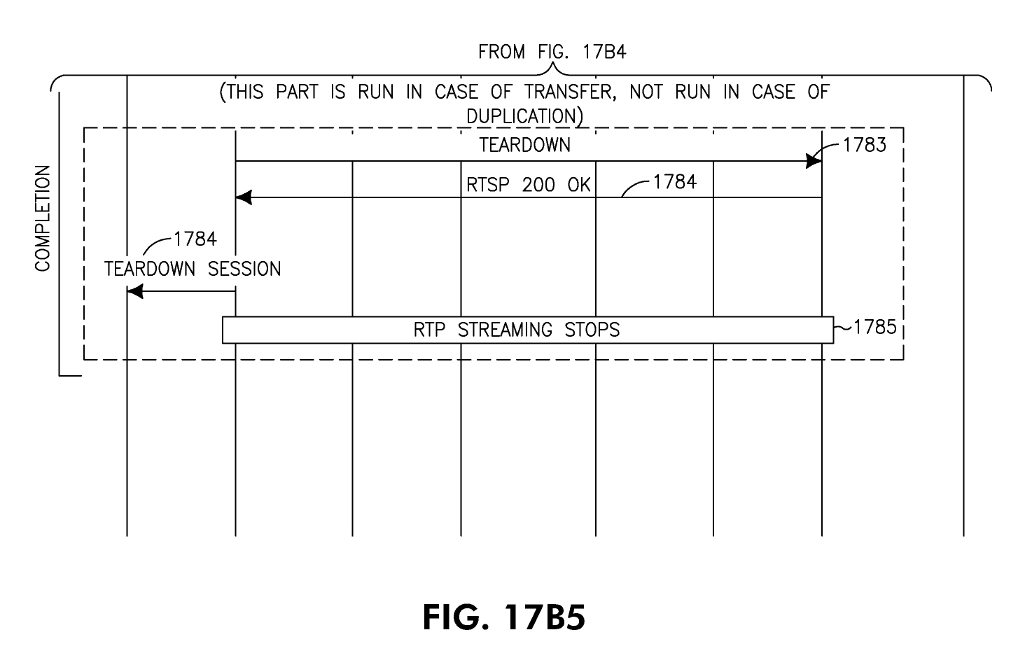

FIGS. 17A1 and 17A2 are a is a high level flow diagram 1700 of P2P IDSC using RTSP, wherein all communications between WTRU-1 1701 and the CN 1707 are through RTSP. In this embodiment, no IDSC interface exists between the CN 1707 and the WTRUs. While both the IDSC protocol and the RTSP protocol are used to prepare and transfer or duplicate the operation, only the RTSP application is used to perform the operation.

In the initialization stage of IDSC, WTRU-1 1701 and WTRU-2 1704 initiate device start-up 1711 and the IDSC services start 1712 in both WTRU-1 1701 and WTRU-2 1704. In WTRU-1 1701 the client application 1703 starts 1713 and registers 1714 to the IDSC service 1702. The IDSC service 1702 in the WTRU-1 1701 initiates peer discovery 1715 with the IDSC service of WTRU-2 1705.

In the start stream stage of IDSC, WTRU-1 1701 initiates RTSP streaming setup 1716 using its client application 1703 with the server application in the CN 1708 and the web server application 1710 in the web server 1709 by sending requests 1716. The requests includes a GET request, an OPTION request, a SETUP request and a PLAY request. WTRU-1 1701 may update its service state1717 and may begin RTP streaming 1718 with the CN 1707 via their respective client 1703 and server 1708 applications.

In the IDSC initiation stage a user may trigger an operation 1719 and WTRU-1 1701 may establish an IDSC transport setup 1720 with WTRU-2 1704. WTRU-1 1701 and WTRU-2 1704 may exchange IDSC transport channel information 1721.

In the IDSC preparation stage, WTRU-1 1701 may send a request 1722 for an IDSC operation with the CN 1707 using RTSP. This may be a request for a transfer or a duplication of a media session. The CN server application 1708 may generate an IDSC request ID and may update its state 1723. The CN 1707 may send a RTSP OK response 1724 to WTRU-1 1701, which may then send the response 1725 to WTRU-2 1704. WTRU-2 1704 may initiate its client application 1726 and register 1727 with the IDSC service 1705. WTRU-2 1704 may send an ACK 1728 to WTRU-1 1701.

In the IDSC execution stage, WTRU-2 1704 may send RTSP streaming requests 1729 including a GET request, an OPTION request, a SETUP request and a PLAY request to the CN 1707 and the web server 1709. WTRU-2 1704 may update its service state 1730 and may begin RTP streaming 1731 with the CN 1707.

In the IDSC completion stage, WTRU-2 1704 may send a response 1732 to WTRU-1 1701. WTRU-1 1701 may cease streaming 1733.

At any point in the method of FIGS. 17A1 and 17A2, additional actions may be performed between WTRU-1 1701, WTRU-2 1704, the CN 1707 and the web server 1709.

FIGS. 17B1, 17B2, 17B3, 17B4 and 17B5 are detailed flow diagrams 1735 of P2P IDSC using RTSP, wherein all communications between WTRU-1 1736 and the CN 1742 are through RTSP.

In FIG. 17B1 the initialization stage of IDSC is shown. WTRU-1 1736 and WTRU-2 1739 initiate device start-up 1746 and the IDSC services of WTRU-1 1736 and WTRU-2 1739 start 1747. In WTRU-1 1736 the client application 1738 starts 1748 and registers 1749 to the IDSC service 1737.

In the start stream stage of IDSC, the IDSC service 1737 in the WTRU-1 1736 initiates peer discovery 1750 with the IDSC service of WTRU-2 1740. The client application of WTRU-1 1738 initiates RTSP streaming by sending a HTTP GET request 1751 to the web server application 1745 of the web server 1744 and receiving an OK ACK 1754 from the web server 1735.

WTRU-1 1736 may send additional requests to the CN server application 1743 including an OPTION request 1752, a SETUP request 1753 and a PLAY request 1754 and receiving an RTSP OK ACK from the CN server application 1743 in response to each request. In FIG. 17B2, WTRU-1 1736 may update its service state 1758 with information regarding whether the RTSP server supports IDSC operations 1756 and new session information including a session ID 1757. WTRU-1 1736 may begin RTP streaming 1755 with the CN 1742 via their respective client 1738 and server 1743 applications.

In the IDSC initiation stage, a user may trigger an operation 1759 such as a transfer or duplication of session and WTRU-1 1736 may establish an IDSC transport setup 1760 with WTRU-2 1739. WTRU-1 1736 and WTRU-2 1739 may exchange IDSC transport channel information 1761.

In the IDSC preparation stage, WTRU-1 1736 may send an IDSC prepare message 1762 to the CN 1742 via the client application of WTRU-1 1738. The prepare message 1762 may include an indication of the type (i.e., transfer or duplicate), session ID, target information, description, media and authentication or authorization information. The CN server application 1743 may generate an IDSC request ID and may update its state 1763. The CN 1742 may store IDSC parameters 1763. The CN 1742 may send a RTSP response OK 1764 to WTRU-1 1736. The response 1764 may include an IDSC request ID, description and media URL information.

In FIG. 17B3, the IDSC preparation stage is continued and the IDSC service of WTRU-1 1737 may send a client request 1765 to the IDSC service of WTRU-2 1740 that includes a request ID, description and media URLs. WTRU-2 1739 may initiate 1766 its client application and register 1767 with the IDSC service 1740. WTRU-2 1739 may send an ACK 1768 to WTRU-1 1736. WTRU-1 1736 may inform the user that the operation is ongoing 1769.

In the IDSC execution stage, the IDSC service of WTRU-2 1740 may send an IDSC client request 1770 to client application of WTRU-2 1741 including but not limited to an IDSC request ID, description and media URLs. The client application of WTRU-2 1741 may send to the web server 1744 an HTTP GET request 1771 and may receive a OK ACK. WTRU-2 1739 may send an OPTIONS request 1772 to the CN server application 1743, which may include an RTSP URL and authorization or authentication information. WTRU-2 client application 1741 may receive an RTSP OK ACK which may indicate 1779 the RTSP server does support IDSC operations. The client application 1741 may transmit this information to the IDSC service of WTRU-2 1740.

In FIG. 17B4, WTRU-2 1739 may send a SETUP request 1774 to the CN server application 1743, which may include an RTSP URL and IDSC request ID. The server application 1743 may retrieve stored IDSC parameters and may create a new session 1775, which may belong to the same aggregate session as the original session. The server application 1743 may send an RTSP OK ACK 1780 to the client application of WTRU-2 1741, which may transmit the information to the IDSC service of WTRU-2 1740. The information may include a new session ID and an IDSC request ID 1780.

WTRU-2 client application 1741 may send a PLAY request 1776 to the server application of the CN 1743. The request 1776 may include an RTSP URL and a session ID. The server application 1743 may start streaming 1778 from its current position and may send an RTSP OK ACK 1782 to the client application of WTRU-2 1741. The client application of WTRU-2 1741 may send a state update indication 1782 the IDSC service 1740 including a session ID. WTRU-2 1739 may update its service state 1781 and may begin RTP streaming 1778 with the CN.

In the IDSC completion stage, the client application of WTRU-2 1741 may send an IDSC client response 1782 to the IDSC service of WTRU-1 1737 via the IDSC service of WTRU-2 1740. The IDSC service of WTRU-1 1737 may send the response 1782 to the client application of WTRU-1 1738. In FIG. 17B5, WTRU-1 1736 may send a teardown request 1783 including RTSP URL the server application 1743. The server application 1743 may send an ACK to the client application of WTRU-1 1738. The client application of WTRU-1 1738 may send a teardown session indication 1784 to the IDSC service of WTRU-1 1737. RTP streaming between the client application of WTRU-1 1738 and the server application 1743 may cease 1785.

At any point in the method of FIGS. 17B1, 17B2, 17B3, 17B4 and 17B5, additional actions may be performed between WTRU-1 1736, WTRU-2 1739, the CN 1742 and the web server 1744.

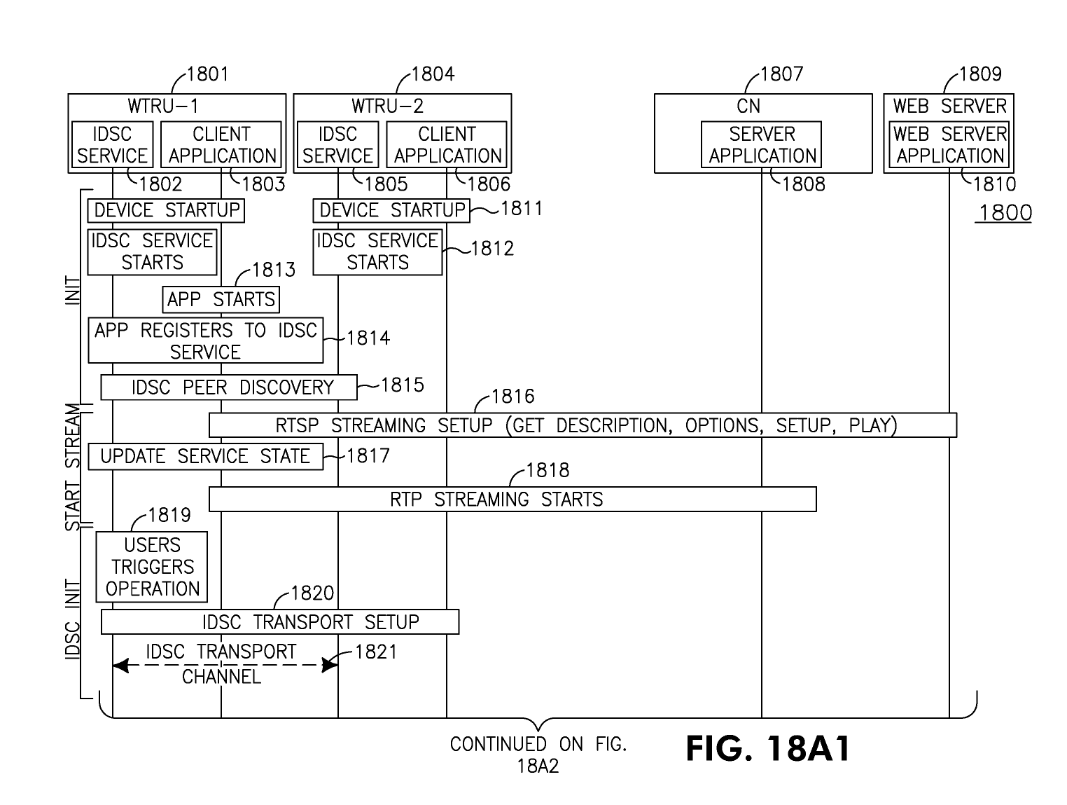

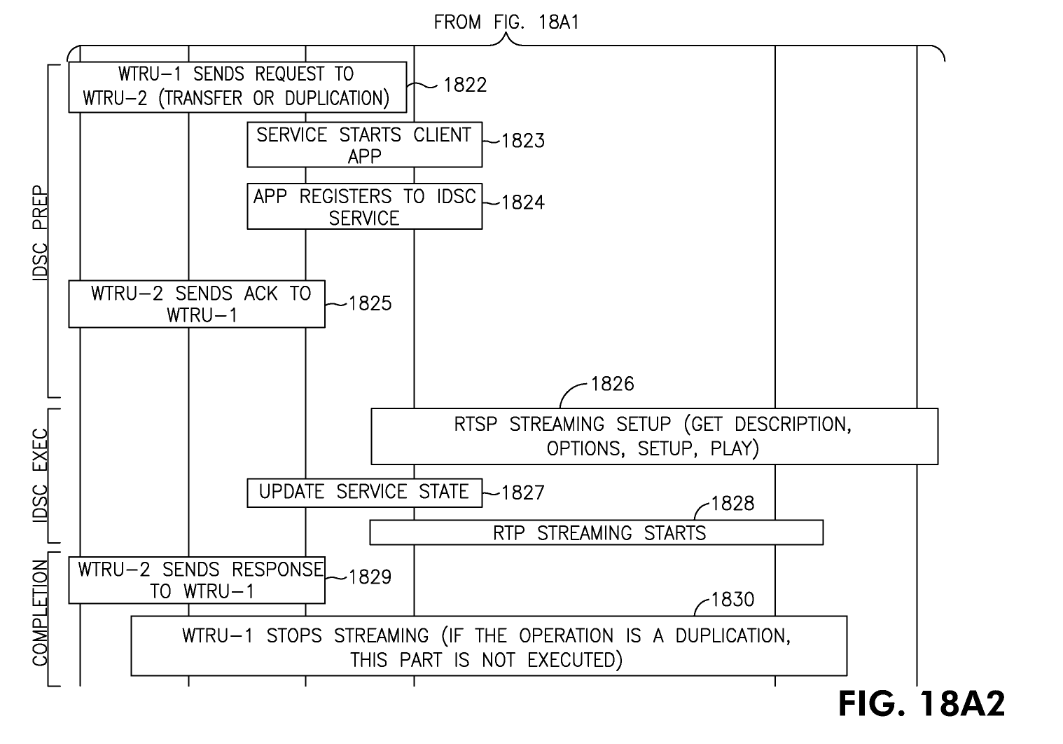

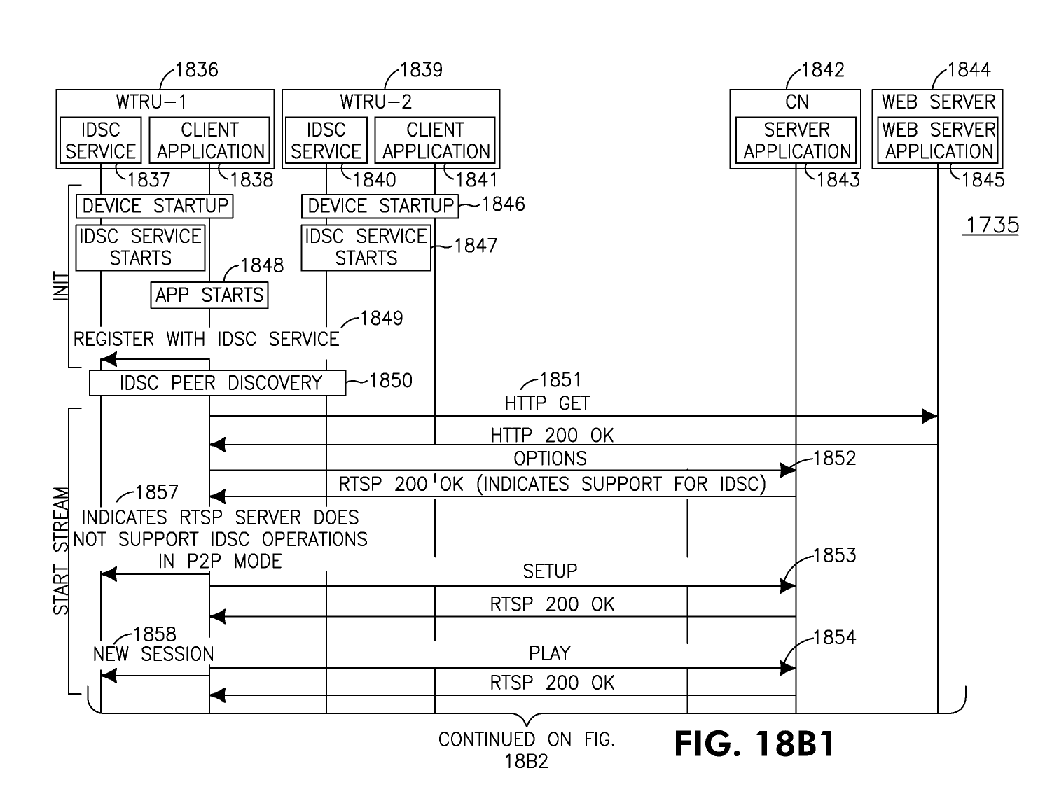

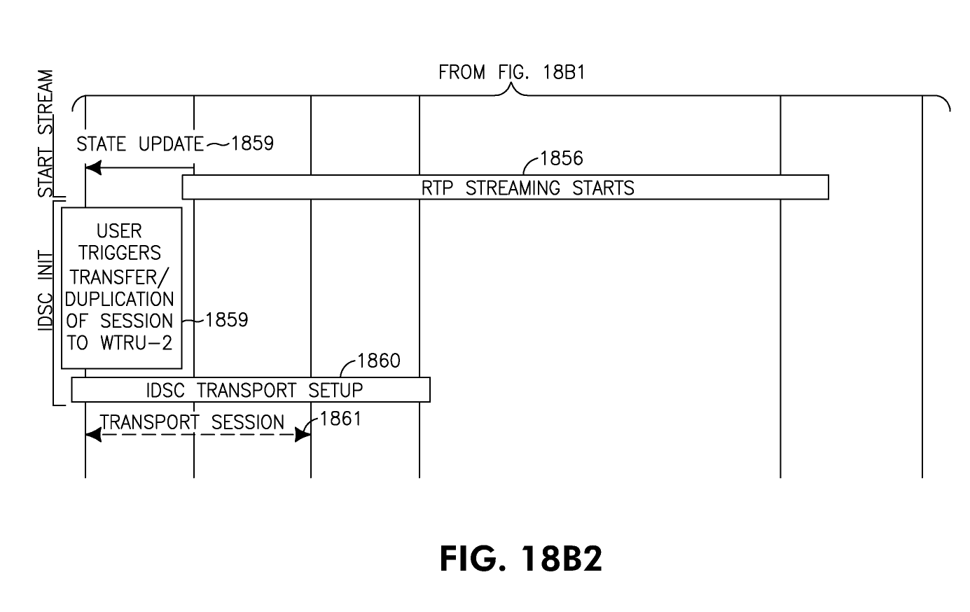

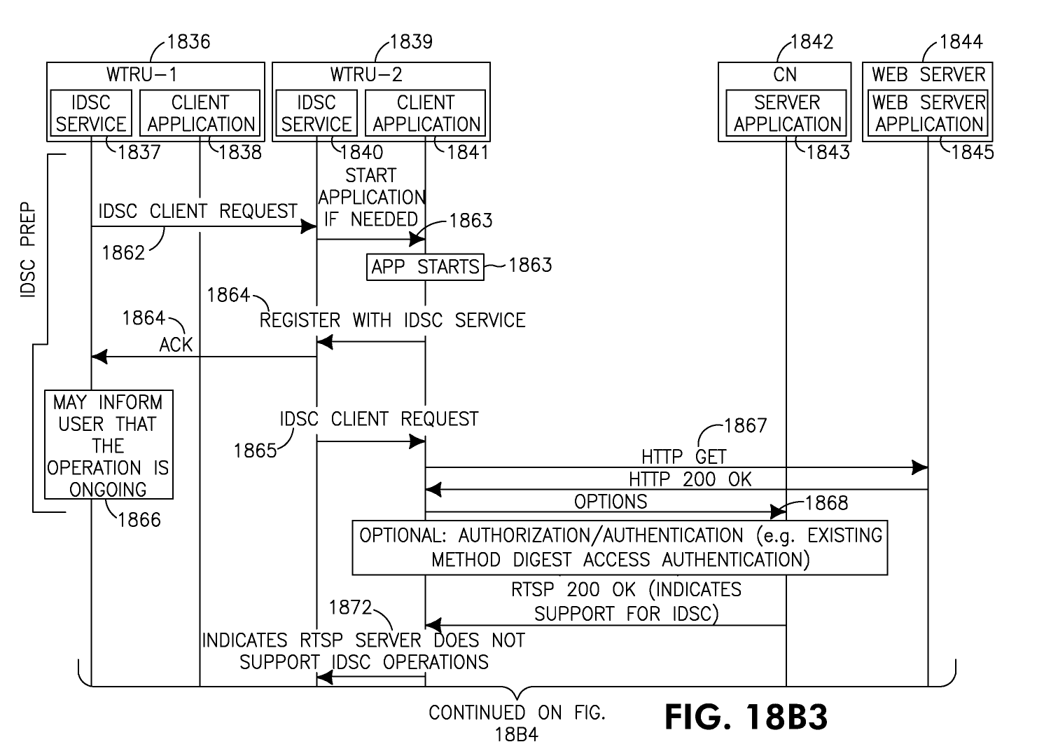

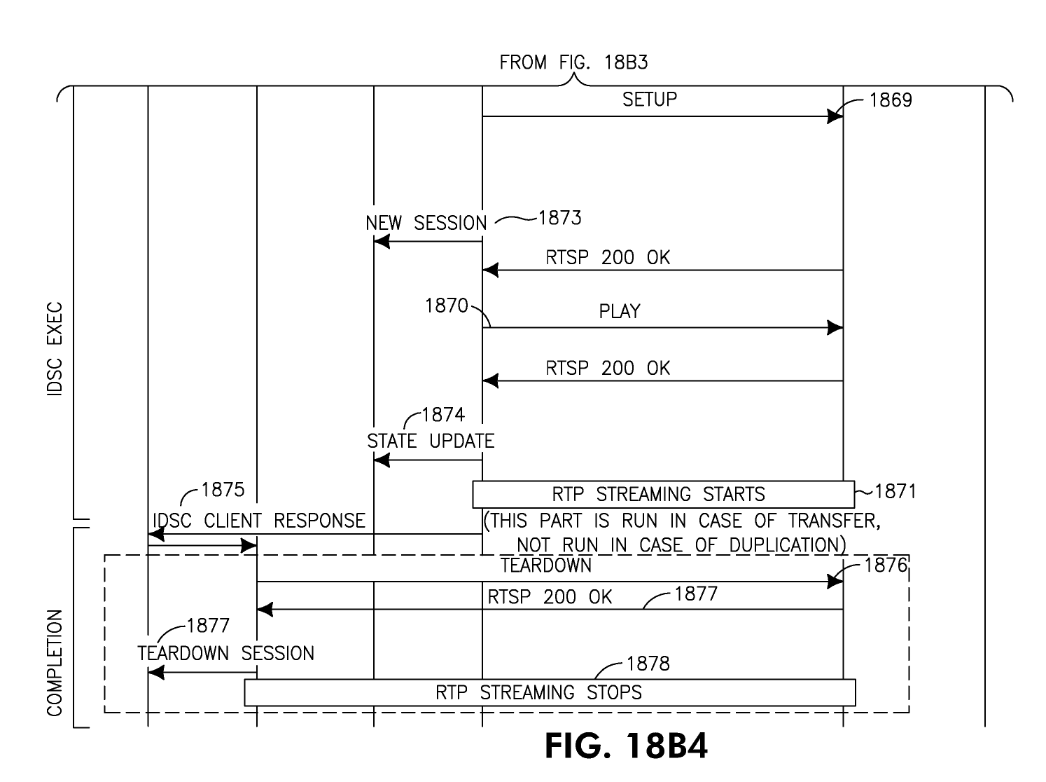

FIGS. 18A1 and 18A2 are a is a high level flow diagram 1800 of P2P IDSC using RTSP, wherein all IDSC communications are between WTRU-1 1801 and WTRU-2 1804, and all communications with the CN 1807 are through RTSP. In this embodiment, an IDSC interface does not exists between the CN 1807 and the WTRUs 1801, 1804. The CN 1807 is not modified for IDSC. An RTSP protocol is used universally to set up sessions.

In the initialization stage of IDSC WTRU-1 1801 and WTRU-2 1804 initiate device start-up 1811 and the IDSC service starts 1812 in both WTRU-1 1801 and WTRU-2 1804. In WTRU-1 1801 the client application starts 1813 and registers 1814 to the IDSC service 1802. The IDSC service in the WTRU-1 1802 initiates peer discovery 1815 with the IDSC service of WTRU-2 1805.

In the start stream stage of IDSC, WTRU-1 1801 initiates RTSP streaming setup 1816 using its client application 1803 with the server application in the CN 1808 and the web server application 1810 by sending requests. The requests includes a GET request, an OPTION request, a SETUP request and a PLAY request. WTRU-1 1801 may update its service state 1817 and may begin RTP streaming 1818 with the CN 1807 via their respective client 1806 and server applications 1808.

In the IDSC initiation stage a user may trigger an operation 1819 and WTRU-1 1801 may establish an IDSC transport setup 1820 with WTRU-2 1804. WTRU-1 1801 and WTRU-2 1804 may exchange IDSC transport channel information 1821.

In the IDSC preparation stage, WTRU-1 1801 may send a request 1822 for an IDSC operation with WTRU-2 1804 using RTSP. This may be a request for a transfer or a duplication of a media session. The IDSC service of WTRU-2 1805 starts the client application 1823 of WTRU-2 1806. The client application of WTRU-2 1806 registers 1824 with the IDSC service of WTRU-2 1805. WTRU-2 1804 may send an ACK 1825 to WTRU-1.

In the IDSC execution stage, WTRU-2 1804 may send RTSP streaming requests 1826 including a GET request, an OPTION request, a SETUP request and a PLAY request to the CN 1807 and the web server 1809. WTRU-2 1804 may update its service state 1827 and may begin RTP streaming 1828 with the CN 1807.

In the IDSC completion stage, WTRU-2 1804 may send a response 1829 to WTRU-1 1801. WTRU-1 1801 may cease streaming 1830.

At any point in the method of FIGS. 18A1 and 18A2, additional actions may be performed between WTRU-1 1801, WTRU-2 1804, the CN 1807 and the web server 1809.

FIGS. 18B1, 18B2, 18B3 and 18B4 are detailed flow diagrams 1835 of P2P IDSC using RTSP, wherein all IDSC communications are between WTRU-1 1836 and WTRU-2 1839, and all communications with the CN 1842 are through RTSP.

In FIG. 18B1 the initialization stage of IDSC is shown. WTRU-1 1836 and WTRU-2 1839 initiate device start-up 1846 and the IDSC service of WTRU-1 1837 and WTRU-2 1840 starts 1847. In WTRU-1 1836 the client application 1838 starts 1848 and registers 1849 to the IDSC service 1837. The IDSC service 1837 in WTRU-1 1836 initiates peer discovery 1850 with the IDSC service of WTRU-2 1840.

In the start stream stage of IDSC, the client application of WTRU-1 1838 initiates RTSP streaming by sending a HTTP GET request 1851 to the web server 1844 and receiving an OK ACK from the web server. WTRU-1 1836 may send additional requests to the CN server application including an OPTION request 1852, a SETUP request 1853 and a PLAY request 1854 and receiving an RTSP OK ACK from the CN server application 1843 in response to each request. In FIG. 18B2, WTRU-1 1836 may update its service state 1859 with information regarding whether the RTSP server supports IDSC operations 1857 and new session information 1858 including a session ID. WTRU-1 1836 may begin RTP streaming 1856 with the CN 1842 via their respective client 1838 and server applications 1843.

In the IDSC initiation stage, a user may trigger 1859 an operation such as a transfer or duplication of session. WTRU-1 1839 may generate an IDSC request ID and may establish an IDSC transport setup 1860 with WTRU-2 1839. WTRU-1 1836 and WTRU-2 1839 may exchange IDSC transport channel information 1861.

In FIG. 18B3, during the preparation stage, WTRU-1 1836 may send an IDSC client request 1862 to the IDSC service of WTRU-2 1840. The IDSC client request 1862 may include an IDSC request ID, media bookmark information, timestamp, description and media URLs. The IDSC service of WTRU-2 1840 may send an indication 1863 to the client application of WTRU-2 1841 to start the client application. WTRU-2 may initiate 1863 its client application 1841 and register 1864 with the IDSC service 1840. WTRU-2 1839 may send an ACK 1879 to WTRU-1 1836. WTRU-1 1836 may inform the user 1866 that the operation is ongoing.

The IDSC service of WTRU-2 1840 may send a IDSC client request 1865 to the client application of WTRU-2 1841, including but not limited to an IDSC request ID, description and media URLs.

In the IDSC execution stage, the client application of WTRU-2 1841 may send to the web server 1844 an HTTP GET request 1867 and may receive a OK ACK. WTRU-2 1839 may send an OPTIONS request 1868 to the CN server application 1843, which may include an RTSP URL and authorization or authentication information. WTRU-2 client application 1841 may receive an RTSP OK ACK 1872, which may indicate the RTSP server does support IDSC operations. The client application 1841 may transmit this information to the IDSC service of WTRU-2 1840. In FIG. 18B4, WTRU-2 1839 may send a SETUP request 1869 to the CN server application 1843, which may include an RTSP URL. The server application 1843 may send an RTSP OK ACK 1873 to the client application of WTRU-2 1841, which may transmit the information to the IDSC service of WTRU-2 1840. The information may include a new session ID and an IDSC request ID.

WTRU-2 client application 1841 may send a PLAY request 1870 to the server application of the CN 1843. The request 1870 may include an RTSP URL and may use the timestamp from the IDSC client request. The server 1843 may send an RTSP OK ACK 1874 to the client application of WTRU-2 1841. The client application of WTRU-2 1841 may send a state update indication 1874 to the IDSC service 1840 including a session ID. WTRU-2 1839 may begin RTP streaming 1871 with the CN 1842.

In the IDSC completion stage, the client application of WTRU-2 1841 may send an IDSC client response 1875 to the client application of WTRU-1 1838 via the IDSC service of WTRU-1 1837. WTRU-1 1836 may send a teardown request 1876 including an RTSP URL to the server application 1843. The server application 1843 may send an ACK 1877 to the client application of WTRU-1 1838. The client application of WTRU-1 1838 may send a teardown session indication 1877 to the IDSC service of WTRU-1 1837. RTP streaming between the client application of WTRU-1 1838 and the server application 1843 may cease 1878.

At any point in the method of FIGS. 18B1, 18B2, 18B3 and 18B4, additional actions may be performed between WTRU-1 1836, WTRU-2 1839, the CN 1842 and the web server 1844.

As shown in FIGS. 15A1-18B4, using RTSP messaging, WTRU-1 may obtain a media description from a server, such as a web server. For example, WTRU-1 may send a message to the server, which may be expressed as:

```
GET /content.sdp HTTP/1.1
  Host: www.example.com
  Accept: application/sdp.
```

The server may send a message to WTRU-1, which may be expressed as:

HTTP/1.0 200 OK
Content-Type: application/sdp
v=0
o=− 2890844526 2890842807 IN IP4 192.16.24.202
s=RTSP Session
m=video 0 RTP/AVP 31
a=control:rtsp://video.example.com/content/video

WTRU-1 may obtain RTSP options from a remote device (i.e., the CN) using a message which may be expressed as:

OPTIONS rtsp://server.example.com RTSP/2.0
CSeq: 1
User-Agent: Example media player (v1.0.0)

The Remote Device may send the RTSP option information to WTRU-1 using a message which may be expressed as:

RTSP/2.0 200 OK
Supported: play.basic, con.persistent
Cseq: 1
Server: Example Media Server 1.0.0
Public: DESCRIBE, SETUP, TEARDOWN, PLAY, PAUSE, OPTIONS,
ANNOUNCE, RECORD, GET_PARAMETER

WTRU-1 may perform RTSP setup with the remote device using a message which may be expressed as:

SETUP rtsp://video.example.com/content/video RTSP/2.0
CSeq: 2
Transport: RTP/AVP/UDP;unicast;client_port=3058-3059

The Remote Device may send a setup response to WTRU-1 using a message which may be expressed as:

RTSP/2.0 200 OK
CSeq: 2
Session: 23456788
Transport: RTP/AVP/UDP;unicast;client_port=3058-3059;
server_port=5002-5003

WTRU-1 may send a message to the remote device to initiate a media stream using a message which may be expressed as:

PLAY rtsp://video.example.com/content/video RTSP/2.0
CSeq: 3
Session: 23456788
Range: npt=0-

The remote device may send a response, including media stream information, to WTRU-1 using a message which may be expressed as:

RTSP/2.0 200 OK
CSeq: 3
Session: 23456788
RTP-Info: url=rtsp://video.example.com/content/video;
seq=45262314;rtptime=65473256

WTRU-1 may perform the communication session including the remote stream. WTRU-1 may send a message to the remote device to initiate termination of the media stream, which may be expressed as:

CN: TEARDOWN rtsp://video.example.com/content/video RTSP/2.0
CSeq: 4
Session: 23456788

The remote device may send an acknowledgment to WTRU-1 using a message which may be expressed as:

RTSP/2.0 200 OK
CSeq: 4

As shown in FIGS. 15A1-17B5, an IDSC transfer using RTSP may include a SETUP request. WTRU-2 may obtain a media description from a server. WTRU-2 may receive a URL associated with the media stream using an IDSC Client Request message, which may be expressed as:
Web Server: GET /content.sdp HTTP/1.1

The server may respond to WTRU-2 using a message which may be expressed as:
HTTP/1.0 200 OK

WTRU-1 may send a request for options information to the Remote Device using a message which may be expressed as:
OPTIONS rtsp://server.example.com RTSP/2.0

The Remote Device may respond to WTRU-1 using a message which may be expressed as:
RTSP/2.0 200 OK

WTRU-2 may initiate an RTSP setup with a RTSP server on the Remote Device. For example, WTRU-2 may send a message that includes a header, such as an IDSCRequestID header, that indicates an IDSC Request ID to the Remote Device. Another header, such as a From header, may be used to provide the identity of WTRU-2 as the target of the IDSC transfer. The header may be used as part of an authentication and authorization method. For example, WTRU-2 may send a message to the Remote Device which may be expressed as:

SETUP rtsp://video.example.com/content/video RTSP/2.0
CSeq: 2
Transport: RTP/AVP/UDP;unicast;client_port=3058-3059
IDSCRequestID: 1234
From: user@Device2.domain.org

The Remote Device may create a new session. The Remote Device may associate the new session to the IDSC transfer. The source stream and the new session may be included in an aggregate stream. The Remote Device may send a message indicating the new session to WTRU-2, which may be expressed as:

RTSP/2.0 200 OK
CSeq: 2
Session: 23456789
Transport: RTP/AVP/UDP;unicast;client_port=3058-3059;
server_port=5002-5003

WTRU-2 may initiate the media stream using a media control message, such as a PLAY command. WTRU-2 may receive an identifier, such as a URL, for the media stream through an IDSC Client Request message. The media control message may not include a range. The Remote Device may identify the current position of the source stream using the session identifier, and may start streaming the media stream from the current position of the source stream. For example, WTRU-2 may initiate the media stream using a message which may be expressed as:

PLAY rtsp://video.example.com/content/video RTSP/2.0
CSeq: 3
Session: 23456789

The Remote Device may respond to WTRU-2 using a message which may be expressed as:

RTSP/2.0 200 OK
CSeq: 3
Session: 23456789
RTP-Info: url=rtsp://video.example.com/content/video;
seq=45262314;rtptime=65473256

WTRU-2 may perform the communication session including the remote stream. WTRU-2 may send a message to the remote device to initiate termination of the media stream, which may be expressed as:

TEARDOWN rtsp://video.example.com/content/video RTSP/2.0
CSeq: 4
Session: 23456789

The Remote Device may acknowledge the media stream termination message using a message which may be expressed as:

RTSP/2.0 200 OK
CSeq: 4

As shown in FIGS. 15A1-17B5, an IDSC transfer using RTSP may include an EXECUTE method. WTRU-2 may perform the IDSC transfer using an IDSC Request ID and the server IP address or host name. For example, WTRU-2 may send a message, such as an IDSCEXECUTE message, to the Remote Device to request additional information. The Remote Device may respond with the requested information, for example encoded using text/parameters encoding similar to a GET_PARAMETERS method.

For example, the additional information may include a describe value, which may indicate a URL where associated with the presentation description; and a play_type, which may indicate a type of component of the presentation, such as video or audio. The additional information request message may be expressed as:

CN: IDSCEXECUTE 1234 RTSP/2.0
CSeq: 2
From: user2@device2.domain.org

The Remote Device may respond to WTRU-2 using a message which may be expressed as:

RTSP/2.0 200 OK
CSeq: 2
Content-Type: text/parameters
describe: http://www.example.com/content.sdp
play_type: video

WTRU-2 may send a message to a server to request the media stream, which may be expressed as:
GET /content.sdp HTTP/1.1

The Server may respond to WTRU-2 using a message which may be expressed as:
HTTP/1.0 200 OK

WTRU-2 may initiate RTSP setup with an RTSP server at the Remote Device. A resource URL may be selected from the presentation description, based on parameters provided by Remote Device in the response to the additional information request message. WTRU-2 may initiate the RTSP setup using a message which may be expressed as:

SETUP rtsp://video.example.com/content/video RTSP/2.0
CSeq: 3
Transport: RTP/AVP/UDP;unicast;client_port=3058-3059

The Remote Device may generate a new session. The Remote Device may associate the new session with the IDSC transfer, based on the additional information request message. The source stream and the new session may be included in an aggregate stream. The Remote Device may send a message to WTRU-2 indicating the new session, which may be expressed as:

RTSP/2.0 200 OK
CSeq: 3
Session: 23456789
Transport: RTP/AVP/UDP;unicast;client_port=3058-3059;
server_port=5002-5003

WTRU-2 may initiate the media stream using a media control message such as a PLAY command. WTRU-2 identify the media stream using, for example, a URL indicated in the IDSC Client Request message. The media stream initiation message may not indicate a range. The Remote Device may identify the current position of the source stream using the session identifier, and may start streaming the media stream from the current position of the source stream. For example, WTRU-2 may initiate the media stream using a message which may be expressed as:

PLAY rtsp://video.example.com/content/video RTSP/2.0
CSeq: 4
Session: 23456789

The Remote Device may respond to WTRU-2 using a message which may be expressed as:

RTSP/2.0 200 OK
CSeq: 4
Session: 23456789
RTP-Info: url=rtsp://video.example.com/content/video;
seq=45262314;rtptime=65473256

WTRU-2 may perform the communication session including the remote stream. WTRU-2 may send a message to the remote device to initiate termination of the media stream.

As shown in FIGS. 18A1-18B4, an IDSC transfer may be performed without a transport session established between WTRU-1 and the Remote Device. For example, WTRU-1 and the Remote Device may initiate a streaming session. WTRU-1 may initiate an IDSC transfer to WTRU-2 by sending a message to the Remote Device, which may be expressed as:

IDSCPREPARE 1234 RTSP/2.0
CSeq: 4
Session: 23456788
Content-Type: text/parameters
idsc_type: transfer
idsc_target: user2@device2.domain.org
idsc_auth: <format not defined at this time>

The “idsc_auth” field may indicate add authorization and authentication information about WTRU-2. The Remote Device may use the authorization and authentication information to authenticate WTRU-2. The Remote Device may generate an IDSC Request ID, and store parameters for the IDSC transfer. The Remote Device may send a message to WTRU-1 to indicate the IDSC request ID, which may be expressed as:

RTSP/2.0 200 OK
CSeq: 4
IDSCRequestID: 1234

As shown in FIGS. 15A1-18B4, a method, such as an OPTIONS RTSP method, may be used to discover whether the Remote Device supports IDSC, and to identify a SCCF, if a SCCF is used. An OPTIONS RTSP method may include OPTIONS request and response messaging, such as a message from WTRU-1 to the Remote Device, which may be expressed as:

OPTIONS rtsp://server.example.com RTSP/2.0
CSeq: 1
User-Agent: Example media player (v1.0.0)

The Remote Device may respond to WTRU-1 using a message which may be expressed as:

RTSP/2.0 200 OK
Supported: play.basic, con.persistent, idsc.basic
Cseq: 1
Server: Example Media Server 1.0.0
IDSCSccf: sccf.mydomain.com
Public: DESCRIBE, SETUP, TEARDOWN, PLAY, PAUSE, OPTIONS,
ANNOUNCE, RECORD, GET_PARAMETER, IDSCEXECUTE,
IDSCPREPARE

The field idsc.basic may indicate support for IDSC SETUP request functions, such as the IDSCRequestID header. The field IDSCEXECUTE may indicate support for an IDSC EXECUTE function. The field IDSCPREPARE may indicate support for IDSC transfer without a transport session between WTRU-1 and the Remote Device. The response message may include a Header, such as an IDSCSccf header, which may indicate centralized IDSC control and may indicate a SCCF.

IDSC transfer using RTSP may include Internet Assigned Numbers Authority (IANA) registration. For example, a feature tag, such as idsc.basic, may be registered with IANA to indicate that the server supports an IDSC transfer SETUP request.

An entry, such as IDSCEXECUTE or IDSCPREPARE, may be registered with IANA to indicate support IDSC EXECUTE and IDSC transfer without a transport session between WTRU-1 and the Remote Device support. The OPTIONS RTSP method may indicate support of these features.

A RTSP header, such as IDSCRequestID, may be registered with IANA and may be used for an IDSC Setup request or IDSC transfer without a transport session between WTRU-1 and the Remote Device.

A RTSP header, such as IDSCSccf, may be registered with IANA and may be used in a RTSP response to OPTIONS, if IDSC is supported and centralized IDSC is used, a SCCF IP Address or a Fully Qualified Domain Name (FQDN) may be associated with this header.

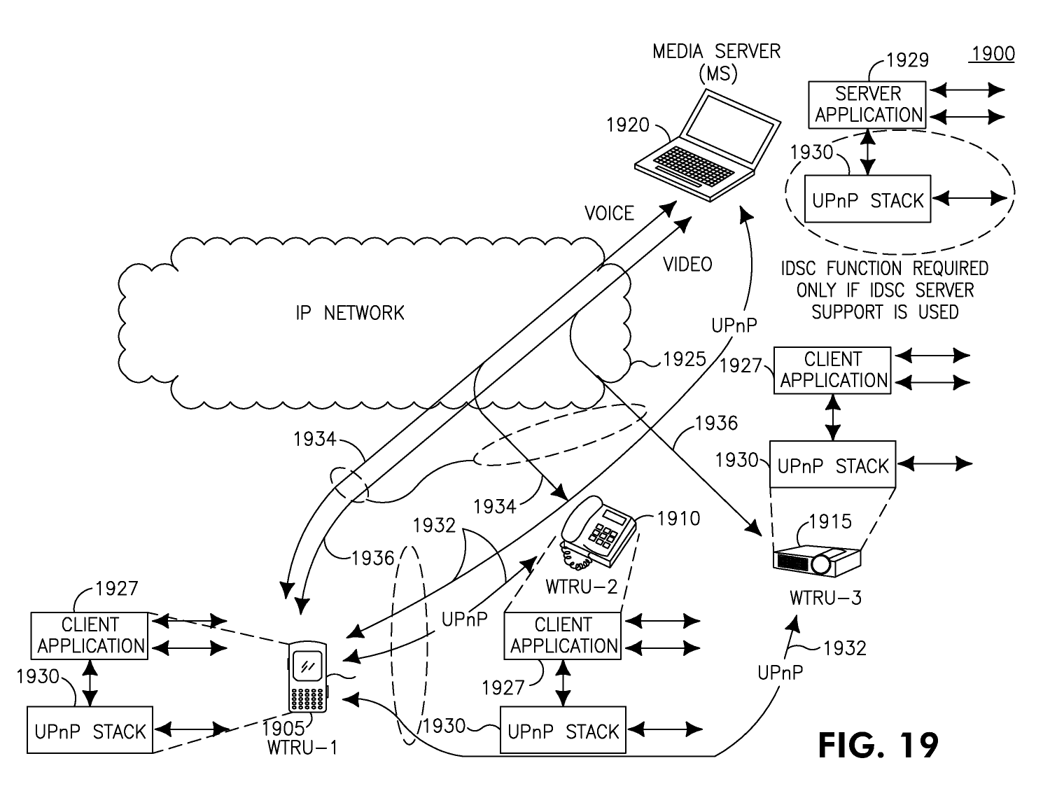

FIG. 19 is a high level diagram of P2P IDSC using a universal plug and play (UPnP) audio/video (A/V) framework, wherein a controller WTRU (i.e., control point and media renderer), WTRU-1 1905, communicates directly with controlee WTRUs (media renderers), WTRU-2 1910 and WTRU-3 1915. Wherein WTRU-1 1905 is a source device for the media sessions and WTRU-2 1910 and WTRU-3 1915 are target devices for the media sessions. IDSC control may be transported over a UPnP framework. The voice and video data may be transported using any application protocol including but not limited to RSP/RTP or HTTP.

Voice and video data may be transferred from WTRU-1 1905 to WTRU-2 1910 and WTRU-3 1915. WTRU-1 1905 is the control point (controller) for the session and acts as the media renderer. The control point may be included in a different device IDSC control may be transported over UPnP, application data, such as voice and video data, may be transported using an application protocol, such as RTSP/RTP or HTTP Streaming.

WTRU-1 1905, WTRU-2 1910 and WTRU-3 1915 may include a client application 1927 that communicates with a UPnP stack 1930. A media server (MS) 1920 may include a server application 1929 that communicates with a UPnP stack 1930.

The MS 1920 may receive a message indicating a session transfer. The MS 1920 may prepare the transfer. The MS 1920 may receive a message from the target device and may proceed with the transfer and may ensure enhanced session continuity. The MS 1920 may maintain aggregated flows when a media flow is moved or duplicated on different devices. For example, after an IDSC transfer, an aggregate flow may be paused, including, for example, the audio on a phone, and the video on a projector and a duplicated video flow on a TV. Aggregated flows may be synchronized after one flow is moved.

A MS 1920 may perform flexible policy enforcement. For example, where a policy allows the MS 1920 to transmit a media flow to a first device but prevents the MS 1920 from transmitting the media flow to a second device, the first device may transfer the media flow to the second device. IDSC-UPnP may be performed without a MS 1920.

In an alternative embodiment, the MS may not be involved in the IDSC procedure. When the MS 1920 is not involved in the IDSC procedure, IDSC operations may be performed without the need to modify the server application or the client-server protocol. In addition, client application changes are less complex since the client-server protocol need not change.

IDSC-UPnP may include the control point (i.e., WTRU-1 1905) sending an IDSC capabilities request, such as a GetDeviceCapabilities( ) request, to the media renderer (i.e., WTRU-2 1910 or WTRU-3 1915), the MS server 1920, or both. The IDSC capabilities request may indicate support for IDSC, such as IDSC or NONE.

The control point may receive a session handle, such as a GetSessionHandles( ), a GetMediaInfo( ), or a GetTransportInfo( ), message, which may indicate a session identifier of a target media flow. A session handle may include an application level identifier. A session handle may include a string, and may use a application dependent format. For example, a session handle may include an RTSP Session ID number. The control point may receive a session handle associated with each of a plurality of media flows in a communication session. For example, a session handle may be expressed as:
123456,audio:123457,video:123458

The control point may send an IDSC preparation request, such as a PrepareIDSCOperation( ), to the MS 1920. An IDSC preparation request may indicate a request to prepare an IDSC transfer. The MS 1920 may accept or reject the request, may generate an IDSC Request ID, and may store IDSC transfer parameters. An IDSC preparation request may include an IDSC type, such as transport or replication, a target Session Handle, which may be an aggregate, such as 123456, or a component, such as 123457. An IDSC preparation request may include an IDSC Request ID, and a Success Code.

The control point may send an IDSC execution request, such as a ExecutelDSCOperation( ), or a SetAVTransportURI( ), to the media renderer. An IDSC execution request may indicate a request to execute an IDSC method. The media renderer may accept or reject the request, and may perform application level signaling to play the target media components, which may be indicated by an IDSC Request ID. An IDSC execution request may include an InstanceID, which may indicate an instance of AVTransport; a CurrentURI; a CurrentURIMetaData; an IDSC Request ID; and an Accept/Reject Code.

In FIG. 19, WTRU-1 1905, the control point, may establish an IDSC control session 1932 using IDSC-UPnP with WTRU-2 1910, a media renderer, WTRU-3 1915, a media renderer, and, optionally, the MS 1920, wherein WTRU-1 1905 is the controller for the media sessions. WTRU-2 1910 and WTRU-3 1915 are controlees for the media sessions.

WTRU-1 1905 may establish a voice and video session 1934, 1936 with the MS 1920 over an IP network 1925. WTRU-1 1905 may decide to initiate an IUT of session information, or to initiate a collaborative session with WTRU-2 1910 and WTRU-3 1915. WTRU-1 1905 may establish a connection with WTRU-2 1910 over an IP network 1925 using the CN 1920 in order to transfer voice information 1934. Similarly, WTRU-1 1905 may establish a connection with WTRU-3 1915 over an IP network 1925 using the CN 1920 in order to transfer video information 1936.

At any point in the method of FIG. 19, additional actions may be performed between WTRU-1 1905, WTRU-2 1910, WTRU-3 1915 and the MS 1920.

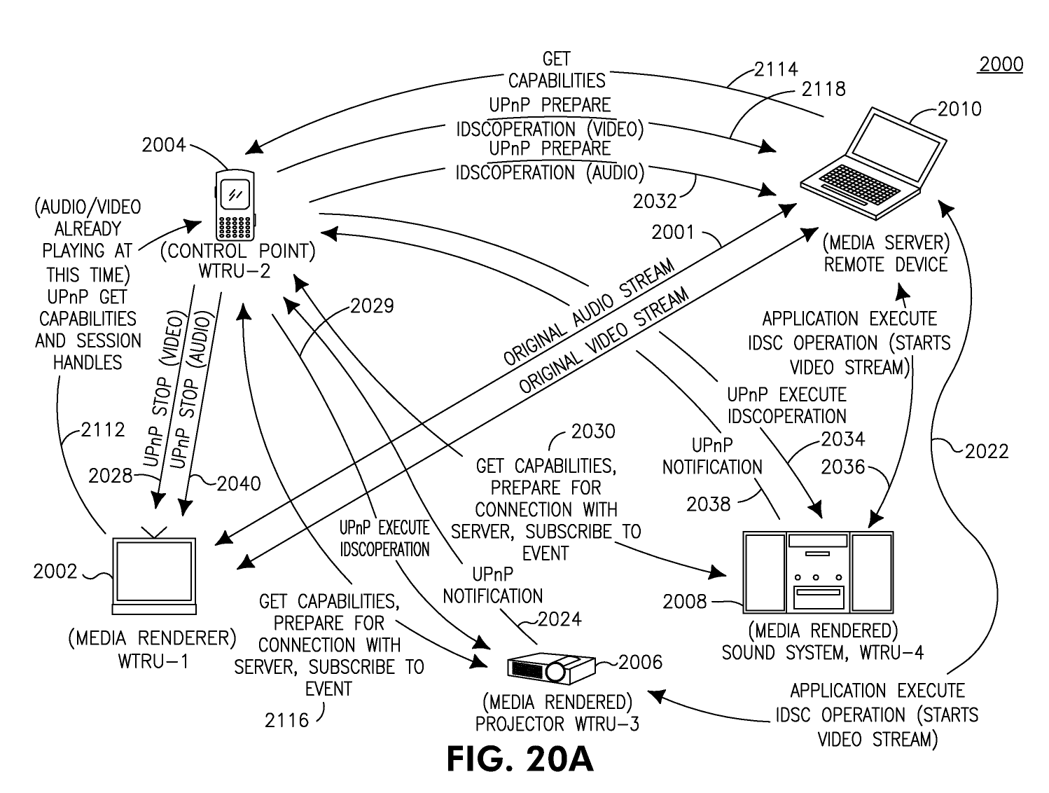

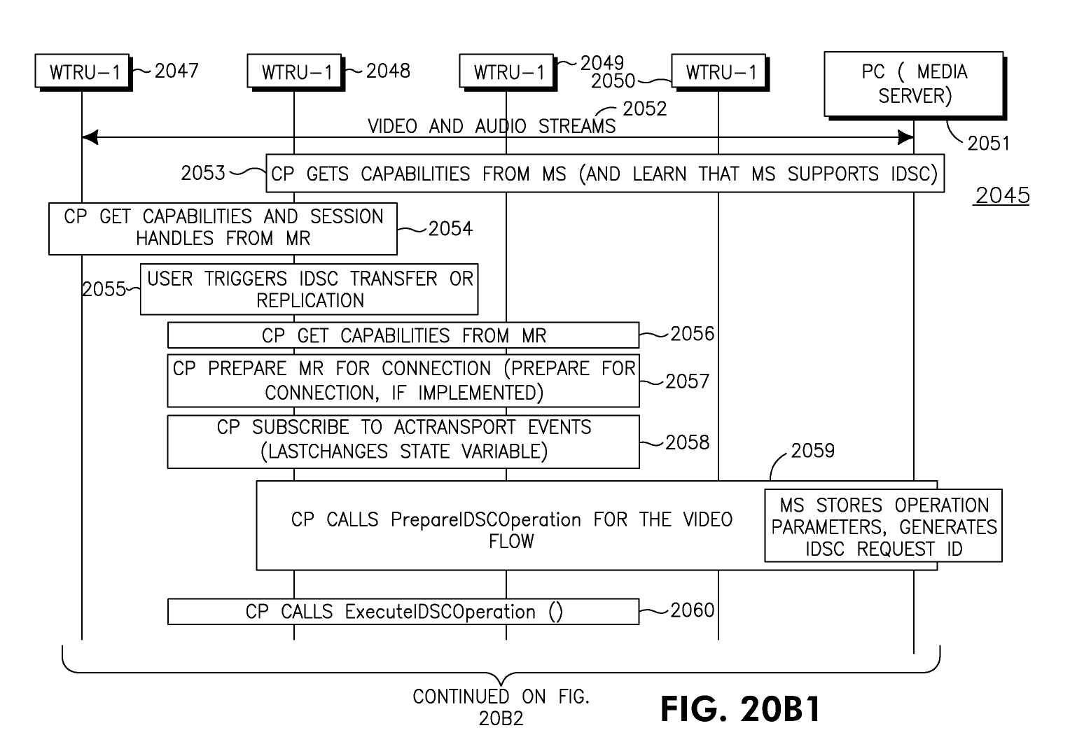

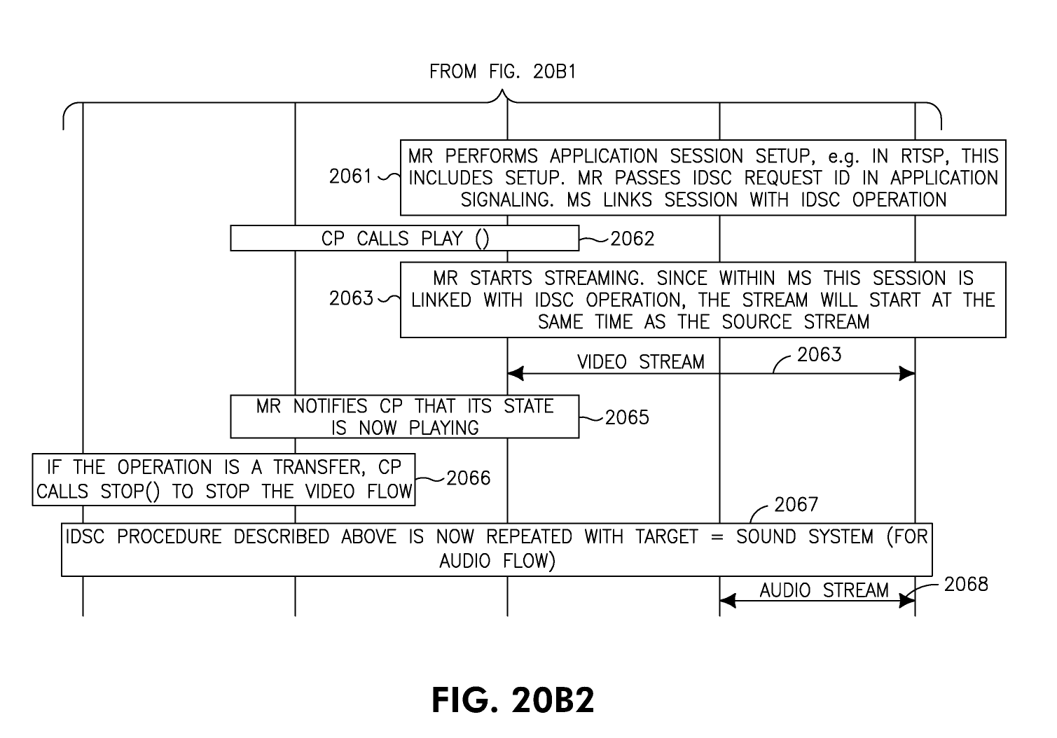

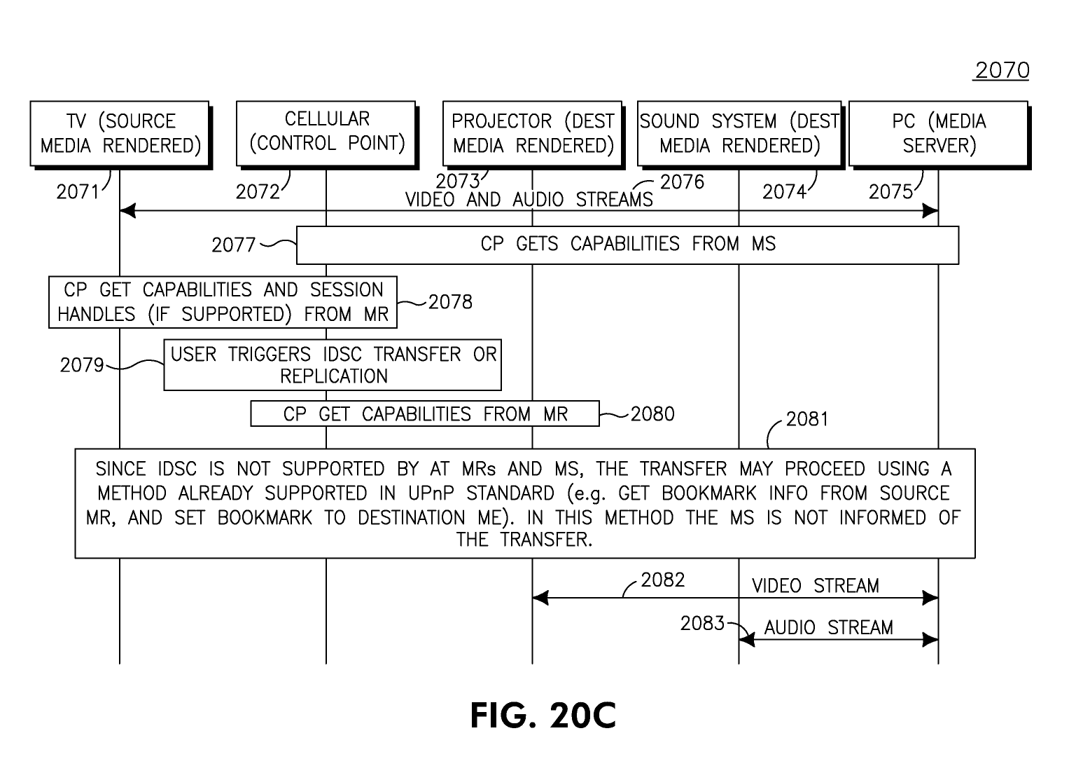

FIG. 20A is a high level diagram 2000 of an example of an IDSC-UPnP transfer. WTRU-1 2002, which may be a media renderer, may be performing a communication session 2001, including a media stream, with a Remote Device 2010, MS. The media stream may include an aggregate of a video component and an audio component. WTRU-1 2002 may send IDSC capabilities and session handles 2112 to WTRU-2 2004. WTRU-2 2004 may receive an IDSC capabilities request 2114 from the MS 2010. WTRU-2 2004, which may be a control point, may initiate an IDSC-UPnP transfer to transfer the media stream to WTRU-3 2006, and WTRU-4 2008. For example, the video component may be transferred to WTRU-3 2006, and the audio component may be transferred to WTRU-4 2008. WTRU-2 2004 may send a IDSC capabilities request 2116, 2030 to WTRU-3 2006 and WTRU-4 2008 to prepare for a connection with the server and to subscribe to an event.

WTRU-2 2004 may send a prepare operation request 2118, 2032 to the remote device 2010 for both the audio and video transfer. WTRU-2 2004 may send an execute operation request 2020, 2034 to WTRU-3 2006 and WTRU-4 2008 for both the audio and video transfer.

WTRU-3 2006 may establish a connection 2022 with the MS 2010. The MS 2010 may prepare the transfer, and WTRU-3 may execute the transfer, for example, at the application level. The control point, WTRU-2 2004 may receive a notification of completion 2024 from WTRU-3 2006. WTRU-1 2002 may maintain the media flow, or, for a transfer, WTRU-2 2004 may stop the video media flow 2028 on WTRU-1 2002.

Similarly, WTRU-4 2008 may establish a connection 2036 with the MS 2010. The MS 2010 may prepare the transfer. WTRU-4 2008 may execute the transfer 2036. The control point, WTRU-2 2004 may receive a notification of completion 2038 from WTRU-4 2008. WTRU-1 2002 may maintain the media flow, or, for a transfer, WTRU-2 2004, may stop the audio media flow 2040 on WTRU-1.

The MS 2010 may maintain the aggregate media flow. For example, WTRU-3 2006 may send a pause request to the media server and the media server may pause the media flow on WTRU-3 2006 and on WTRU-4 2008.

At any point in the method of FIG. 20A, additional actions may be performed between WTRU-1 2002, WTRU-2 2004, WTRU-3 2006, WTRU-4 2008 and the MS 2010.

FIGS. 20B1 and 20B2 show a flow diagram 2045 of an example of an IDSC-UPnP transfer. WTRU-1 2047 may be performing a communication session 2052, including a media stream, with the MS 2051. The media stream 2052 may include an aggregate of a video component and an audio component. WTRU-2 2048 may initiate a request 2053 to get IDSC capabilities from the MS 2051, may initiate a request 2054 to get IDSC capabilities from WTRU-1 2047, and may trigger transfer 2055 of the media stream to WTRU-3 2049 and WTRU-4 2050 by requesting IDSC capabilities and preparing for connection 2057.

WTRU-2 2048 may subscribe to ACTransport events 2058 and may send a request 2059 to the MS 2051 to prepare for IDSC operations. The MS 2051 may store operation parameters and may generate an IDSC request ID. WTRU-2 2048 may execute IDSC transfer 2060.

WTRU-3 2049 may establish a connection 2061 with the MS 2051. The MS 2051 may prepare the transfer, and WTRU-3 2049 may execute the transfer and may notify 2062 WTRU-2 2048. WTRU-3 2049 may begin streaming 2063. The WTRU-2 2048 may receive a notification of completion 2065 from WTRU-3 2049. WTRU-1 2047 may maintain the media flow, or, WTRU-2 2048 may stop 2066 the video media flow on WTRU-1 2047.

Similarly, WTRU-4 2050 may establish a connection with the MS 2051. The MS 2051 may prepare the transfer. WTRU-4 2050 may execute the transfer. WTRU-2 2048 may receive a notification of completion from WTRU-4 2050. WTRU-1 2047 may maintain the media flow, or, WTRU-2 2048 may stop the audio media flow on WTRU-1 2047.

At any point in the method of FIGS. 20B1 and 20B2, additional actions may be performed between WTRU-1 2047, WTRU-2 2048, WTRU-3 2049, WTRU-4 2050 and the MS 2051.

FIG. 20C is a diagram 2070 of an example of an IDSC-UPnP transfer without universal IDSC support. IDSC is not supported. The transfer may proceed using Bookmark information. However, the MS 2075 may not be informed of the transfer.

WTRU-1 2071 may be performing a communication session 2076, including a media stream, with the MS 2075. The media stream 2076 may include an aggregate of a video component and an audio component. WTRU-2 2072 may initiate a request 2077 to get IDSC capabilities from the MS 2075, may initiate a request 2078 to get IDSC capabilities from WTRU-1 2071, and may trigger transfer the media stream 2079 to WTRU-3 2072 and WTRU-4 2073 by requesting IDSC capabilities 2080 and preparing for connection.

The transfer of information continues as described in FIGS. 20B1 and 20B2. However, since IDSC is not supported in this embodiment, the transfer may proceed using a standard, such as a Bookmark standard. The MS 2075 is not informed of the transfer of information.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed is:

1. A wireless transmit/receive unit (WTRU) for Inter-User Equipment Transfer (IUT) using an Inter-Device Session Continuity (IDSC) protocol, the WTRU comprising:
a receiver configured to receive an IDSC request for transfer of a media session and media session information;
a processor configured to process the IDSC request and the media session information and based on the IDSC request and the media session information determine whether to accept the IDSC request; and
a transmitter configured to transmit a response including an indication of acceptance or rejection of the IDSC request;
wherein on a condition the IDSC request is accepted the receiver is further configured to receive the media session.

2. The WTRU of claim 1 wherein the IDSC protocol is implemented using universal plug and play (UPnP).

3. The WTRU of claim 1 wherein a relay node is used communicate with a source device.

4. The WTRU of claim 3 wherein the relay node is a session continuity control function (SCCF) or a session continuity relay function (SCRF) node.

5. The WTRU of claim 3 wherein the relay node is a media server.

6. The WTRU of claim 5 wherein a control session is established with the media server.

7. The WTRU of claim 1 wherein the IDSC request includes parameter information and configuration information.

8. The WTRU of claim 1 wherein the media session information includes protocol information and preparation information.

9. The WTRU of claim 1 wherein the IDSC protocol provides media session bookmarking.

10. The WTRU of claim 1 wherein the media sessions are Hyper Text Transport Protocol (HTTP) or Real Time Streaming Protocol (RTSP) based media streams.

11. A method for initiation of Inter-User Equipment Transfer (IUT) using an Inter-Device Session Continuity (IDSC) protocol, the method comprising:
receiving an IDSC request for transfer of a media session and media session information;
processing the IDSC request and the media session information and based on the IDSC request and the media session information determine whether to accept the IDSC request; and
transmitting a response including an indication of acceptance or rejection of the IDSC request;
wherein on a condition that the IDSC request is accepted the receiver is further configured to receive the media session.

12. The method of claim 11 wherein the IDSC protocol is implemented using universal plug and play (UPnP).

13. The method of claim 11 wherein a relay node is used communicate with a source device.

14. The method of claim 13 wherein the relay node is a session continuity control function (SCCF) or a session continuity relay function (SCRF) node.

15. The method of claim 13 wherein the relay node is a media server.

16. The method of claim 15 wherein a control session is established with the media server.

17. The method of claim 11 wherein the IDSC request includes parameter information and configuration information.

18. The method of claim 11 wherein the media session information includes protocol information and preparation information.

19. The method of claim 11 wherein the IDSC protocol provides media session bookmarking.

20. The method of claim 11 wherein the media sessions are Hyper Text Transport Protocol (HTTP) or Real Time Streaming Protocol (RTSP) based media streams.
